(19) United States
(12) Patent Application Publication
(10) Pub. No.: US 2024/0117765 A1
(43) Pub. Date: Apr. 11, 2024

(54) SYSTEMS, ASSEMBLIES, AND METHODS FOR TREATMENT/FILTRATION OF INTAKE AIR FLOWS TO A GAS TURBINE ENGINE OF A HYDRAULIC FRACTURING UNIT

(71) Applicant: BJ Energy Solutions, LLC, The Woodlands, TX (US)

(72) Inventors: Tony Yeung, The Woodlands, TX (US); Ricardo Rodriguez-Ramon, The Woodlands, TX (US); Guillermo Rodriguez, The Woodlands, TX (US)

(73) Assignee: BJ Energy Solutions, LLC, The Woodlands, TX (US)

(21) Appl. No.: 18/541,638

(22) Filed: Dec. 15, 2023

Related U.S. Application Data
(63) Continuation-in-part of application No. 17/989,601, filed on Nov. 17, 2022.
Application No. 17/989,601 is a continuation-in-part of application No. 17/954,118, filed on Sep. 27, 2022, now Pat. No. 11,598,263.
Application No. 17/954,118 is a continuation of application No. 17/403,373, filed on Aug. 16, 2021, now Pat. No. 11,560,845.
Application No. 17/403,373 is a continuation of application No. 17/326,711, filed on May 21, 2021, now Pat. No. 11,156,159.
Application No. 17/326,711 is a continuation of application No. 17/213,802, filed on Mar. 26, 2021, now Pat. No. 11,060,455.
Application No. 17/213,802 is a continuation of application No. 16/948,289, filed on Sep. 11, 2020, now Pat. No. 11,002,189.
(60) Provisional application No. 63/493,070, filed on Mar. 30, 2023.
(60) Provisional application No. 63/476,452, filed on Dec. 21, 2022.
(60) Provisional application No. 62/704,565, filed on May 15, 2020.
(60) Provisional application No. 62/900,291, filed on Sep. 13, 2019.

(51) Int. Cl. F02C 7/052; B01D 46/42; B01D 46/58; F02C 6/00; F02C 7/042; F02C 7/143

(52) U.S. Cl. CPC F02C 7/052; B01D 46/4263; B01D 46/58; F02C 6/00; F02C 7/042; F02C 7/143; B01D 2279/60

(57) ABSTRACT

Systems, assemblies, and methods to enhance the efficiency of operation of a gas turbine engine may include a turbine housing positioned to at least partially enclose the gas turbine engine, and a filtration assembly connected to the turbine housing to supply at least partially filtered intake air to an air inlet assembly associated with the gas turbine engine. The filtration assembly may include one or more inertial separators configured to separate a first portion of particles, liquids, and/or combinations thereof from ambient air supplied to the gas turbine engine, thereby to provide at least partially filtered intake air, and one or more filters positioned downstream of the one or more inertial separators to separate a second portion of the particles, liquids, and/or combinations thereof from the at least partially filtered intake air.

### CROSS-REFERENCE TO RELATED APPLICATIONS

This application is a Non-Provisional Application which claims priority to U.S. Provisional Application No. 63/493,070, filed on Mar. 30, 203, titled “SYSTEMS, ASSEMBLIES, AND METHODS FOR TREATMENT/FILTRATION OF INTAKE AIR FLOWS TO A GAS TURBINE ENGINE OF A HYDRAULIC FRACTURING UNIT,” and U.S. Provisional Application No. 63/476,452, filed on Dec. 21, 2022, titled “SYSTEMS, ASSEMBLIES, AND METHODS FOR TREATMENT/FILTRATION OF INTAKE AIR FLOWS TO A GAS TURBINE ENGINE OF A HYDRAULIC FRACTURING UNIT,” which is a continuation-in-part of U.S. Non-Provisional application Ser. No. 17/989,601, filed Nov. 17, 2022, titled “SYSTEMS, ASSEMBLIES, AND METHODS TO ENHANCE INTAKE AIR FLOW TO A GAS TURBINE ENGINE OF A HYDRAULIC FRACTURING UNIT,” which is a continuation-in-part of U.S. Non-Provisional application Ser. No. 17/954,118, filed Sep. 27, 2022, titled “MOBILE GAS TURBINE INLET AIR CONDITIONING SYSTEM AND ASSOCIATED METHODS,” now U.S. Pat. No. 11,598,263, issued Mar. 7, 2023, which is a continuation of U.S. Non-Provisional application Ser. No. 17/403,373, filed Aug. 16, 2021, titled “MOBILE GAS TURBINE INLET AIR CONDITIONING SYSTEM AND ASSOCIATED METHODS,” now U.S. Pat. No. 11,560,845, issued Jan. 24, 2023, which is a continuation of U.S. Non-Provisional application Ser. No. 17/326,711, filed May 21, 2021, titled “MOBILE GAS TURBINE INLET AIR CONDITIONING SYSTEM AND ASSOCIATED METHODS,” now U.S. Pat. No. 11,156,159, issued Oct. 26, 2021, which is a continuation U.S. Non-Provisional application Ser. No. 17/213,802, filed Mar. 26, 2021, titled “MOBILE GAS TURBINE INLET AIR CONDITIONING SYSTEM AND ASSOCIATED METHODS,” now U.S. Pat. No. 11,060,455, issued Jul. 13, 2021, which is a continuation of U.S. Non-Provisional application Ser. No. 16/948,289, filed Sep. 11, 2020, titled “MOBILE GAS TURBINE INLET AIR CONDITIONING SYSTEM AND ASSOCIATED METHODS,” now U.S. Pat. No. 11,002,189, issued May 11, 2021, which claims priority to and the benefit of U.S. Provisional Application No. 62/704,565, filed May 15, 2020, titled “MOBILE GAS TURBINE INLET AIR CONDITIONING SYSTEM AND ASSOCIATED METHODS,” and U.S. Provisional Application No. 62/900,291, filed Sep. 13, 2019, titled “MOBILE GAS TURBINE INLET AIR CONDITIONING SYSTEM,” the disclosures of which are incorporated herein by reference in their entireties.

### TECHNICAL FIELD

The present disclosure relates to systems, assemblies, and methods for cleaning intake air flows to a gas turbine engine, and more particularly, to systems, assemblies, and methods for enhancing and cleaning particulates and other contaminants from and intake air flow to a gas turbine engine of a hydraulic fracturing unit.

### BACKGROUND

Hydraulic fracturing is often used to produce oil and gas in an economic manner from low permeability reservoir rocks, such as shale. During hydraulic fracturing, a fluid is pumped under high pressure into the reservoir rock, opening a flow channel, after which a proppant-carrying fluid is pumped into the flow channel to continue opening and widening the flow channel. Mechanical power for pumping such fluids may be generated by direct drive turbine fracturing units at a fracturing operation site, and due to the large nature of many fracturing operations, a number of direct drive turbine fracturing units often may be required at a fracturing operation site to ensure coverage for the fracturing operation. Such direct drive turbine fracturing units generally utilize gas turbine engines to generate power.

The performance of such gas turbine engines may be affected by conditions under which the gas turbine engine operates. For example, gas turbine engines may be subject to damage by particulates in air supplied to the intake of the gas turbine engine, and thus the incoming air generally may be filtered before entering the intake of the gas turbine engine. However, such filtration may reduce pressure of air supplied to the intake, particularly as the filter medium of the filter becomes obstructed by filtered particulates with use, which may lead to reduced power output of the gas turbine engines that consequently may affect the effectiveness of a hydraulic fracturing operation powered by the gas turbine engines.

Accordingly, Applicant has recognized a need for systems, assemblies, and methods for cleaning/filtering air flows upstream of the intake of a gas turbine engine and provide enhanced air flows to the intake of the gas turbine engine for hydraulic fracturing operations. The present disclosure may address one or more of the above-referenced drawbacks, as well as other possible drawbacks.

### SUMMARY

The present disclosure generally is directed to assemblies and methods for cleaning/filtering air flows upstream of the intake of a gas turbine engine to enhance the efficiency of operation of the gas turbine engine, which may be connected to, for example, one or more hydraulic fracturing pumps to pump hydraulic fracturing fluid into wellheads. According to some aspects, an intake air treatment system is provided, the intake air treatment system comprising a filtration assembly configured to clean/filter inlet air upstream of an intake of a gas turbine engine to help enhance the efficiency of operation of the gas turbine by removing particulate materials from the inlet air flow by purging such particulate materials from the filtration assembly on a substantially continuous basis, without necessarily requiring disruptions of the air flow of intermittent purging, and without substantially reducing pressure of the inlet air flow passing through the filtration assembly.

For example, and without limitation, in some embodiments, the intake air treatment system may be configured to supply cleaned/filtered intake air to an engine. In embodiments, the engine may comprise a gas turbine engine including an air inlet assembly configured to receive the intake air supplied to the gas turbine engine from the intake air treatment system. The gas turbine engine also may include a compressor section, a combustor section and power turbine section that transfers energy to an output shaft. According to some embodiments, the gas turbine engine and intake air treatment system may be included as components of a hydraulic fracturing unit, such as a mobile hydraulic fracturing unit, for pumping a flow of fracturing fluid into a wellhead during a high-pressure fracturing operation. In embodiments, the hydraulic fracturing unit may include a chassis having a longitudinal chassis axis and a width perpendicular to the longitudinal chassis axis, with the gas turbine engine and intake air treatment system being supported along the chassis. The hydraulic fracturing unit also may include a hydraulic fracturing pump connected to the output shaft of the gas turbine engine so as to be driven by the operation of the gas turbine engine.

In embodiments, the intake air treatment system generally may be arranged upstream from the air inlet assembly of the gas turbine engine, and may include an air intake housing configured to at least partially enclose the air inlet assembly of the gas turbine engine; air channels and turbine air intake ducts. The intake air treatment system further may include a filtration assembly positioned to provide along a flow path of flows of incoming, ambient air entering the intake air treatment system. The filtration assembly may filter the ambient air flow to supply filtered intake air to the air inlet assembly of the gas turbine engine.

In embodiments, the filtration assembly may include one or more pre-cleaners positioned to receive ambient air drawn into the filtration assembly via operation of the gas turbine engine and including one or more inertial separators configured to separate a first portion of particles, liquids, or combinations thereof, from the ambient air flows, to provide at least partially filtered intake air. The filtration assembly further may include one or more filters positioned in the flow path downstream of the one or more pre-cleaners and configured to separate a second portion of the particles, liquids, or combinations thereof, from the at least partially filtered intake air, so as to further clean/filter the intake air prior to its supply into the air inlet assembly of the gas turbine engine.

In some embodiments, the intake air treatment system may include a filtration assembly including one or more pre-cleaners on opposite sides of the air intake housing and configured to receive ambient air drawn into the filtration assembly via operation of the gas turbine engine. In embodiments, the one or more pre-cleaners may include one or more inertial separators configured to separate particles, liquids, or combinations thereof, from the ambient air to provide at least partially filtered intake air prior to the ambient air reaching the inlet of the gas turbine engine. The filtration assembly also may include one or more filters positioned in the flow path downstream of the one or more pre-cleaners and configured to separate a second portion of the particles, liquids, and/or combinations thereof from the at least partially filtered intake air, thereby to provide the at least partially filtered intake air to the air inlet assembly of the gas turbine engine. The pre-cleaners, in at least some embodiments, may serve to separate and block at least a first portion of particles, liquids, or combinations thereof, from reaching one or more filters, which may reduce the rate at which the one or more filters need to be services or replaced, thereby reducing maintenance and downtime associated with the one or more filters.

According to some aspects, the intake air treatment system may include a filtration assembly including one or more pre-cleaners, which, in embodiments, may include one or more inertial separators, and in some embodiments one or more downstream filters, arranged along a flow path of incoming ambient air and configured to separate particles, liquids, or combinations thereof, from the ambient air to provide at least partially filtered intake air prior to the ambient air reaching the inlet of the gas turbine engine. In embodiments, the air intake treatment system may further include a bleed air system connected to the one or more inertial separators and configured to draw a substantially continuous flow of bleed air through the one or more inertial separators sufficient to provide substantially continuous purging of particles, liquids, or combinations thereof, filtered from the ambient air flow. As a result, the one or more such particles, liquids, or combinations thereof, removed by the one or more inertial separators may be removed on a substantially real-time and/or substantially continuous basis, without the introduction of compressed air or intermittent purging operations being required to clean the inertial separators.

In embodiments, the bleed air system may include one or more fans in fluid communication with the one or more inertial separators. For example, in embodiments, each inertial separator may be connected to a duct having a fan coupled thereto so as to draw a flow of bleed air from the inertial separator through the duct, with at least a portion of the particles, liquids, or combinations thereof, cleaned/filtered from the ambient air flow being carried out of the inertial separator with the flow of bleed air. In some embodiments, the ducts of the one or more inertial separators each may have a fan located therealong to generate/pull the bleed air flows therethough; while in other embodiments, one or more sets or banks of fans may be connected to the ducts; either directly or through a manifold.

In addition, in embodiments, the intake air treatment system may include a control system for controlling operation of the bleed air system. The control system may include one or more processors and may further include one or more sensors configured to monitor the bleed air system and/or the flows of ambient air into the intake air treatment system and/or the flow if the cleaned/filtered intake air supplied to the air inlet assembly for the gas turbine engine.

In some embodiments, the bleed air system may include one or more fans connected to the one or more pre-cleaners, e.g., one or more inertial separators, by a duct or plurality of ducts, and driven by a drive mechanism. For example, in embodiments, the drive mechanism may comprise an electric motor, such as a servo motor, stepper motor, torque motor, or other electrically powered drive. In other embodiments, the one or more fans may be driven by hydraulic motors.

The one or more fans may be operated by the control system in response to operator commands or based on programmed control instructions. In embodiments, the one or more fans may be operated substantially continuously during operation of the gas turbine engine to provide a substantially continuous flow of bleed air for removal of the particles, liquids, or combinations thereof, cleaned/filtered from the ambient air flow.

In some embodiments, the one or more fans may be selectively controlled. For example, the fans may be run at varying speeds, e.g., based on feedback from the one or more sensors regarding air flow pressures, etc. or, in some embodiments, the one or more fans may be controlled such that some fans may be operated while others may be powered down, or even shut off, e.g., the fans may be operated for selected or pre-determined times, with the operations of the fans being sequenced or overlapping. In embodiments, such timed operations also may be overridden by an operator or by the control system in response to incoming sensor feedback.

According to other aspects, a method to enhance the efficiency of operation of a gas turbine engine (GTE) may include causing ambient air to flow toward an air inlet assembly of the gas turbine engine, and passing the ambient air through one or more pre-cleaners to cause the ambient air to swirl and separate a first portion of particles, liquids, or combinations thereof, from the ambient air, thereby to provide at least partially filtered intake air. The method further may include passing the at least partially filtered intake air through one or more filters to separate a second portion of the particles, liquids, or combinations thereof, from the at least partially filtered intake air, thereby to provide further filtered intake air. The method also may include supplying the further filtered intake air to the air inlet assembly of the GTE.

In embodiments, the method may further comprise drawing a substantially continuous flow of bleed air through the one or more pre-cleaners, which, in embodiments, may include inertial separators. The flow of bleed air may be selectively controlled by a control system. For example, in embodiments, the bleed air system may include one or more fans that may be operated in a substantially continuous manner to draw a substantially continuous flow of bleed air through and out of the pre-cleaners to remove particles, liquids, or combinations thereof, cleaned/filtered from the ambient air flow. In some embodiments, the one or more fans may be selectively operated, such as based on a pre-selected time of operation or feedback from one or more sensors monitoring pressures of the ambient air flow through the intake air treatment system, a pressure of the cleaned/filtered air passing into the air inlet assembly of the gas turbine engine, and/or other factors.

An intake air treatment system for supplying filtered intake air to an air inlet assembly of a gas turbine engine, the intake air treatment system comprising an air intake housing configured to at least partially enclose the air inlet assembly of the gas turbine engine; a filtration assembly at least partially received within the air intake housing and configured to substantially clean particles, liquids, and/or combinations thereof, from ambient air drawn into the filtration assembly by operation of the gas turbine engine, the filtration assembly comprising: a filtration housing connected to the air inlet assembly of the gas turbine engine and having a filtration chamber defined therein; at least one pre-cleaner positioned along the filtration housing upstream of the filtration chamber such that the ambient air passes therethrough, the at least one pre-cleaner comprising at least one inertial separator configured to separate a first portion of the particles, liquids, and/or combinations thereof, from the ambient air to provide a flow of at least partially filtered intake air; and one or more filters positioned along the filtration chamber downstream of the at least one inertial separator, the one or more filters and configured to receive the at least partially filtered intake air from the at least one inertial separator and separate a second portion of the of particles, liquids, and/or combinations thereof, from the at least partially filtered intake air to provide the filtered intake air into the filtration chamber; and a bleed air system in fluid communication with the at least one inertial separator and comprising: a conduit coupled to the at least one inertial separator; and at least one bleed airflow generator in fluid communication with the conduit or hose, the at least one bleed airflow generator configured to draw a bleed air flow through the at least one inertial separator and the conduit; wherein the bleed air flow has a velocity sufficient to remove the first portion of the particles, liquids, and/or combinations thereof, separated from the ambient air from the at least one inertial separator.

In embodiments of the intake air treatment system, the at least one bleed airflow generator comprises one or more fans or blowers located along the conduit and operable to draw the bleed air flow through and out of the at least one inertial separator so as to create a static pressure sufficient to draw the first portion of the particles, liquids, and/or combinations thereof, separated from the ambient air out of the at least one inertial separator and along the conduit with the bleed air flow.

In embodiments of the intake air treatment system, the at least one inertial separator comprises a plurality of inertial separators; and wherein the at least one bleed airflow generator further comprises at least one fan box having one or more fans housed therein, wherein the at least one fan box is located along an intake line coupled to one or more of the plurality of inertial separators.

In embodiments, the at least one inertial separator comprises a plurality of inertial separators arranged along opposite sides of the filtration chamber; and wherein the at least one bleed airflow generator comprises a plurality of fans or blowers each in fluid communication with an associated one of the plurality of inertial separators, one of the plurality of each of the fans or blowers configured to draw the bleed air flow through and out of the associated inertial separators so as to create a static pressure sufficient to draw the first portion of the particles, liquids, and/or combinations thereof, separated from the ambient air out of the at least one inertial separator and along the conduit with the bleed air flow.

In some embodiments, the at least one inertial separator comprises a body having an interior panel, an exterior panel, and a separation cavity defined between the interior and exterior panels; and a plurality of separator tubes, each comprising an air flow inlet tube having a proximal end connected to the exterior panel, extending toward the interior panel, and terminating at a distal end, the air flow inlet tube defining an interior cross-sectional area; a diverter arranged along the air flow inlet tube and configured to cause turbulence in the ambient air entering the air flow inlet tube as the ambient air flows from the proximal end of the air flow inlet tube toward the distal end of the air flow tube; and an air outlet tube connected to the interior panel and extending into the distal end of the air flow tube, the air outlet tube having an exterior cross-sectional area smaller than on interior cross-sectional area of the air flow tube.

In embodiments, the air outlet tube comprises an interior passage defining a first separator flow path along which the at least partially filtered intake air is directed to exit the air outlet tube; and wherein a second separator flow path is defined between an exterior surface of the air outlet tube and configured to enable an interior surface of the air flow inlet tube configured the first portion of the particles, liquids, and/or combinations thereof, separated from the ambient air to be discharged from the separator tube.

In embodiments, the diverter comprises one or more stator blades having one or more curved surfaces configured to cause the ambient air entering the air flow inlet tube to swirl as the ambient air passes the one or more stator blades.

In some embodiments, the interior panel of the at least one inertial separator comprises a plurality of interior holes, and wherein the air outlet tubes connected to the interior panel such that an interior passage of the air outlet tube provides a first separator flow path for the at least partially filtered intake air to exit through the interior passage of the air outlet tube and the interior hole of the interior panel; and wherein each air flow inlet tube is connected to an exterior surface of a corresponding air outlet tube and at least partially defines a second separator flow path for the first portion of the one or more of particles, liquids, and/or combinations thereof to be separated from the ambient air and directed into the separation cavity.

In embodiments, one or more of an interior passage of the air flow inlet tube, an interior passage of the air outlet tube, or an exterior passage defined between the air flow inlet tube and the air outlet tube has a substantially circular cross-sectional shape.

In embodiments of the intake air treatment system, the at least one inertial separator comprises a plurality of inertial separators mounted along one or both sides of the filtration housing; wherein each inertial separator comprises at least one pre-cleaner bypass positioned along a lower portion of the inertial separator and configured to receive and divert the first portion of the particles, liquids, or combination thereof separated from the ambient air into the conduit.

In embodiments of the intake air treatment system, the one or more filters comprise one or more of a pre-filter or a final filter.

In embodiments of the intake air treatment system, the at least one bleed airflow generator comprises at least one fan or blower located along the conduit coupled to the at least one inertial separator; wherein the at least one fan or blower is located at a position along the conduit selected to substantially minimize a pressure drop of the bleed air flow after exiting the at least one inertial separator.

In embodiments of the intake air treatment system, the at least one fan or blower comprises an axial fan, centrifugal fan, axial blade fan, or a squirrel cage fan.

In embodiments, the at least one bleed airflow generator further comprises at least one hydraulically, pneumatically or electrically powered motor coupled to the at least one fan or blower.

In embodiments of the intake air treatment system, the bleed air system further comprises at least one timer linked to the at least one bleed airflow generator; wherein the timer is activated as the at least one bleed airflow generator is actuated to generate the bleed air flow, and, upon expiration of the timer, the at least one bleed airflow generator is deactivated.

In embodiments, the intake air treatment system, further comprises one or more sound attenuation baffles positioned within the filtration chamber and configured to attenuate sound generated during operation of the gas turbine engine.

In another aspect, a hydraulic fracturing unit comprises a chassis;

a gas turbine engine supported by the chassis; an air inlet assembly connected to the gas turbine engine and adapted to supply intake air to the gas turbine engine; a hydraulic fracturing pump positioned along the chassis and connected to the gas turbine engine; and an intake air treatment system comprising an air intake housing at least partially enclosing the air inlet assembly of the gas turbine engine; a filtration assembly located at least partially within the turbine housing and having a flow path defined therethrough; wherein ambient air is drawn into the filtration assembly via operation of the gas turbine engine and is passed through the filtration assembly to substantially clean particles, liquids, and/or combinations thereof, from the ambient air to supply filtered intake air to the air inlet assembly; wherein the filtration assembly comprises a pre-cleaner configured to separate a first portion of the particles, liquids, and/or combinations thereof, from the ambient air drawn into the filtration assembly via operation of the gas turbine engine; and one or more filters positioned along the flow path downstream of the pre-cleaner, the one or more filters configured to receive at least partially cleaned ambient air from the pre-cleaner and separate a second portion of the one or more of particles, liquids, and/or combinations thereof, from the at least partially cleaned ambient air, to provide filtered intake air to the air inlet assembly of the gas turbine engine; and a bleed air system in fluid communication with a pre-cleaner, the bleed air system configured to generate a substantially continuous bleed air flow through the pre-cleaner to create a static pressure or suction sufficient to substantially draw the first portion of the particles, liquids, and/or combinations thereof, out of the pre-cleaner with the bleed air flow.

In embodiments, the bleed air system comprises at least one bleed airflow generator comprises a plurality of fans or blowers located along a conduit coupled to the pre-cleaner operable to generate and draw the bleed air flow through and out of the pre-cleaner.

In embodiments, the at least one bleed airflow generator further comprises a motor coupled to each of the fans or blowers, wherein when the bleed air system is operating, the motors are configured to drive the fans or blowers to generate the substantially continuous bleed air flow.

In embodiments, the hydraulic fracturing unit further comprises a variable speed controller configured to control a speed of the motors.

In embodiments, the pre-cleaner comprises a plurality of inertial separators; and wherein the bleed air flow system comprises at least one bleed airflow generator, the at least one bleed airflow generator comprises at least one fan box having a plurality of fans mounted therein, wherein the fan box is located along a conduit coupled to one or more of the plurality of inertial separators.

In embodiments, the pre-cleaner comprises a plurality of inertial separators arranged along opposite sides of the filtration assembly, upstream from the one or more filters; and wherein the bleed air system comprises a plurality of fans or blowers, each fan or blower in fluid communication with an associated one of the plurality of inertial separators and operable draw the bleed air flow through and out its associated one of the plurality of inertial separators.

In embodiments, the pre-cleaner comprises at least one inertial separator including a body having an interior panel, an exterior panel, and a separation cavity defined between the interior and exterior panels; and a plurality of separator tubes, each comprising an air flow inlet tube having a proximal end connected to the exterior panel, extending toward the interior panel, and terminating at a distal end, the air flow inlet tube defining an interior cross-sectional area; a diverter arranged along the air flow inlet tube and configured to cause turbulence in the ambient air entering the air flow inlet tube as the ambient air flows from the proximal end of the air flow inlet tube toward the distal end of the air flow tube; and an air outlet tube connected to the interior panel and extending into the distal end of the air flow tube, the air outlet tube having an exterior cross-sectional area smaller than on interior cross-sectional area of the air flow tube.

In embodiments, the air outlet tube comprises an interior passage defining: a first separator flow path along which the at least partially filtered intake air is directed to exit the air outlet tube; and wherein a second separator flow path is defined between an exterior surface of the air outlet tube and configured to enable an interior surface of the air flow inlet tube and the first portion of the particles, liquids, and/or combinations thereof, separated from the ambient air to be discharged from the separator tube.

In embodiments, the pre-cleaner comprises a plurality of inertial separators mounted along one or both sides of the filtration housing; and further comprising at least one pre-cleaner bypass configured to receive and divert the first portion of the particles, liquids, or combination thereof separated from the ambient air to a conduit or hose along which the bleed air flow is drawn out of each inertial separator.

In embodiments, the one or more filters comprise one or more of a pre-filter or a final filter.

In embodiments, the bleed air system comprises at least one fan or blower in fluid communication with the pre-cleaner, and configured to generate the bleed air flow through the pre-cleaner.

In some embodiments, the at least one fan or blower comprises an axial fan, centrifugal fan, axial blade fan, or a squirrel cage fan.

In embodiments, the hydraulic fracturing unit further comprises a gas turbine engine controller configured to monitor and control a speed of the gas turbine engine, and to turn on the at least one fan or blower when the speed of the gas turbine engine exceeds a selected minimum speed, and turn off the at least one fan or blower when the speed of the gas turbine engine is at or below the selected minimum speed.

In embodiments, the bleed air system comprises at least one bleed airflow generator, the at least one bleed airflow generator comprising at least one fan or blower, and at least one hydraulically, pneumatically or electrically powered motor coupled to the at least one fan or blower.

In embodiments, the bleed air system further comprises at least one timer linked to at least one bleed airflow generator; wherein as the at least one air flow generator is actuated to generate the bleed air flow, the timer is activated and, upon expiration of a selected time, the at least one bleed airflow generator is deactivated.

In embodiments, the filtration assembly further comprises a filtration housing having a filtration chamber defined therein, with the air inlet assembly of the gas turbine engine in communication therewith; and one or more sound attenuation baffles positioned within the filtration chamber and configured to attenuate sound generated during operation of the gas turbine engine.

In another aspect, a method comprises operating a gas turbine engine; drawing ambient air into and through a filtration assembly in communication with an air inlet assembly connected to the gas turbine engine; passing the ambient air through one or more inertial separators of the filtration assembly to separate a first portion of one or more of particles, liquids, and/or combinations thereof, from the ambient air, and provide a flow of at least partially filtered intake air; passing the flow of at least partially filtered intake air through one or more filters to separate a second portion of the one or more of particles, liquids, and/or combinations thereof, from the at least partially filtered intake air, thereby to provide further filtered intake air; supplying the further filtered intake air to the air inlet assembly; and as the gas turbine engine is operating to draw the ambient air into and through the filtration assembly, drawing a bleed air flow out of the one or more inertial separators; wherein the bleed air creates a static pressure or suction sufficient to remove the first portion of the particles, liquids, and/or combination thereof, from the one or more inertial separators with the bleed air flow.

In embodiments of the method, passing the ambient air through one or more inertial separators comprises passing the ambient air through an air flow inlet tube and a diverter connected to the air flow inlet tube and positioned to cause the ambient air entering the air flow inlet tube to swirl as the ambient air flows from a proximal end of the air flow inlet tube to a distal end of the air flow inlet tube to thereby generate swirling ambient air; and separating the first portion of the one or more of particles, liquids, and/or combinations thereof from the swirling ambient air via the separator tube.

In embodiments of the method, drawing the bleed air flow out of the one or more inertial separators comprises turning on one or more fans or blowers when a speed of the gas turbine engine reaches or exceeds a selected minimum speed.

In embodiments, the method further comprises turning off the one or more fans or blowers when the speed of the gas turbine engine falls below the selected minimum speed.

In some embodiments, the method further comprises initiating a timer after the one or more fans or blowers are turned on, and turning off the one or more fans or blowers after the timer expires.

In some embodiments, the method further comprises initiating a second timer when the one or more fans or blowers are turned off, and, after the second timer has expired, turning on the one or more fans.

In embodiments, the method further comprises passing the further filtered intake air through one or more sound attenuation baffles to attenuate sound generated during operation of the gas turbine engine.

In embodiments, the method, further comprises drawing the bleed air flow out of the one or more inertial separators comprises turning on a plurality of blowers or fans in fluid communication with the one or more inertial separators.

In embodiments, the method, further comprises monitoring a speed of the gas turbine engine and turning selected ones of the plurality of fans or blowers on and off based on the speed of the gas turbine engine.

Still other aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 schematically illustrates an example hydraulic fracturing system including a plurality of example hydraulic fracturing units, according to embodiments of the disclosure.

FIG. 2 is a perspective view of an example hydraulic fracturing unit, according to embodiments of the disclosure.

FIG. 3A is a partial side section view of an example hydraulic fracturing unit, according to embodiments of the disclosure.

FIG. 3B is a detailed partial side section view of an example intake air treatment system with a filtration assembly for use with the example hydraulic fracturing unit shown in FIG. 3A, according to embodiments of the disclosure.

FIG. 4A is a perspective view of an example inertial separator assembly of the inlet air filtration treatment system according to embodiments of the disclosure.

FIG. 4B is a schematic top view of an example intake air treatment system, showing an example flow path therethrough, according to embodiments of the disclosure.

FIG. 4C is a schematic top view of another example intake air treatment system, showing another example flow path therethrough, according to embodiments of the disclosure.

FIG. 4D is a schematic top view of an example intake air treatment assembly including example sound attenuation baffles, according to embodiments of the disclosure.

FIG. 4E is a schematic top view of another example intake air treatment assembly not including sound attenuation baffles, according to embodiments of the disclosure.

FIG. 5A is a schematic perspective view of an example an inertial separator viewed from an exterior side, according to embodiments of the disclosure.

FIG. 5B is a schematic perspective partial section view of the example inertial separator shown in FIG. 5A, according to embodiments of the disclosure.

FIG. 5C is a schematic side view of the example inertial separator shown in FIG. 5A viewed from the exterior side, according to embodiments of the disclosure.

FIG. 5D is a schematic end view of the example inertial separator shown in FIG. 5A, according to embodiments of the disclosure.

FIG. 5E is a schematic side view of an example separator tube shown in FIG. 5D, according to embodiments of the disclosure.

FIG. 5F is a schematic partial side section view of an example configuration of a plurality of inertial separators, according to embodiments of the disclosure.

FIG. 5G is a schematic perspective view of another example inertial separator viewed from an exterior side, according to embodiments of the disclosure.

FIG. 6A is an end view schematically illustrating an example configuration of an engine intake air treatment system having a system of inertial separators with direct mounted bleed fans, according to embodiments of the disclosure.

FIG. 6B is an end view schematically illustrating another example configuration of an engine intake air treatment system having a system of inertial separators with remotely located/mounted bleed fans, according to embodiments of the disclosure.

FIGS. 6C-6D are end views schematically illustrating example configurations of intake air treatment systems having a system of inertial separators that remotely mount/plumb into different example configurations of a box system including a plurality of bleed fans, according to embodiments of the disclosure.

FIG. 6E is an end view schematically illustrating an example configuration of an intake air treatment system having a system of inertial separators feeding to a manifold powered by one or more bleed air fans, according to embodiments of the disclosure.

FIG. 7 a schematic diagram showing a hydraulically powered bleed fan assembly, according to embodiments of the disclosure.

FIGS. 8A-8B are schematic diagrams showing examples of electrically powered bleed fan assemblies, according to embodiments of the disclosure.

FIGS. 9A-9B are schematic diagrams illustrating various example processes for control of a gas turbine engine, intake air treatment system, and/or a bleed fan assembly, according to embodiments of the disclosure.

FIG. 9C is a schematic diagram illustrating another example process for control of a hydraulically powered bleed fan assembly, according to embodiments of the disclosure.

FIG. 10 is a schematic diagram of an example controller for controlling one or more operational aspects or parameters of a gas turbine engine, an intake air treatment system, and/or a bleed fan assembly, according to embodiments of the disclosure.

FIG. 11 is a flow diagram illustrating an example process for control of an intake air treatment system for cleaning/filtering intake air for supply to an air inlet assembly of a gas turbine engine, according to embodiments of the disclosure.

FIG. 12 is a block diagram of an example method for operating a bleed air assembly that generates bleed air flow through an intake air treatment system, according to embodiments of the disclosure.

FIG. 13 is a flow diagram illustrating another example process for control of an intake air treatment system for cleaning/filtering intake air for supply to an air inlet assembly of a gas turbine engine, according to embodiments of the disclosure.

FIG. 14 is a flow diagram illustrating still another example process for control of an intake air treatment system for cleaning/filtering intake air for supply to an air inlet assembly of a gas turbine engine, according to embodiments of the disclosure.

FIG. 15 is a flow diagram illustrating a further example process for control of an intake air treatment system for cleaning/filtering intake air for supply to an air inlet assembly of a gas turbine engine, according to embodiments of the disclosure.

FIG. 16A-16B are block diagrams of further example methods of operating a bleed air assembly that generates bleed air flow through an intake air treatment system, according to embodiments of the disclosure.

FIG. 17 is a flow diagram illustrating a further example process for control of an intake air treatment system for cleaning/filtering intake air for supply to an air inlet assembly of a gas turbine engine, according to embodiments of the disclosure.

FIG. 18 is a block diagram of another example method of operating a bleed air assembly that generates bleed air flow through an intake air treatment system, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to,” unless otherwise stated. Thus, the use of such terms is meant to encompass the items listed thereafter, and equivalents thereof, as well as additional items. The transitional phrases “consisting of” and “consisting essentially of,” when present, are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements. In addition, as used herein, the terms “axial” and “axially” generally mean along or parallel to a given axis (e.g., such as a central axis of a body or a port), while the terms “radial” and “radially” generally mean perpendicular to the given axis. For instance, an axial distance refers to a distance measured along or parallel to the axis, and a radial distance means a distance measured perpendicular to the axis.

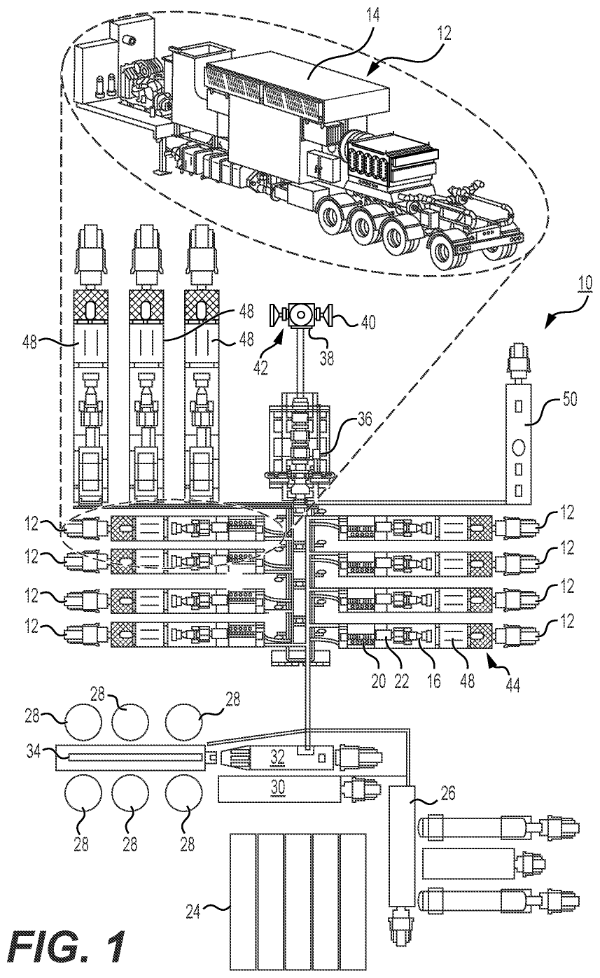

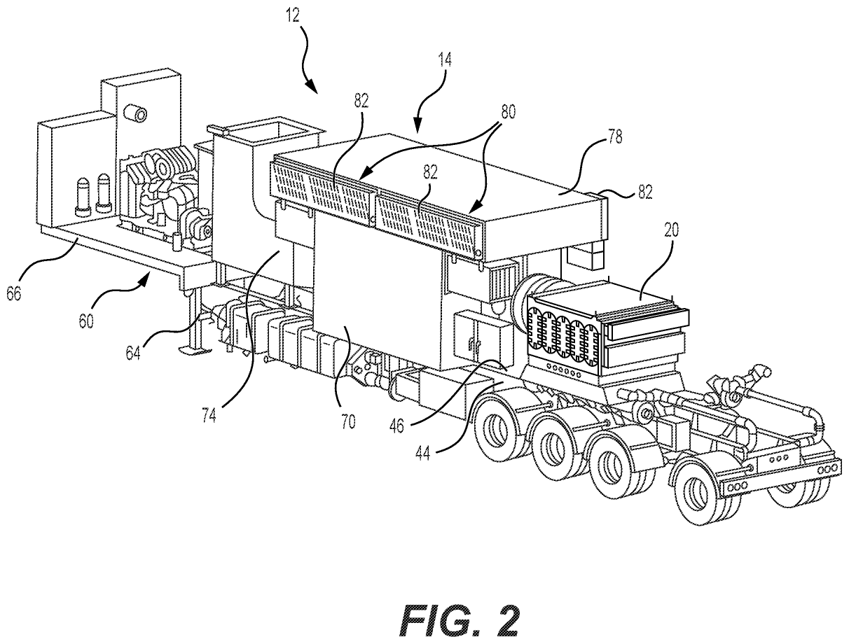

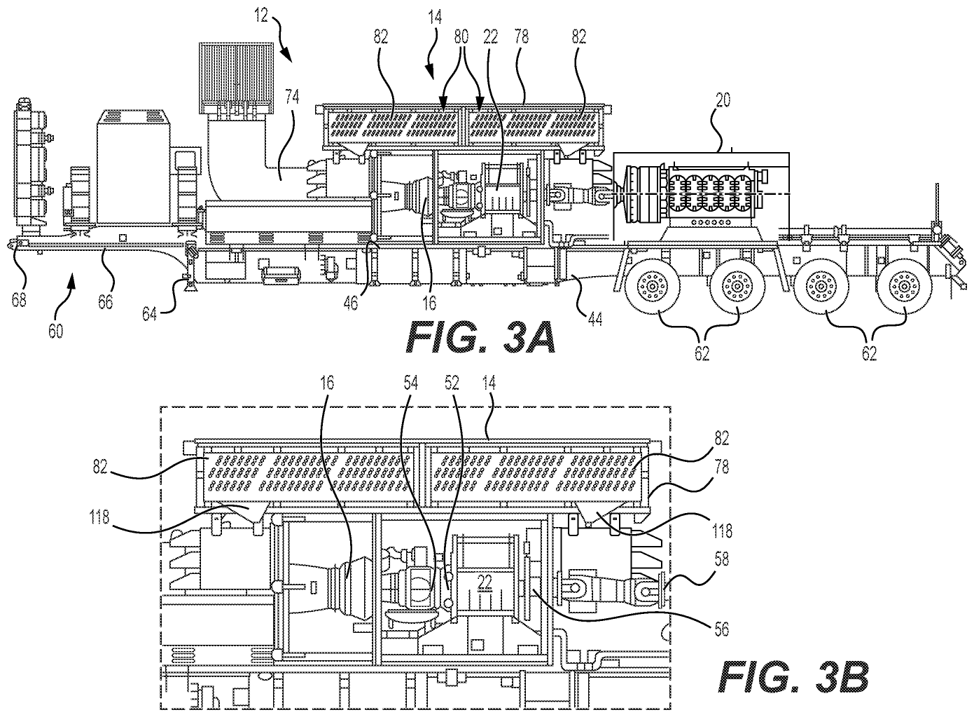

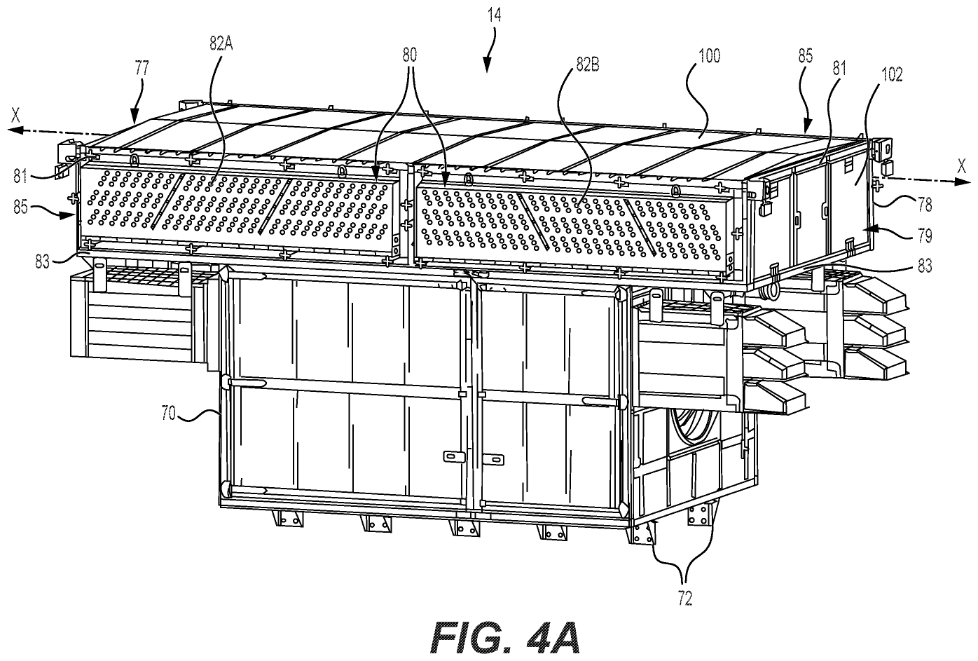

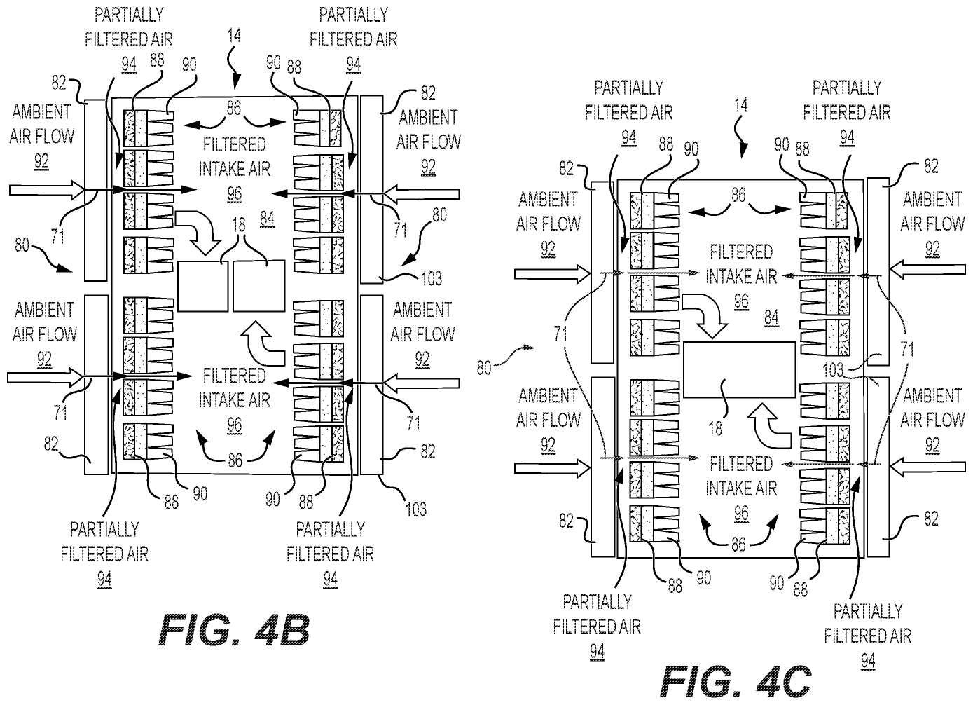

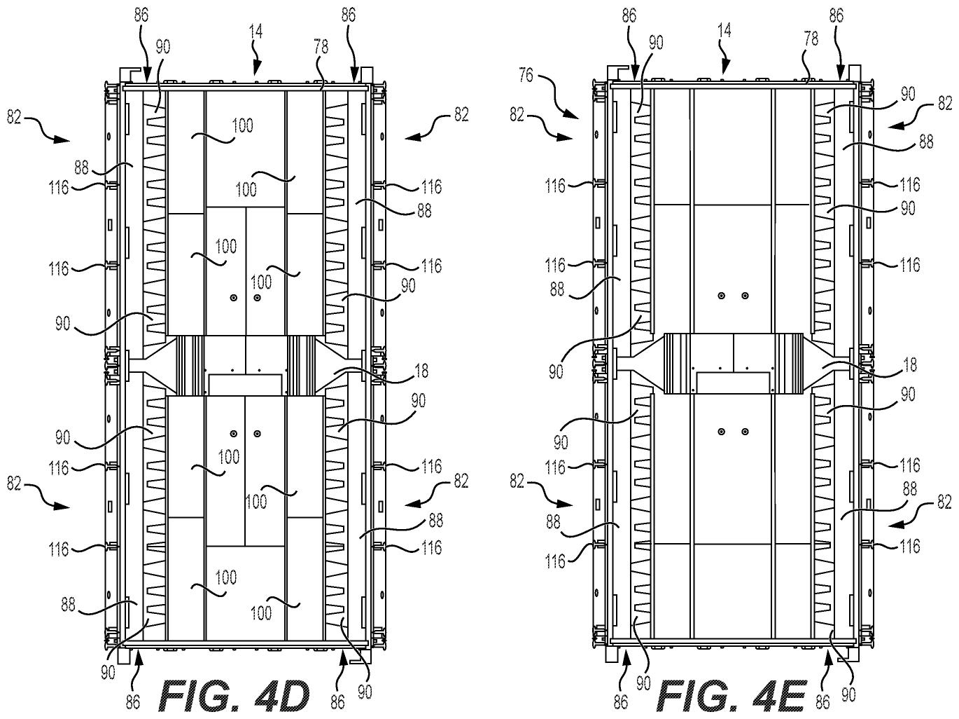

FIG. 1 schematically illustrates a top view of an example hydraulic fracturing system 10 including a plurality of hydraulic fracturing units 12, according to embodiments of the disclosure. FIG. 2 is a schematic perspective view of an example hydraulic fracturing unit 12, according to embodiments of the disclosure. FIG. 3A is a schematic partial side section view of an example hydraulic fracturing unit 12, and FIG. 3B is a detailed partial side section view of an example filtration assembly 14 of the example hydraulic fracturing unit 12 shown in FIG. 3A, according to embodiments of the disclosure. As explained herein, a filtration assembly 14, in some embodiments, may be configured to enhance the efficiency of operation of a prime mover, such as a gas turbine engine (GTE) 16, including an air inlet assembly 18 (FIGS. 4A-4B) positioned to supply intake air to the GTE 16.

As shown in FIGS. 3A and 3B, in some embodiments, one or more of the hydraulic fracturing units 12 may include a hydraulic fracturing pump 20 driven by a GTE 16. In some embodiments, the prime mover may be a type of internal combustion engine other than a GTE, such as a reciprocating-piston engine (e.g., a diesel engine). In some embodiments, each of the hydraulic fracturing units 12 may include a directly-driven turbine (DDT) hydraulic fracturing pump 20, in which the hydraulic fracturing pump 20 is connected to one or more GTEs 16 that supply power to the respective hydraulic fracturing pump 20 for supplying fracturing fluid at high pressure and high flow rates to a formation. For example, the GTE 16 may be connected to a respective hydraulic fracturing pump 20 via a transmission 22 (e.g., a reduction gearbox) connected to a drive shaft, which, in turn, is connected to a driveshaft or input flange of a respective hydraulic fracturing pump 20, which may be a reciprocating hydraulic fracturing pump. Other types of engine-to-pump arrangements are contemplated as will be understood by those skilled in the art.

In some embodiments, one or more of the GTEs 16 may be a dual-fuel or bi-fuel GTE, for example, capable of being operated using of two or more different types of fuel, such as natural gas and diesel fuel, although other types of fuel are contemplated. For example, a dual-fuel or bi-fuel GTE may be capable of being operated using a first type of fuel, a second type of fuel, and/or a combination of the first type of fuel and the second type of fuel. For example, the fuel may include gaseous fuels, such as, for example, compressed natural gas (CNG), natural gas, field gas, pipeline gas, methane, propane, butane, and/or liquid fuels, such as, for example, diesel fuel (e.g., #2 diesel), bio-diesel fuel, bio-fuel, alcohol, gasoline, gasohol, aviation fuel, and other fuels as will be understood by those skilled in the art. Gaseous fuels may be supplied by CNG bulk vessels, a gas compressor, a liquid natural gas vaporizer, line gas, and/or well-gas produced natural gas. Other types and associated fuel supply sources are contemplated. The one or more GTEs 16 may be operated to provide horsepower to drive the transmission 22 connected to one or more of the hydraulic fracturing pumps 20 to fracture a formation during a well stimulation project or fracturing operation.

In some embodiments, the fracturing fluid may include, for example, water, proppants, and/or other additives, such as thickening agents and/or gels, such as guar. For example, proppants may include grains of sand, ceramic beads or spheres, shells, and/or other particulates, and may be added to the fracturing fluid, along with gelling agents to create a slurry as will be understood by those skilled in the art. The slurry may be forced via the hydraulic fracturing pumps 20 into the formation at rates faster than may be accepted by the existing pores, fractures, faults, or other spaces within the formation. As a result, pressure in the formation may build rapidly to the point where the formation fails and begins to fracture. By continuing to pump the fracturing fluid into the formation, existing fractures in the formation may be caused to expand and extend in directions away from a well bore, thereby creating additional air flow paths for hydrocarbons to flow to the well. The proppants may serve to prevent the expanded fractures from closing or may reduce the extent to which the expanded fractures contract when pumping of the fracturing fluid is ceased. Once the well is fractured, large quantities of the injected fracturing fluid may be allowed to flow out of the well, and the water and any proppants not remaining in the expanded fractures may be separated from hydrocarbons produced by the well to protect downstream equipment from damage and corrosion. In some instances, the production stream of hydrocarbons may be processed to neutralize corrosive agents in the production stream resulting from the fracturing process.

In the example shown in FIG. 1, the hydraulic fracturing system 10 may include one or more water tanks 24 for supplying water for fracturing fluid, one or more chemical additive units 26 for supplying gels or agents for adding to the fracturing fluid (e.g., guar, etc.), and one or more proppant tanks 28 (e.g., sand tanks) for supplying proppants for the fracturing fluid. The example hydraulic fracturing system 10 shown also includes a hydration unit 30 for mixing water from the water tanks 24 and gels and/or agents from the chemical additive units 26 to form a mixture, for example, gelled water. The example shown also includes a blender 32, which receives the mixture from the hydration unit 30 and proppants via conveyers 34 from the proppant tanks 28. The blender 32 may mix the mixture and the proppants into a slurry to serve as fracturing fluid for the hydraulic fracturing system 10. Once combined, the slurry may be discharged through low-pressure hoses, which convey the slurry into two or more low-pressure lines in a fracturing manifold 36. In the example shown, the low-pressure lines in the fracturing manifold 36 may feed the slurry to the hydraulic fracturing pumps 20 through low-pressure suction hoses as will be understood by those skilled in the art.

The hydraulic fracturing pumps 20, driven by the respective GTEs 16, discharge the slurry (e.g., the fracturing fluid including the water, agents, gels, and/or proppants) at high flow rates and/or high pressures through individual high-pressure discharge lines into two or more high-pressure flow lines, sometimes referred to as “missiles,” on the fracturing manifold 36. The flow from the high-pressure flow lines is combined at the fracturing manifold 36, and one or more of the high-pressure flow lines provide fluid flow to a manifold assembly 38, sometimes referred to as a “goat head.” The manifold assembly 38 delivers the slurry into a wellhead manifold 40. The wellhead manifold 40 may be configured to selectively divert the slurry to, for example, one or more wellheads 42 via operation of one or more valves. Once the fracturing process is ceased or completed, flow returning from the fractured formation discharges into a flowback manifold, and the returned flow may be collected in one or more flowback tanks as will be understood by those skilled in the art.

As schematically depicted in FIG. 1, FIG. 2, and FIG. 3A, one or more of the components of the fracturing system 10 may be configured to be portable, so that the hydraulic fracturing system 10 may be transported to a well site, quickly assembled, operated for a relatively short period of time, at least partially disassembled, and transported to another location of another well site for use. For example, the components may be connected to and/or supported on a chassis 44, for example, a trailer and/or a support incorporated into a truck, so that they may be easily transported between well sites. In some embodiments, the GTE 16, the hydraulic fracturing pump 20, and/or the transmission 22 may be connected to the chassis 44. For example, the chassis 44 may include a platform 46, and the transmission 22 may be connected to the platform 46, and the GTE 16 may be connected to the transmission 22. In some embodiments, the GTE 16 may be connected to the transmission 22 without also connecting the GTE 16 directly to the platform 46, which may result in fewer support structures being needed for supporting the GTE 16, hydraulic fracturing pump 20, and/or transmission 22 on the chassis 44.

As shown in FIG. 1, some embodiments of the hydraulic fracturing system 10 may include one or more fuel supplies 48 for supplying the GTEs 16 and any other fuel-powered components of the hydraulic fracturing system 10, such as auxiliary equipment, with fuel. The fuel supplies 48 may include gaseous fuels, such as compressed natural gas (CNG), natural gas, field gas, pipeline gas, methane, propane, butane, and/or liquid fuels, such as, for example, diesel fuel (e.g., #2 diesel), bio-diesel fuel, bio-fuel, alcohol, gasoline, gasohol, aviation fuel, and other fuels as will be understood by those skilled in the art. Gaseous fuels may be supplied by CNG bulk vessels, such as fuel tanks coupled to trucks, a gas compressor, a liquid natural gas vaporizer, line gas, and/or well-gas produced natural gas. The fuel may be supplied to the hydraulic fracturing units 12 by one of more fuel lines supplying the fuel to a fuel manifold and unit fuel lines between the fuel manifold and the hydraulic fracturing units 12. Other types and associated fuel supply sources and arrangements are contemplated as will be understood by those skilled in the art.

As shown in FIG. 1, some embodiments also may include one or more data centers 50 configured to facilitate receipt and transmission of data communications related to operation of one or more of the components of the hydraulic fracturing system 10. Such data communications may be received and/or transmitted via hard-wired communications cables and/or wireless communications, for example, according to known communications protocols. For example, the data centers 50 may contain at least some components of a hydraulic fracturing control assembly, such as a supervisory controller configured to receive signals from components of the hydraulic fracturing system 10 and/or communicate control signals to components of the hydraulic fracturing system 10. The hydraulic fracturing control assembly may, for example, at least partially control operation of one or more components of the hydraulic fracturing system 10, such as, for example, the GTEs 16, the hydraulic fracturing pumps 20, and/or the transmissions 22 of the hydraulic fracturing units 12, the chemical additive units 26, the hydration units 30, the blender 32, the conveyers 34, the fracturing manifold 36, the manifold assembly 38, the wellhead manifold 40, and/or any associated valves, pumps, and/or other components of the hydraulic fracturing system 10.

As shown in FIGS. 3A and 3B, in some embodiments, the transmission 22 may include a transmission input shaft 52 connected to a prime mover output shaft 54 (e.g., a turbine output shaft), such that the transmission input shaft 52 rotates at the same rotational speed as the prime mover output shaft 54. The transmission 22 may also include a transmission output shaft 56 positioned to be driven by the transmission input shaft 52 at a different rotational speed than the transmission input shaft 52. In some embodiments, the transmission 22 may be a reduction gearbox, which results in the transmission output shaft 56 having a relatively slower rotational speed than the transmission input shaft 52. The transmission 22 may include a continuously variable transmission, an automatic transmission including one or more planetary gear trains, a transmission shiftable between different ratios of input-to-output, etc., or any other suitable of types of transmissions as will be understood by those skilled in the art.

As shown in FIGS. 3A and 3B, in some embodiments, the hydraulic fracturing pump 20 may be, for example, a reciprocating fluid pump, as explained herein. In some embodiments, the hydraulic fracturing pump 20 may include a pump drive shaft 58 connected to the transmission output shaft 56, such that the transmission output shaft 56 drives the pump drive shaft 58 at a desired rotational speed. For example, the transmission output shaft 56 may include an output shaft connection flange, and the pump drive shaft 58 may include a drive shaft connection flange, and the output shaft connection flange and the drive shaft connection flange may be coupled to one another, for example, directly connected to one another. In some embodiments, the transmission output shaft 56 and the pump drive shaft 58 may be connected to one another via any known coupling types as will be understood by those skilled in the art (e.g., such as a universal joint and/or a torsional coupling).

As shown in FIGS. 2 and 3A, in some embodiments, the chassis 44 may be or include a trailer 60 including the platform 46 for supporting components of the hydraulic fracturing unit 12, one or more pairs of wheels 62 facilitating movement of the trailer 60, a pair of retractable supports 64 to support the hydraulic fracturing unit 12 during use, and a tongue 66 including a coupler 68 for connecting the trailer 60 to a truck for transport of the hydraulic fracturing unit 12 between well sites to be incorporated into a hydraulic fracturing system 10 of a well site fracturing operation, as will be understood by those skilled in the art.

As shown in FIGS. 2, 3A, and 3B, in some embodiments, the hydraulic fracturing unit 12 may include a turbine housing 70 configured to at least partially enclose the GTE 16 and the air inlet assembly 18 thereof, and the filtration assembly 14. The turbine housing 70 may be positioned to facilitate supply of intake air to the air inlet assembly 18 of the GTE 16. The air inlet assembly 18 may include one or more air intake ducts (17a, 17b (see embodiments in FIG. 4B); 19 (see embodiment in FIG. 4C)) passing through walls of the turbine housing 70 and connected to the GTE 16. The turbine housing 70 may be connected to a turbine exhaust duct 74 configured to expel exhaust produced by the GTE 16. The turbine housing 70 may be connected to and supported by the chassis 44 according to embodiments of the disclosure. In some embodiments, the turbine housing 70 may connect to the chassis 44 of the hydraulic fracturing unit 12 via, for example, one or more fasteners, adhesives, and/or welding (e.g., one or more fasteners 72 as shown in FIG. 4A and described herein below). In some embodiments, as shown in FIGS. 3A and 3B, the GTE 16 may be connected to the transmission 22 via the prime mover output shaft 54 and the transmission input shaft 52, both of which may be substantially contained within the turbine housing 70. The GTE 16 may be connected to the hydraulic fracturing pump 20 via the transmission 22, with the transmission output shaft 56 connected to the pump drive shaft 58, for example, as explained herein.

As shown in FIGS. 1, 2, 3A, and 3B, some embodiments of the hydraulic fracturing pump 20 may have physical dimensions configured such that the hydraulic fracturing pump 20 does not exceed the space available on the platform 46, for example, while still providing a desired pressure output and/or flow output to assist with performing the fracturing operation as explained herein. For example, the hydraulic fracturing pump 20 may have a pump length dimension substantially parallel to a longitudinal axis of the platform 46 that facilitates placement and/or connection of the hydraulic fracturing pump 20 on the platform 46, for example, without causing the hydraulic fracturing unit 12 to exceed a length permitted for transportation on public highways, for example, in compliance with government regulations.

In some embodiments, for example, as shown in FIG. 2, the hydraulic fracturing pump 20 may have a pump width dimension substantially perpendicular to a longitudinal axis of the platform 46 that facilitates placement and/or connection of the hydraulic fracturing pump 20 on the platform 46, for example, without causing the hydraulic fracturing unit 12 to exceed a width permitted for transportation on public highways, for example, in compliance with government regulations. For example, the hydraulic fracturing pump 20 may have a pump width perpendicular to the longitudinal axis of the platform 46, such that the pump width is less than or equal to the width of the platform 46, for example, as shown in FIG. 2.

As shown in FIGS. 2, 3A, and 3B, some embodiments of the filtration assembly 14 may include a filtration housing 78 connected to the turbine housing 70, or at least partially located within the turbine housing 70. FIG. 4A is a perspective view of an example filtration assembly 14, according to embodiments of the disclosure. The filtration housing 78 may be generally shaped as a rectangular parallelepiped that includes a central or longitudinal axis X (or more simply “axis X”), a first end 77, and a second end 79 opposite the first end 77 along axis X. In addition, the filtration housing 78 includes a top side 81 and a bottom side 83 that are radially opposite one another across axis X and that extend axially between the ends 77, 79 relative to axis X. Further, the filtration housing 78 includes two sides 85 that are radially opposite one another across axis X and that extend axially between the ends 77, 79 and that span or extend between the top side 81 and the bottom side 83. While the filtration housing 78 shown in FIG. 4A has a rectangular parallel piped shape as described herein, other or different shapes are contemplated (such as non-rectangular shapes) are contemplated in other embodiments. For instance, in some embodiments, the filtration housing 78 may have a curved, triangular, polygonal, etc. shape or cross-section (such as a cross section along or perpendicular to the axis X).

In some embodiments, the filtration assembly 14 may also include sound attenuation baffles 100 (or more simply “baffles 100”) arranged within the filtration housing 78 or along the filtration housing 78. As shown in FIG. 4A, in some embodiments, the filtration housing 78 may include sound attenuation baffles 100 positioned on the top member 81 of the filtration housing 78. The baffles 100 may have a chevron or A-frame cross-section along a radius of the axis X such that the baffles 100 may angle “upward” or away from axis X when moving from the sides 85 toward the axis X. As additionally shown in FIGS. 4D and 4E, in some embodiments, the filtration assembly 14 may also include the baffles 100 arranged within or along the filtration housing 78.

In addition, in some embodiments, the turbine housing 70 may include one or more fasteners 72 positioned to facilitate connection of the turbine housing 70 to the chassis 44 of the hydraulic fracturing unit 12. For example, as shown in FIG. 4A, the turbine housing 70 may connect to the chassis 44 of the hydraulic fracturing unit (as shown in FIGS. 2, 3A, and 3B) via the one or more fasteners 72 located toward the bottom of the turbine housing 70.

The filtration housing 78 may at least partially enclose the air inlet assembly 18 of the GTE 16. In addition, the filtration assembly 14 may include pre-cleaners 80 positioned along one or both of the side(s) 85 of the filtration housing 78 to receive ambient air 92 drawn into and through the filtration assembly 14 via operation of the GTE 16, as shown in FIGS. 4B and 4C. In some embodiments, the pre-cleaners 80 may include one or more inertial separators 82 each configured to separate a first portion of particles, liquids, and/or combinations thereof from the ambient air 92, thereby to provide at least partially filtered intake air 94 for use by the GTE 16 during operation. For example, as shown in FIG. 4A, the pre-cleaner 80 may include one or more inertial separators (e.g., inertial separators 82a and 82b) positioned on one of the sides 85, extending axially between the ends 77, 79 of the filtration housing 78. The inertial separator 82a may be positioned proximate to the end 77 of the filtration housing 78 and the inertial separator 82b may be positioned proximate to the end 79 of the filtration housing 78. The pre-cleaner 80 including two inertial separators is depicted in FIGS. 2-4A; however, the pre-cleaner 80 may include a plurality (e.g., or one or more) of inertial separators 82 connected to the filtration housing 78 in a similar manner according to some embodiments.

In some embodiments, the filtration housing 78 may be positioned to facilitate supply of filtered intake air to the air inlet assembly 18 of the GTE 16, via one or more intake ducts, for example, as shown in FIGS. 4B and 4C. FIGS. 4B and 4C show schematic views of example filtration assemblies 14 with pre-cleaners 80 (e.g., one or more inertial separators 82) positioned along the sides 85 of the filtration assemblies 14. As shown in FIGS. 4B and 4C, in some embodiments, as an air flow path 71 is defined through the filtration housing 78, extending through one or more inertial separators 82 and one or more additional filters 86, and along which the ambient air 92 may pass through for cleaning/filtering of the ambient air 92 to provide a supply of filtered air to the air inlet assembly 18 of the GTE 16. In some embodiments, the inertial separators 82 may be positioned upstream of an intake air chamber 84 and a plurality of additional filters 86 located along the sides within the filtration housing 78. As indicated in FIGS. 4B and 4C, the ambient air flow 92 will pass through the inertial separators 82 and through the additional filters 86 into the intake air chamber 84 of the filtration assembly 14 for supply to the air intake ducts (17a, 17b, 19) of the one or more GTEs 16, according to embodiments of the disclosure.

The ambient air flow 92, particularly in harsh environments common to oilfield operations, may include contaminates, such as particles, liquids, and/or combinations thereof, including, for example, sand, dust, dirt, water, ice, proppants, and/or fracturing fluid additives, such as thickening agents and/or gels, such as guar. For example, proppants may include grains of sand, ceramic beads or spheres, shells, and/or other particulates, along with gelling agents, and such materials may become suspended in the ambient air and drawn into the GTE 16 during operation, unless separated from the ambient air, for example, via the pre-cleaners 80 and/or other types of filtration. In some embodiments, the one or more pre-cleaners 80 may be configured to separate one or more of these contaminates from ambient air 92 supplied to the GTE 16 during operation to prevent damage to components of the GTE 16 and/or to reduce maintenance and/or downtime associated with the GTE 16, for example, as discussed herein.

In some embodiments, the intake air chamber 84 may be defined within the interior of the filtration assembly 14. As also shown in FIGS. 4B-4C, one or more air intake ducts (17a, 17b, 19) may be in fluid communication with the intake air chamber 84, e.g., a proximal or open end of one or more air intake ducts (17a, 17b, 19) may extend or open into the intake air chamber 84, to receive filtered intake air 96. In addition, the additional filters 86 may be arranged along the sides of the intake air chamber 84 and positioned in the air flow path downstream of the one or more inertial separators 82. The additional filters 86 may be configured to separate a second portion of the particles, liquids, and/or combinations thereof from the at least partially filtered intake air 94 received from the one or more inertial separators 82, thereby to provide at least partially (e.g., further) filtered intake air to the air intake ducts (17a, 17b, 19) of the one or more GTEs 16. For example, the one or more additional filters 86 may serve to separate an additional or second portion of particles, liquids, and/or combinations thereof from the partially filtered air 94 received from the one or more inertial separators 82.

In some embodiments, the inertial separators 82 of each of the pre-cleaners 80 may be configured to separate relatively larger particles and/or larger liquid droplets from the ambient air, and the additional filters 86 may be configured to separate relatively smaller particles and/or larger liquid droplets from the partially filtered ambient air received from the inertial separators. Use of the inertial separators 82, in some embodiments as described herein, may reduce the frequency with which the additional filters 86 need to be serviced or replaced and/or the filtration chamber purged of collected particles, liquids, and/or combinations thereof, due to obstruction or clogging by particles, liquids, and/or combinations thereof, in the ambient air.

In some embodiments, as shown in FIGS. 4B and 4C, the one or more additional filters 86 may include one or more pre-filters 88 and/or one or more final filters 90, and in some embodiments, additional filtration downstream of the pre-filters 88 and/or the final filters 90. In some embodiments, the one or more pre-filters 88 may include one or more medium-efficiency intermediate filters (e.g., one or more cartridge-type pre-filters and/or bag-type pre-filters), and the one or more final filters 90 may include one or more high-efficiency final filters.

As indicated in FIGS. 4B-4C, in some embodiments, during operation of the GTE 16, ambient air 92 is drawn into the filtration housing 78 and along the air flow path 71 through the one or more inertial separators 82. As described herein, the inertial separators 82 may include one or more separator tubes 114 configured to separate a first portion of particles, liquids, and/or combinations thereof from the ambient air 92, thereby to provide at least partially filtered intake air 94 thereafter. The at least partially filtered intake air 94 may be further drawn into and through the one or more additional filters 86, including, in at least some embodiments, the pre-filters 88 and/or the final filters 90 downstream along the air flow path 71 relative to the inertial separators 82. The one or more additional filters 86 may be configured to separate a second portion of the particles, liquids, and/or combinations thereof, from the at least partially filtered intake air 94, thereby to provide the resultant filtered intake air 96.

In some embodiments, the filtered intake air 96 may be supplied to the air inlet assembly 18 of the GTE 16, with or without additional filtration. As also shown in FIGS. 4B-4C, in some embodiments, the air inlet assembly 18 may comprise a single air intake duct (19 (see embodiment in FIG. 4C), or, in other embodiments, may be separated into two or more separate air intake ducts (17a, 17b (see embodiment in FIG. 4B), each of which may be configured to supply filtered intake air (e.g., 96) to one or more GTEs 16.

As previously described, in some embodiments, the filtration assembly 14 may also include the baffles 100 arranged within or along the filtration housing 78. FIG. 4D is a schematic top view of an example intake air treatment assembly including example sound attenuation baffles, according to embodiments of the disclosure, and FIG. 4E is a schematic top view of another example filtration assembly 14 without sound attenuation baffles, according to embodiments of the disclosure. As shown in FIG. 4D, in some embodiments, the filtration assembly 14 may include one or more sound attenuation baffles 100 received in the intake air chamber 84 and configured to reduce sound generated during operation of the GTE 16 caused by air drawn into the intake air chamber 84 during operation of the GTE 16. For example, as shown in FIG. 4D, the sound attenuation baffles 100 may positioned downstream relative to the inertial separators 82 and the additional filters 86, but upstream relative to the air inlet assembly 18, which may include an inlet plenum (and/or inlet manifold), for example, as shown in FIGS. 4D and 4E.

In some embodiments, the filtration housing 78 may include one or more access panels 102 positioned to facilitate access to the intake air chamber 84 of the filtration assembly 14, as shown in FIG. 4A. For example, the access panels 102 may enable maintenance or replacement of the additional filters 86 and/or the sound attenuation baffles 100, for example, if the intake air chamber 84 houses the sound attenuation baffles 100 (as shown FIG. 4D).

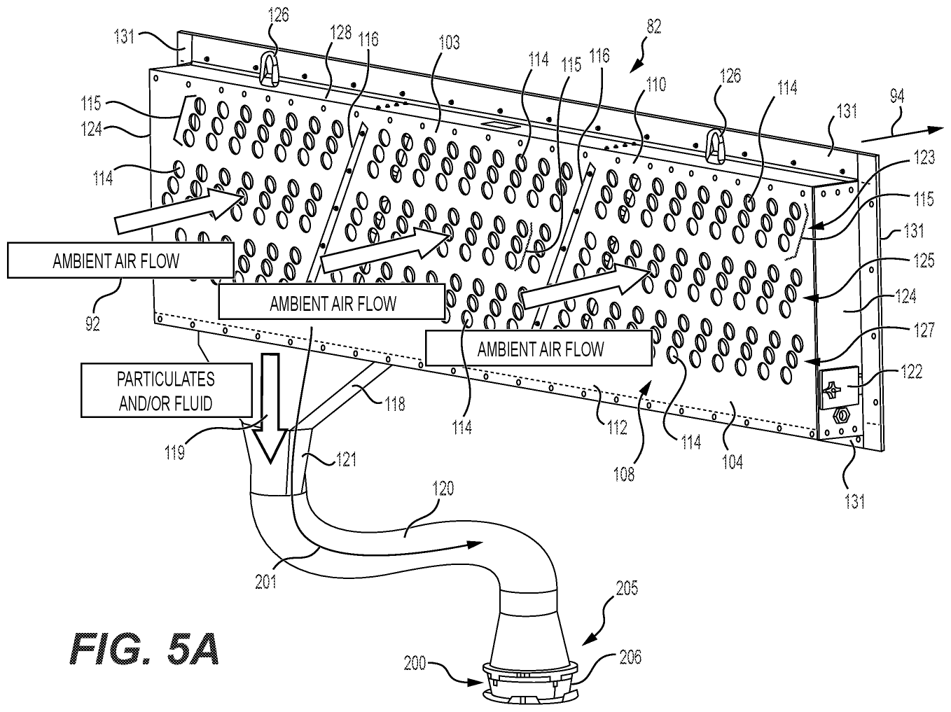

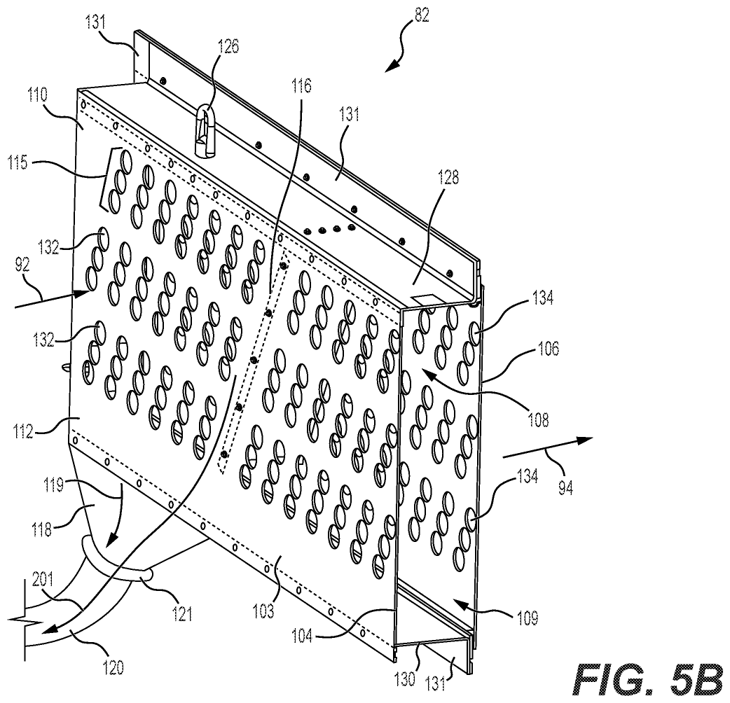

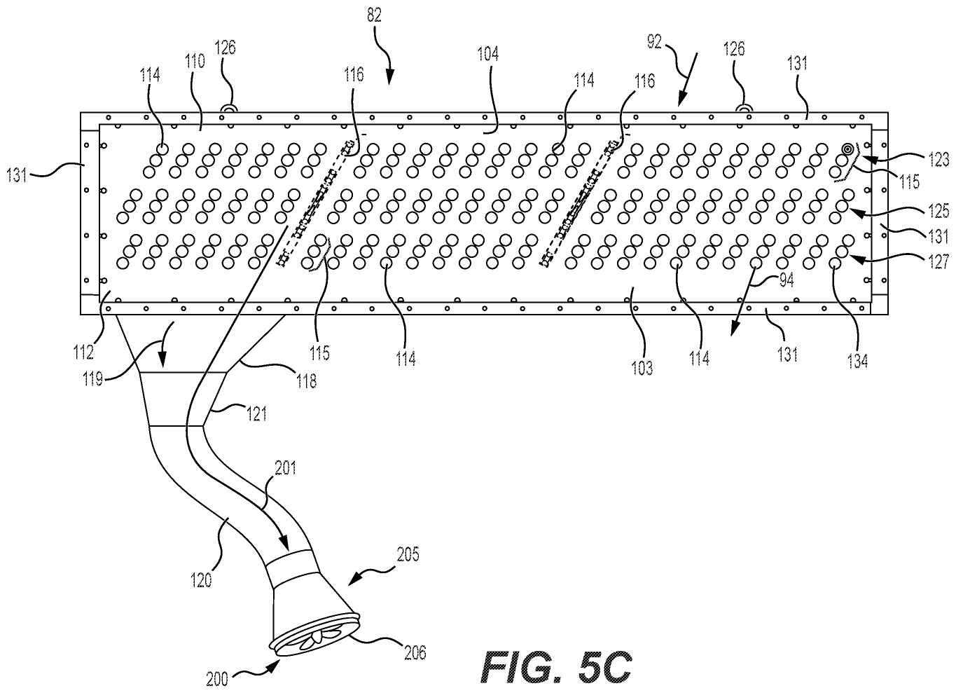

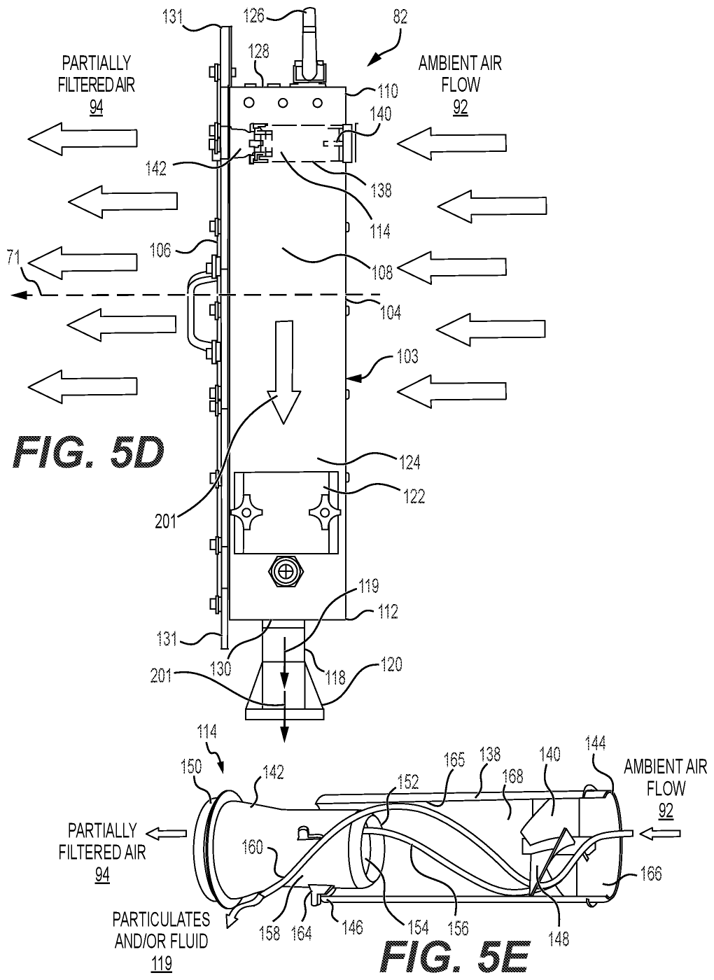

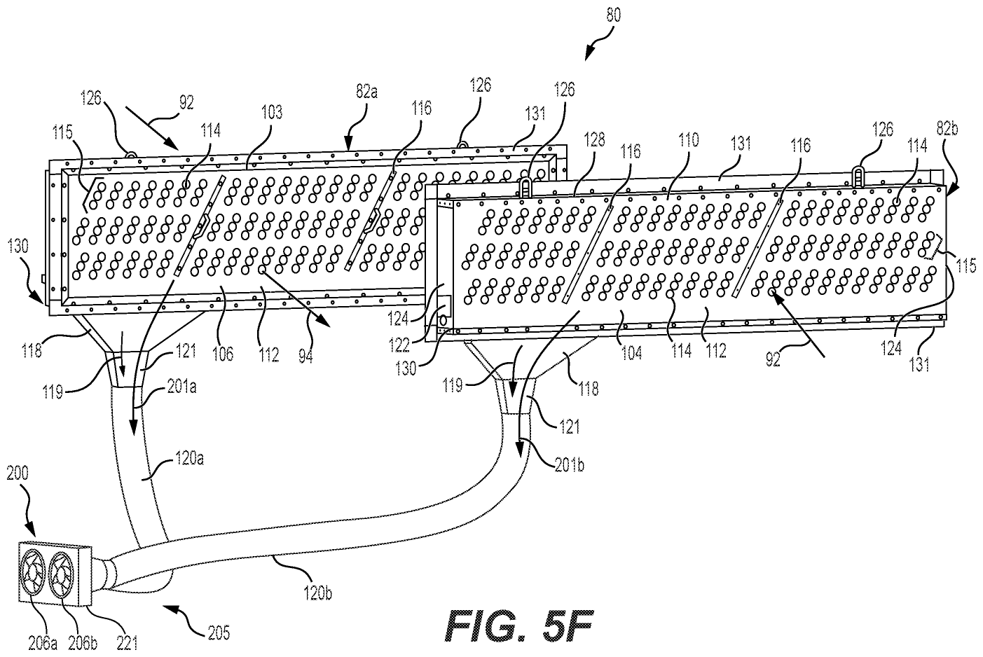

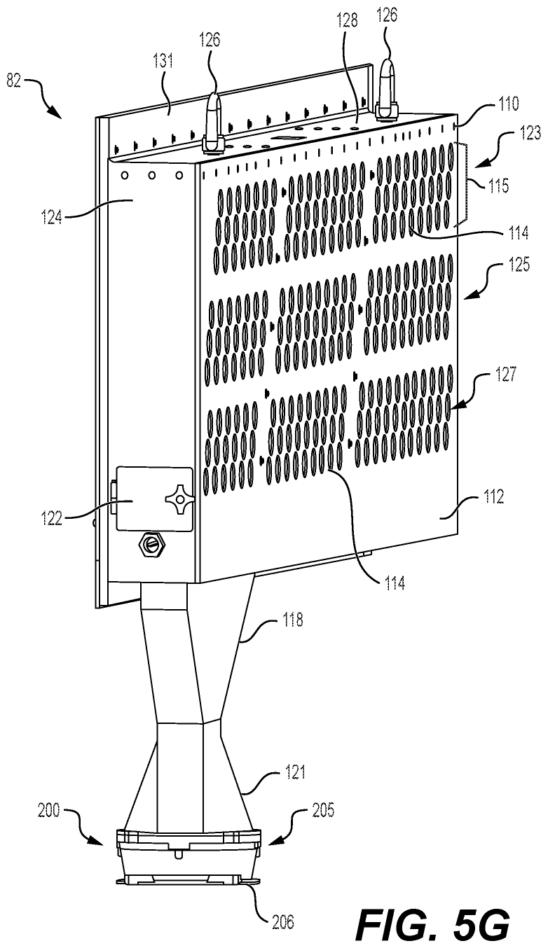

FIG. 5A, FIG. 5B, FIG. 5C, FIG. 5D, FIG. 5E, FIG. 5F, and FIG. 5G are schematic views of example inertial separators 82, according to embodiments of the disclosure. In some embodiments, one or more inertial separators 82 may be positioned along one or more of the sides 85 of the filtration housing 78 (e.g., as shown in FIGS. 4A-4E), and may include a plurality of separator tubes 114 configured to separate at least a first portion of particles, liquids, and/or combinations thereof 119, from the ambient air 92 passing along the air flow path 71 through each inertial separator, to provide at least partially filtered intake air 94 (see, e.g., FIGS. 4B and 4C). FIG. 5A is a schematic perspective view of the example inertial separator 82 viewed from an exterior side and FIG. 5B is a perspective partial section view of the example inertial separator 82 shown in FIG. 5A, according to embodiments of the disclosure. As shown in FIGS. 5A and 5B, in some embodiments, each of the inertial separators 82 may include a body 103 at least partially comprising an exterior panel 104 facing outward from the filtration assembly 14, and an interior panel 106 radially opposite the exterior panel 104 and facing inward toward the interior of the filtration assembly 14, for example, toward the intake air chamber 84 and the additional filters 86 (FIGS. 4B-4C). The exterior panel 104 and the interior panel 106 of the body 103 may at least partially define an interior chamber or separation cavity 108 (or more simply “separation cavity 108”) of the inertial separator 82, for example, as shown in FIG. 5B.

As further shown in FIGS. 5A, 5B, 5C, 5D, and 5F, the exterior panel 104 and/or the interior panel 106 may at least partially define an upper end 110 and a lower end 112 of the body 103 of the inertial separator 82. The plurality of separator tubes 114 may extend through the body 103, e.g., through the separation cavity 108, and may be arranged in groups 115 extending diagonally between the upper end 110 and the lower end 112 of the inertial separator 82. For example, as shown in FIGS. 5A, 5B, 5C, and 5F, the groups 115 of separator tubes 114 may include two or more separator tubes 114 (e.g., groups of three separator tubes 114 as shown) and/or the groups 115 may be arranged in sets of two, three, or more groups 115 spaced from one another lengthwise and/or height-wise across and along the body 103 of the inertial separator 82. For example, as shown, the groups 115 of separator tubes 114 may be spaced width-wise across the body 103 of each inertial separator 82 forming one or more rows of separator tubes 114 (e.g., three rows of groups 115 as shown) and vertically between the upper ends 110 and lower ends 112 of the body 103 of each inertial separator 82. As shown in FIGS. 5A and 5C, in some embodiments, the groups 115 of separator tubes may be arranged in a first row 123 proximal to the upper end 110, extending longitudinally across the body 103 of the inertial separator 82, a third row 127 proximal to the lower end 112, extending longitudinally across the body 103 of the inertial separator 82, and a second row 125 positioned between vertically between the first row 123 and the third row 127, extending longitudinally across the body 103 of the inertial separator. While the inertial separators 82 shown in FIGS. 5A-5C have the groups 115 of separator tubes arranged in three rows (e.g., 123, 125, and 127) as described herein, different number of rows are contemplated (such as four or five rows). In some embodiments, the spacing of the separator tubes 114 may facilitate internal reinforcement of the body 103 of each inertial separator 82, for example, with internal bracing 116 to prevent the exterior panel 104 and/or the interior panel 106 from deflecting toward one another and/or collapsing during operation of the GTE 16. In some embodiments, the spacing and/or the diagonal arrangements of the groups 115 of separator tubes 114 may allow particles, liquids, and/or combinations thereof, separated from the ambient air 92 by the separator tubes 114 of the inertial separators 82, to fall or drop to a lower end 109 of the separation cavity 108 to facilitate removal of such separated particles, liquids, and/or combinations thereof, from the inertial separator 82. Other configurations of the separator tubes 114 are contemplated. In some embodiments, the separator tubes 114 may not be arranged in groups across one or more of the inertial separators 82.

As shown, in some embodiments, a duct or pre-cleaner bypass 118 may be connected to each inertial separator 82, being positioned along the bottom of the body 103 of the inertial separator 82 and in fluid communication with the separation cavity 108 (FIG. 5B) so as to receive ambient air expelled from the separator tubes 114 that does not exit the inertial separator 82 via the interior panel 106 and/or that includes the first portion of the particles, liquids, and/or combinations thereof 119, separated from the ambient air 92. For example, some of the ambient air 92 entering the inertial separator 82 may be expelled from the inertial separator 82 via the pre-cleaner bypass 118. In some embodiments, the first portion of the particles, liquids, and/or combinations thereof, separated from the ambient air 92 may fall or drop toward the lower end 109 of the separation cavity 108 of each inertial separator 82 and may pass through the pre-cleaner bypass 118, which directs the separated or filtered particles, liquids, and/or combinations thereof 119, to a conduit 120 for removal of the separated or filtered particles, liquids, and/or combination thereof, in the direction of arrow 119, out of the filtration assembly 14. For example, as shown in FIGS. 5A-5F, the pre-cleaner bypass 118 may be connected to the conduit 120by a duct adapter or coupling 121 configured to draw-off the ambient air and/or the first portion of the particles, liquids, and/or combinations thereof, passing into the pre-cleaner bypass 118 from the inertial separators 82. In some embodiments, as shown in FIGS. 5A, 5C, and 5F, the conduit 120 may connect to a bleed air system 200 including a bleed airflow generator 205 and one or more fans or blowers 206 (or more simply “one or more fans 206”), configured to assist in expelling the ambient air and/or first portion of the particles, liquids, and/or combinations thereof separated by the inertial separators (as described in further detail below). In some embodiments, as shown in FIG. 5G, the pre-cleaner bypass 118 may be connected to one or more fans 206 of a bleed air system 200 via the duct adapter or coupling 121 which may provide a direct communication of the bleed airflow 201 channels of the inertial separators 82, as described in more detail below.

FIG. 5F is a partial side section view of an example configuration of a plurality of inertial separators with remotely located/mounted fans of a bleed air system, according to embodiments of the disclosure. As shown in FIG. 5F, a bleed airflow generator 205 of a bleed air system 200 may include one or more fans 206, identified respectively as 206a, 206b. The one or more fans 206 may be configured to supply a bleed airflow 201, identified respectively as 201a, 201b, through each respective inertial separator (e.g., 82a, 82b) via each respective conduit 120, identified respectively as 120a, 120b, as described in more detail below. For example, as shown in FIG. 5F, the fan 206b of the bleed air system 200 may generate the bleed airflow 201b to pass through the inertial separator 82b and to assist in expelling the ambient air 92 and/or first portion of the particles, liquids, and/or combinations thereof separated by the inertial separator 82b.

As shown in FIGS. 5A and 5D, in some embodiments, the inertial separator 82 may include one or more access plates 122 which may enable access to the separation cavity 108, for example, to service the inertial separator 82; for example, to remove larger particles, or liquids, and/or combinations thereof, that may not be removed through the conduit 120 that fall or drop into the lower end 109 of the separation cavity 108. In some embodiments, for example, the inertial separator 82 may include side panels 124 at opposite longitudinal ends thereof, extending between the exterior panel 104 and the interior panel 106, and the one or more access plates 122 located at lower ends of the side panels 124 (as shown in FIGS. 5A, 5D, 5F, and 5G).

In some embodiments, each inertial separator 82 may include one or more lifting fixtures 126 configured to facilitate lifting and mounting of each inertial separator 82. Such lifting fixtures 126 may include, for example, hooks, eyebolts, and/or other devices to facilitate lifting of each inertial separator 82 via a lifting mechanism, such as a forklift or crane. As shown in FIGS. 5A and 5B, in some embodiments, the inertial separator 82 may include an upper panel 128 and a lower panel 130 located at the upper end 110 and the lower end 112, respectively, of the body 103 of the inertial separator 82, extending between the exterior panel 104 and the interior panel 106. In some embodiments, the one or more lifting fixtures 126 may be located along the upper panel 128 of the body 103 of the inertial separator 82. The side panels 124, the upper panel 128, and the lower panel 130 may at least partially define the separation cavity 108 of the inertial separator 82.

In some embodiments, each inertial separator 82 may include one or more flanges 131 extending outward from a perimeter of the inertial separator 82 to facilitate connection of the inertial separator 82 to the filtration assembly 14 (via the filtration housing 78). For example, as shown in FIGS. 5A-5C, the inertial separator 82 may include one or more flanges 131 positioned along a perimeter of the interior panel 106 of the inertial separator 82 and may facilitate connection of the inertial separator 82 to the filtration housing 78 via, for example, one or more fasteners, adhesives, and/or welding.

As shown in FIG. 5B, for example, in some embodiments, the exterior panel 104 of the body 103 of each inertial separator 82 may include one or more exterior holes 132, and the interior panel 106 of the body 103 of each inertial separator 82 may include one or more interior holes 134, each configured to provide mounting points for the one or more separator tubes 114, for example, as described with respect to FIGS. 5A-5C.

As schematically shown in FIG. 5D, the separator tubes 114 may each extend between the exterior panel 104 and the interior panel 106 of the inertial separator 82, with opposite ends of the separator tubes being connected to the exterior panel 104 and the interior panel 106 at respective exterior holes 132 and interior holes 134. The exterior holes 132 may provide a pathway or opening through which the ambient air flow 92 is received into the inertial separator 82 via the separator tubes 114. The interior holes 134 may provide a pathway or opening through which the partially filtered intake air flow 94 from the inertial separator 82 is received into the intake air chamber 84.

In some embodiments, each inertial separator 82 may include one or more (e.g., a plurality of) separator tubes 114 configured to separate a first portion of particles, liquids, and/or combinations thereof 119, from the ambient air 92, thereby to provide the at least partially filtered intake air 94 for operation of the GTE 16. For example, as shown in FIG. 5D and FIG. 5E, each of the one or more separator tubes 114 may include an air flow inlet tube 138, a diverter 140, and/or air outlet tube 142. In embodiments, the air flow inlet tube 138 may have a proximal end 144 connected to the exterior panel 104, may extend toward the interior panel 106, and may terminate at a distal end 146. In some embodiments, the diverter 140 may be connected to the air flow inlet tube 138 and may be positioned to create turbulence in the ambient air, for example, by causing the ambient air 92 entering the air flow inlet tube 138 to swirl as the ambient air 92 flows from the proximal end 144 of the air flow inlet tube 138 to the distal end 146 of the air flow inlet tube 138, for example, as schematically depicted in FIG. 5E. In embodiments, the diverter 140 may include one or more stator blades 148 presenting one or more curved surfaces to create the turbulence in the incoming flow of ambient air 92, e.g., to cause the ambient air 92 entering the air flow inlet tube 138 to swirl as the ambient air 92 passes the one or more stator blades 148 and flows from the proximal end 144 of the air flow inlet tube 138 to the distal end 146 of the air flow inlet tube 138.

As shown in FIG. 5E, in some embodiments, the air outlet tube 142 may be connected to the interior panel 106 and may extend from the interior panel 106 toward the proximal end 144 of the air flow inlet tube 138. The air outlet tube 142 may have a proximal end 150 connected to the interior panel 106 and may terminate at a distal end 152. As shown, in some embodiments, the air flow inlet tube 138 may define an interior cross-sectional area, and the air outlet tube 142 may have an exterior cross-sectional area smaller than the interior cross-sectional area of the air flow inlet tube 138, for example, and the distal end 152 of the air outlet tube 142 may be received in the distal end 146 of the air flow inlet tube 138, such that the distal end 152 of the air outlet tube 142 terminates between the distal end 146 and the proximal end 144 of the air flow inlet tube 138.

In some embodiments, as shown in FIG. 5E, the air outlet tube 142 may be connected to the interior panel 106, such that an interior passage 154 of the air outlet tube 142 provides a first separator flow path 156 for the at least partially filtered intake air 94 to exit the separator tube 114 through the interior passage 154 of the air outlet tube 142 and the interior hole 134 of the interior panel 106. For example, as shown in FIG. 5E, the air outlet tube 142 may be positioned relative to the distal end 146 of the air flow inlet tube 138 to provide the first separator flow path 156 for the at least partially filtered intake air 94 to exit the inertial separator 82 through the interior passage 154 of the air outlet tube 142. In some embodiments, the distal end 146 of the air flow inlet tube 138 (e.g., at an interior surface 166 of the air flow inlet tube 138) may be connected to the air outlet tube 142 (e.g., at an exterior surface 158 of the air outlet tube 142) such that an interior passage 168 of the air flow inlet tube 138 provides a second separator flow path 160 for the first portion of particles, liquids, and/or combinations thereof 119, separated from the ambient air 92 entering into each separator tube 114, to be discharged from the separator tubes 114 and into the separation cavity 108. In addition, as also shown in FIG. 5E, one or more struts 164 may connect the exterior surface 158 of the distal end 152 of the air outlet tube 142 to the distal end 146 of the air flow inlet tube 138.

In some embodiments, the second separator flow path 160 may be configured and/or positioned to deposit the first portion of particles, liquids, and/or combinations thereof 119, into the separation cavity 108 (FIG. 5B). For example, the distal end 146 of the air flow inlet tube 138 may terminate between the exterior panel 104 and the interior panel 106, thereby at least partially defining the second separator flow path 160 for the first portion of the particles, liquids, and/or combinations thereof 119 to be separated from the ambient air 92 entering the separator tube 114, with the second separator flow path 160 passing between the exterior surface 158 of the air outlet tube 142 and the interior surface 166 of the air flow inlet tube 138. As shown in FIG. 5E, in some embodiments, the interior passage 168 of the air flow inlet tube 138, the interior passage 154 of the air outlet tube 142, and/or the exterior surface 158 of the air outlet tube 142 may have a substantially circular cross-sectional shape. While the interior passage 168 of the air flow inlet tube 138, the interior passage 154 of the air outlet tube 142, and/or the exterior surface 158 of the air outlet tube 142 shown in FIG. 5E has a substantially circular cross-sectional shape as described herein, other or different cross-sectional shapes (such as non-circular shapes) are contemplated.

Applicant has recognized that for some embodiments, for the ambient air 92 that flows through the inertial separators 82, as the velocity of the ambient air increases, the resistance or pressure against the flow of the ambient air also increases, which reduces the efficiency of operation and/or the power output of the GTE 16. Thus, reducing the velocity of the ambient air flowing through the inertial separators 82 via the separator tubes 114 may result in more efficient operation and/or a higher power output of the GTE 16. Applicant has also recognized that reducing the velocity of the ambient air flowing through the separator tubes 114 also reduces the effectiveness of the removal of particles, liquids, and/or combinations thereof from the ambient air passing therethrough. Controlling the cross-sectional area of the separator tubes 114 may enable control of, the angular acceleration of particles, liquids, and/or combinations thereof, in the ambient air 92 for a given air flow velocity, which, in turn, may cause the particles, liquids, and/or combinations thereof, to be forced outward toward the interior surface 166 of the air flow inlet tube 138 by the diverter 140 as the particles, liquids, and/or combinations thereof 119, travel in a substantially helical path down the length of the air flow inlet tube 138 between the proximal end 144 of the air flow inlet tube 138 to the distal end 146 of the air flow inlet tube 138 (see, e.g., FIG. 5E). Because the particles, liquids, and/or combinations thereof, are forced outward by the relatively higher angular acceleration due to centrifugal force due to the smaller diameter, the particles, liquids, and/or combinations thereof, travel radially outward relative to the distal end 152 of the air outlet tube 142 and follow the second separator flow path 160 into the separation cavity 108 of the inertial separator 82. The ambient air 92, separated from the particles, liquids, and/or combinations thereof, that follows the second separator flow path 160, may continue in through the interior passage 154 of the air outlet tube 142, following the first separator flow path 156. By reducing the cross-sectional area of the separator tubes 114, a relatively greater percentage of the particles, liquids, and/or combinations thereof, in the ambient air 92 may be separated or removed from the ambient air 92.

In addition, by reducing the cross-sectional area of the separator tubes 114, relatively smaller particles (e.g., fine silica dust, liquid droplets, and/or combinations thereof) in the ambient air 92 may be more effectively separated from the ambient air 92. According to some embodiments, this may be desirable in environments in which hydraulic fracturing operations are being performed due to the smaller dust particles, liquid droplets, and/or combinations thereof, sometimes including gels, that are often present in the ambient air 92 in such environments. According to some embodiments, by increasing the number of separator tubes 114 for given surface area of an inertial separator 82, the volume of ambient air 92 flowing through the inertial separator 82 during operation of the GTE 16 may be substantially maintained, even though the cross-sectional area of the separator tubes 114 may be relatively reduced.

In some embodiments, the ratio of the distance between the exterior panel 104 and the interior panel 106 of the inertial separators 82 to the diameter of the separator tubes 114 (e.g., measured at the air flow tube 138, for example, when the air flow tube 138 has a substantially circular cross-section) may range from about 1:1 to about 10:1, for example, from about 1:1 to about 9:1, from about 1:1 to about 8:1, from about 1:1 to about 7:1, from about 1:1 to about 6:1, from about 1:1 to about 5:1, from about 1:1 to about 4:1, from about 1.5:1 to about 4:1, from about 2:1 to about 4:1, from about 2.5:1 to about 4:1, or from about 3:1 to about 4:1 (e.g., about 3.5:1). In some embodiments, this ratio may be critical for balancing the effectiveness of the separation tubes 114 with the velocity of the flow of the ambient air 92 as it passes through the separation tubes 114, which results in effective separation of the particles and/or liquid from the ambient air 92 and reducing the pressure drop of the ambient air 92 as it flows through the separation tubes 114. In some embodiments, the distance between the exterior panel 104 and the interior panel 106, and thus, length of the separator tubes 114 may be selected and/or varied for balancing the effectiveness of the separator tubes 114 in separating the particles, liquids, and/or combinations thereof, with the velocity of the flow of the ambient air 92 as it passes therethrough, which results in effective separation of the particles, liquids, and/or combinations thereof, from the ambient air 92 and reducing the pressure drop of the ambient air 92 as it flows through the separator tubes 114 and into the intake air chamber 84.

In some embodiments, the inertial separators 82 may be configured to separate particles, liquids, and/or combinations thereof present in the ambient air 92, where the particles, liquids, and/or combinations thereof, include one or more of mud, rain, ice, snow, leaves, sawdust, chaff, sand, dust (e.g., silica dust), proppant materials, gels (e.g., guar), and/or other possible contaminates that may be present in the ambient air surrounding, for example, a hydraulic fracturing operation. In some embodiments, the separator tubes 114 of the inertial separators 82 may be configured to separate particles, liquids, and/or combinations thereof present in the ambient air 92 having a median particle size and/or a median droplet size ranging from about 1.0 micrometer (micron) to about 15 microns, for example, from about 1.5 microns to about 14 microns, from about 2.0 microns to about 13 microns, from about 2.5 microns to about 12 microns, from about 2.5 microns to about 11 microns, from about 2.5 microns to about 10 microns, from about 2.5 microns to about 9 microns, from about 2.5 microns to about 8 microns, from about 2.5 microns to about 7 microns, from about 2.5 microns to about 6 microns, from about 2.5 microns to about 5 microns, or from about 2.5 microns to about 4 microns (e.g., about 3 microns). In some embodiments, the separator tubes 114 of the inertial separators 82 may be configured to separate particles and/or liquid present in the ambient air 92 having a median particle size and/or a median droplet size of about 5.0 microns or less, for example, of about 4.5 microns or less, of about 4.0 microns or less, of about 3.5 microns or less, of about 3.0 microns or less, of about 2.5 microns or less, of about 2.0 microns or less, of about 1.5 microns or less, or of about 1.0 micron or less. In some embodiments, the particle size may be critical for sizing the cross-section of the separation tubes 114 (e.g., selecting the diameter of the separation tubes 114 (e.g., measured at the air flow tube 138)) and/or the distance between the exterior panel 104 and the interior panel 106 of the inertial separators 82, for example, to balance the effectiveness of the separation tubes 114 with the velocity of the flow of the ambient air 92 as it passes through the separation tubes 114, which may result in effective separation of the particles and/or liquid from the ambient air 92 and reducing the pressure drop of the ambient air 92 as it flows through the separation tubes 114.

In some embodiments, the inertial separators 82 may be configured to separate a percentage of particles, liquids, and/or combinations thereof present in the ambient air 92 ranging from about 87% to about 97% by weight, for example, from about 88% to about 96% by weight, from about 89% to about 96% by weight, or from about 90% to about 95% by weight, for example, for coarse particles and/or liquid present in the ambient air 92 having a median particle size and/or a median droplet size ranging from about 2.5 microns to about 10 microns. In some embodiments, the inertial separators 82 may be configured to separate a percentage of particles and/or liquid present in the ambient air 92 ranging from about 70% to about 90% by weight, for example, from about 71% to about 89% by weight, from about 72% to about 88% by weight, from about 73% to about 87% by weight, from about 74% to about 86% by weight, from about 75% to about 85% by weight, for example, for fine particles and/or liquid present in the ambient air 92 having a median particle size and/or a median droplet size of about 2.5 microns or less.

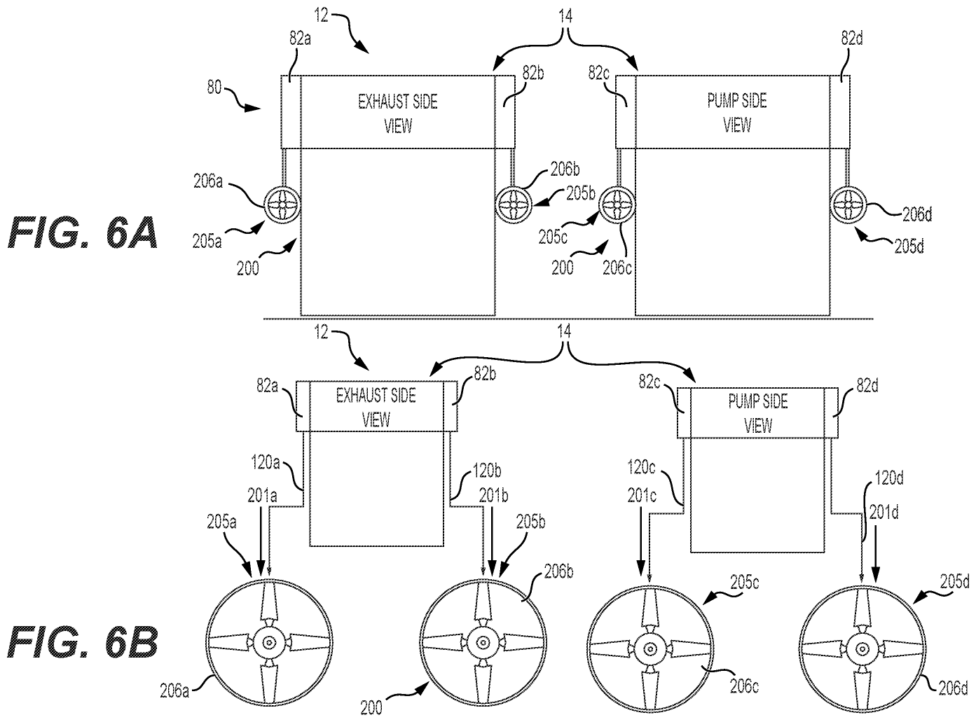

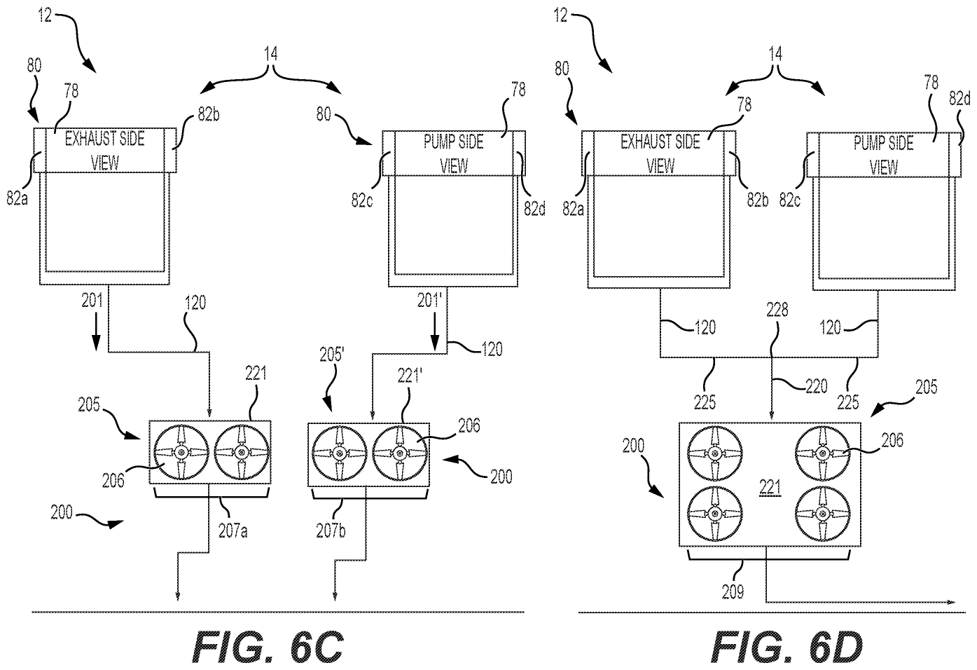

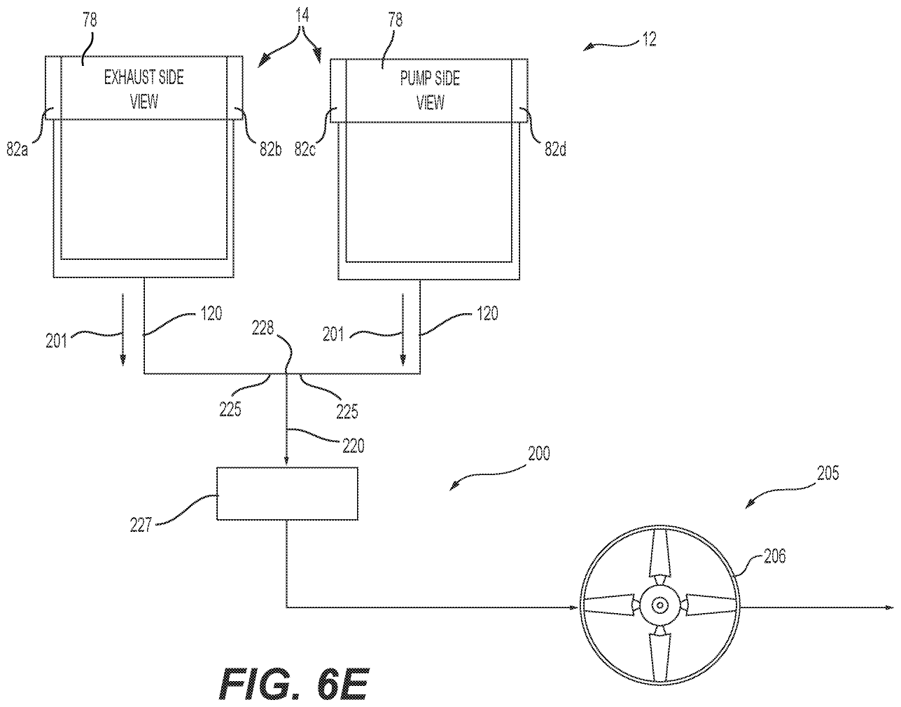

FIGS. 6A-6E illustrate various embodiments of a bleed air system 200 configured to generate and draw bleed airflows (as indicated by arrows 201) through and out of each inertial separator 82 of a filtration assembly 14. As shown in FIGS. 6A-6E, an example filtration assembly 14 of a hydraulic fracturing unit 12 is shown according to some embodiments. The embodiments of filtration assembly 14 shown in FIGS. 6A-6E may be representative of one or more of the filtration assemblies 14 of the hydraulic fracturing units 12 or all of the filtration assemblies 14 of the hydraulic fracturing units 12. In addition, to facilitate the description of the embodiments of bleed air system 200 shown in FIGS. 6A-6E, some of the features of the filtration assembly 14 (e.g., filtration housing 78, inertial separators 82, etc.) are depicted in FIGS. 6A-6E, and reference may be made to other features and components of filtration assembly 14 and bleed air system 200 shown in FIGS. 3A-5F. As such, in the following description, like reference numerals are used herein to identify features previously described above and depicted in FIGS. 3A-5F.

FIGS. 6A-6E are end views schematically illustrating various example configurations of bleed air systems 200 in fluid communication with inertial separators 82, identified as 82a, 82b, 82c, 82d, of the filtration assembly 14, according to embodiments of the disclosure. In the embodiments shown in FIGS. 6A-6E, an exhaust side view may represent an end view of the filtration assembly 14 as viewed from the front of a platform 46 (of the hydraulic fracturing 12 as shown in FIGS. 2 and 3A) and a pump side view may represent an end view of the filtration assembly 14 as viewed from the rear of the platform 46 (as shown in FIGS. 2 and 3A). Accordingly, as shown in FIGS. 6A-6E, the filtration assembly 14 may include inertial separators 82a, 82d, and 82b, 82c positioned on opposing sides 85 of the filtration assembly 14.

In some embodiments, the bleed air system 200 may be configured to provide a substantially continuous bleed airflow 201 that passes through and is exhausted from one or more of the inertial separators 82 of the filtration assembly 14. The bleed airflow 201 generated by the bleed air system 200 generally may have sufficient velocity and/or may be generated to create a static pressure or suction/vacuum within the inertial separators 82 sufficient to substantially remove the separated particles, liquids, and/or combinations thereof, 119 (FIGS. 5A-5B) that have been collected within the separation cavity 108 of each inertial separator 82 as indicated in FIGS. 5A-5D.

By providing a substantially continuous bleed airflow 201 passing through and exiting from the separation cavity 108 of each inertial separator 82, the inertial separators 82 may be substantially continuously cleaned of the particles, liquids, and/or combinations thereof, separated from the incoming ambient air flow 92. As a result, the potential buildup of such separated particles, liquids, and/or combinations thereof, within the separation cavities 108 may be substantially reduced; and the inertial separators 82 may be substantially continuous cleaned of collected particles, liquids, and/or combinations thereof, which further may substantially reduce the maintenance required for the inertial separators 82. In addition, in some embodiments, the bleed air system 200 may be configured to generate a single bleed airflow passing through each of the inertial separators 82 so as to substantially continuously clean the inertial separators 82 of collected particles, liquids, and/or combinations thereof, as opposed to requiring intermittent purging of the inertial separators 82, such as by application of compressed air thereto.

The bleed air system 200 further may include one or more bleed airflow generators 205 that may be coupled to one or more inertial separators 82. For example, in some embodiments, as shown in FIGS. 5F, and 6C-6E, two or more inertial separators 82 may be coupled to a single bleed airflow generator 205, or to a bank of bleed airflow generators. In some embodiments, the bleed airflow generators 205 may include one or more fans or blowers 206 (or simply “fan(s) 206”). Such fans or blowers 206 may include, in various embodiments, electrically, hydraulically, or pneumatically powered fans or blowers, such as squirrel cage fans, vane axial fans, centrifugal fans, blowers, axial blade fans, or other, similar fans or blowers. The one or more fans 206 generally may be configured (e.g., having a selected horsepower and/or flowrate rating, e.g., cubic feet per minute) to generate a substantially constant bleed airflow 201 through and out of the inertial separator(s) 82 to create a negative static pressure or suction/vacuum within the separation cavity 108 thereof sufficient to entrain and draw the ambient air and/or the particles, liquids, and/or combinations thereof, out of the inertial separators, and into and along the duct adapter or coupling 121 and/or the conduits 120 connected thereto.

In an embodiment, such as shown in FIGS. 6A, the bleed airflow generators 205, identified as 205a, 205b, 205c, 205d, of the bleed air system 200 may include one or more fans 206, identified respectively as 206a, 206b, 206c, 206d, that are mounted on each side of the filtration housing 78 of the filtration assembly 14, and may be configured as part of the filtration assembly 14. The one or more fans 206 may be coupled in fluid communication with at least one of the inertial separators 82, identified respectively as 82a, 82b, 82c, 82d. For example, as illustrated in FIG. 5G, a fan 206 may be mounted along the duct adapter or coupling 121, e.g., at a distal end of the duct adapter or coupling 121 coupled to the pre-cleaner bypass 118 for one of the inertial separators 82. In some embodiments, the one or more fans 206 (e.g., 206a, 206b, 206c, 206d) may include a squirrel cage fan that may be mounted to the distal end of the duct adapter or coupling 121 (FIG. 5G) or the conduit 120 (FIG. 5F) and operable to draw or pull the bleed airflow 201 through and out of its associated inertial separator with a sufficient suction/static pressure or velocity of the bleed airflow 201 being sufficient to remove the separated particles, liquids, and/or combinations thereof, with the bleed airflow 201.

In an additional embodiment, such as shown in FIG. 6B, the bleed airflow generators 205, identified respectively as 205a, 205b, 205c, 205d, may include one or more fans 206, identified respectively as 206a, 206b, 206c, 206d, that may be externally mounted or remote from their associated inertial separators 82, identified respectively as 82a, 82b, 82c, 82d. In this embodiment, the one or more fans 206 may be coupled to the respective hoses or conduits 120, identified respectively as 120a, 120b, 120c, 120d, (as shown in FIGS. 5A-5C, and 5F) leading to each of the inertial separators 82. For example, as shown in FIG. 6B, the fans 206a, 206b, 206c, 206d are individually coupled to the respective hoses or conduits 120a, 120b, 120c, 120d and configured to provide a bleed airflow 201, identified respectively as 201a, 201b, 201c, 201d, to each respective inertial separator 82 (e.g., 82a, 82b, 82c, 82d). The one or more fans 206 further may be selectively positioned or located downstream from the inertial separators 82, e.g., being located at positions along the hose or conduit 120 selected to substantially minimize pressure drop increases of the bleed airflow 201 coming from the inertial separators 82. Minimizing such pressure drop increases the bleed airflow 201 which may in turn reduce loads required by each of the one or more fans 206. The one or more fans 206 may

FIGS. 6C and 6D illustrate additional configurations of the bleed air system 200 wherein the bleed air flow generators 205 may include multiple sets or banks of fans 206 coupled to one or more filtration assemblies 14. As shown in FIGS. 6C and 6D, various pluralities of fans 206 may be grouped together as a set (207a, 207b (see embodiment in FIG. 6C; 209 (see embodiment in FIG. 6D)). For example, as illustrated in FIG. 6C, each of the inertial separators 82, identified respectively as 82a, 82b, 82c, 82d, of a filtration assembly 14 may be connected to and in fluid communication with the hose or conduit 120, identified respectively as 120, 120′, that extends therefrom and is connected to an associated set of two fans 207a and 207b. In some embodiments, as shown in FIG. 6D, the one or more inertial separators 82 (e.g., inertial separators 82a, 82b, 82c, 82d) may be linked or coupled by a common collection conduit 220 to a bank or set of bleed airflow generators 205 having four fans 206.

In one embodiment as shown in FIG. 6C, the inertial separators 82 located along each side of the filtration housing 78 of the filtration assembly 14 may be linked to a corresponding or associated set of fans (207a and 207b). In other embodiments, such as shown in FIG. 6D, all of the inertial separators 82 of the filtration assembly 14 may each be coupled to a single, larger capacity/horsepower set of fans 209, here illustrated as including four fans 206 with the hoses or conduits 120 thereof feeding to a common outlet conduit 220, although additional configurations or numbers of fans 206 also may be used.

In embodiments, as illustrated in FIGS. 6C and 6D, one or more sets of fans (e.g., 207a, 207b, 209) may be arranged within a fan box or housing 221 (or more simply “fan box 221”) that may be coupled to the hose or conduit 120 (see embodiment in FIG. 6C) or the common outlet conduit 220 (see embodiment in FIG. 6D) in fluid communication with one or more inertial separators 82 of the filtration assembly 14. In some embodiments, one or more fan boxes 221 may be directly coupled to one or more hoses or conduits 120 (e.g., conduit 120, 120′) extending from the one or more inertial separators 82 such as shown in FIG. 5F. For example, as shown in FIG. 6C, the fan box 221′ may include the fan set 207b directly coupled to conduit 120′ to provide a bleed airflow 201′ through the inertial separators 82c, 82d and expel the particles, liquids, and/or combinations thereof, separated from the ambient airflow 92 by the inertial separators 82c and 82d. In a similar manner, in this embodiment, the fan box 221 may include the fan set 207a which may be directly coupled to conduit 120 to provide a bleed airflow 201 through the inertial separators 82a, 82b thereby to assist in exhausting the particles, liquids, and/or combinations thereof, separated from the ambient airflow 92 by the inertial separators 82a and 82b.

In other embodiments, as shown in FIG. 6D, the fan box 221 may be coupled to the common outlet conduit 220 that may be in fluid communication with multiple inertial separators 82 of an associated filtration assembly 14 (e.g., the pump side view or the exhaust side view), for example, being coupled to the common collection duct 220 to which the hoses or conduits 120 of the inertial separators 82 are connected (e.g. by a T joint, etc.), and which is configured to receive and collect the particles, liquids, and/or combinations thereof, separated from the incoming ambient airflow 92 by each of the inertial separators 82 of the filtration assembly 14.

In addition, in some embodiments, the fan boxes 221 may comprise individual units or modules that may include various numbers and configurations of fans 206. For example, modules having fans 206 with which further differing horsepower may be provided to generate bleed airflows 201 of varying, selected velocities. Such modules may be removably connected to one or more inertial separators 82 by the hoses or conduits 120 or the common outlet conduit 220. The configuration and use of the fan boxes 221 as modular structures or units further may enable addition or substitution of such fan boxes or unit modules as needed to address bleed airflow demands at a fracturing site.

FIG. 6E illustrates still another embodiment of a bleed air system 200 wherein the bleed air system 200 includes a bleed airflow generator 205 that, in this embodiment, is illustrated as a single large fan 206 having an increased size and/or airflow capacity (e.g., cubic feet per minute), such that the single large fan 206 may provide sufficient airflow required to draw out the ambient air and/or the particles, liquids and/or combinations thereof, separated by the inertial separators 82. For example, in some embodiments, the single large fan 206 may vary in size (e.g., wheel diameter) depending on the type of fan (e.g., centrifugal fan, vane axial fan, etc.), manufacture, and/or static and dynamic pressure capability, in order to provide continuous bleed airflow through the inertial separators. As shown in FIG. 6E, the filtration assembly 14 may include a plurality of inertial separators 82 (e.g., one or more inertial separators 82) fluidly connected to the single large fan 206 through a manifold 227.

In some embodiments, one or more conduits 120 of one or more inertial separators 82 further may connect at a common outlet conduit 220 which may be connected to the manifold 227. In such an embodiment, each of the one or more conduits 120 may be merged or coupled together at distal ends 225 thereof at a “T” junction 228 coupled to the common outlet conduit 220, such as indicated in FIG. 6E. The common outlet conduit 220 further may be connected to the manifold 227, to which one or more bleed airflow generators 205 may be coupled and in fluid communication therewith. In such a configuration, the bleed airflow generator 205 of the bleed air system 200 may be substantially consolidated into a single fan assembly in communication with one or more inertial separators 82 of the filtration assembly 14, and through the use of the manifold 227, the suction or static pressure generated by the bleed airflows 201 drawn through and out of each of the inertial separators 82 may be regulated so as to maintain substantially consistent pressures and/or velocities. The size and/or number of the bleed airflow generators 205, for example, may be varied so as to control the bleed airflow 201 to maintain a substantially consistent static pressure or suction within the filtration assembly 14.

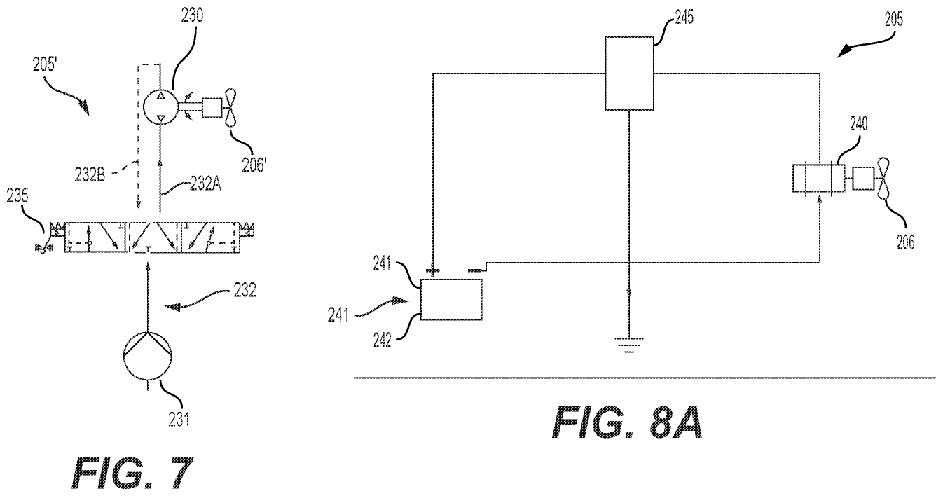

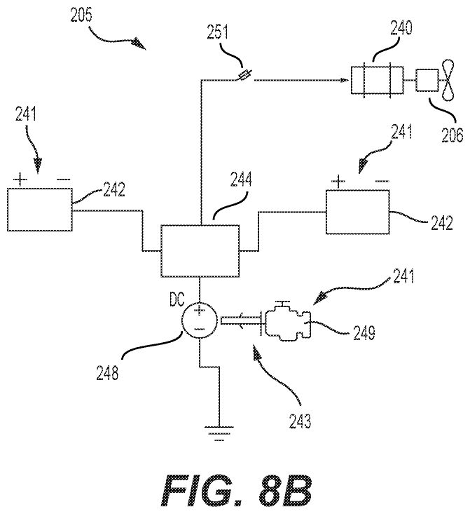

FIGS. 7-8B illustrates embodiments of bleed airflow generators 205 for use in the bleed air system 200, such as illustrated in the example embodiments of FIGS. 5A, 5F, 5G and 6A-6E. In some embodiments, the bleed airflow generators 205 may include one or more fans 206 that may be hydraulically, electrically or pneumatically powered. FIG. 7 schematically illustrates an example of a bleed airflow generator (e.g., bleed airflow generator 205′) including use of hydraulic power to operate one or more hydraulic motors (e.g., hydraulic motor 230) connected to the one or more fans 206′ (e.g., if hydraulically powered fan(s) are used). In the example embodiment shown in FIG. 7, the bleed airflow generator 205′ may include a fan 206′ driven by a hydraulic motor 230. A single fan 206′ and a single hydraulic motor 230 are depicted in FIG. 7; however, the bleed airflow generator 205′ may include a plurality of fans 206′ driven by one or more hydraulic motors 230 in a similar manner according to some embodiments. The hydraulic motor 230 may be coupled to a hydraulic fluid pressure source 231, such as by a fluid or pressure conduit 232. The hydraulic fluid pressure source 231 may supply a pressurized fluid media, such as air or a fluid, along an initial or upstream portion 232A of the conduit 232, which may pass through the hydraulic motor 230 to provide power for the hydraulic motor 230 to drive operation of the fan 206′. The pressurized fluid thereafter may be returned along a second or downstream portion 232B of the conduit 232 where it may be returned to the hydraulic flow pressure source, e.g., such as bypassing through a compressor, or may be exhausted or discharged from the system.

As additionally illustrated in FIG. 7, in embodiments, a proportional flow control valve 235 may be located along the conduit 232 between the hydraulic flow pressure source 231 and the hydraulic motor 230. In some embodiments, the proportional flow control valve 235 may be provided and configured to receive operational input from a supervisory control system 300 (as described in more detail below) so as to control the bleed airflow 201 generated by the fan 206′ during operations. The proportional flow control valve 235 generally may be adapted to regulate or control the pressure of the pressurized fluid media being supplied to the hydraulic motor 230 in order to regulate the speed of which the fan 206′ is driven by the hydraulic motor 230, and thus regulate or control the volume and velocity of the bleed airflow generated by the fan 206′, so as to maintain a substantially consistent static pressure or suction sufficient to draw out the collected particles, liquids, and/or combinations thereof, entrained within the bleed airflow 201 drawn through each of the inertial separators.

FIGS. 8A and 8B illustrate additional example embodiments of bleed airflow generators 205, in which the bleed airflow generators 205 comprise or include electric motors 240 coupled to one or more fans 206 (or simply “a fan 206”). A single fan 206 is depicted in FIGS. 8A and 8B; however, the bleed airflow generator 205 may include a plurality of fans driven by the electric motor 240 in a similar manner according to some embodiments. As generally illustrated in FIG. 8A in an embodiment, the fan 206 may be connected to an associated electric motor 240 that is coupled to a power source 241. In embodiments, the power source may include a battery 242. In other embodiments, the electric motor 240 may be connected to an external power source, for example to an engine or other electric power generator, which, in some embodiments, further may include an alternating current (or “AC”)-direct current (or “DC”) converter.

A controller 245 further may be connected to the electric motor 240 and to the power source 241. The controller 245 may comprise a variable speed controller configured to control or adjust the speed of the electric motor 240 during operation thereof to control the speed of operation of the fan 206 to maintain a substantially consistent bleed airflow 201. For example, the controller 245 may include programming configured to enable the controller to adjust the speed of the electric motor 240 and thus the rate at which the fan 206 is driven in response to feedback from various sensors, e.g., one or more pressure or flow sensors located within the inertial separators or along one or more hoses or conduits coupled to associated one or more of the inertial separators (for example, at the upstream and downstream or distal ends thereof) to maintain a substantially consistent velocity and/or suction/static pressure of the bleed airflow 201 within the inertial separators generated by the fan. In other embodiments, the controller 245 may also be configured to control one or more valves positioned to maintain a substantially consistent velocity and/or suction/static pressure of the bleed airflow 201 within the inertial separators.

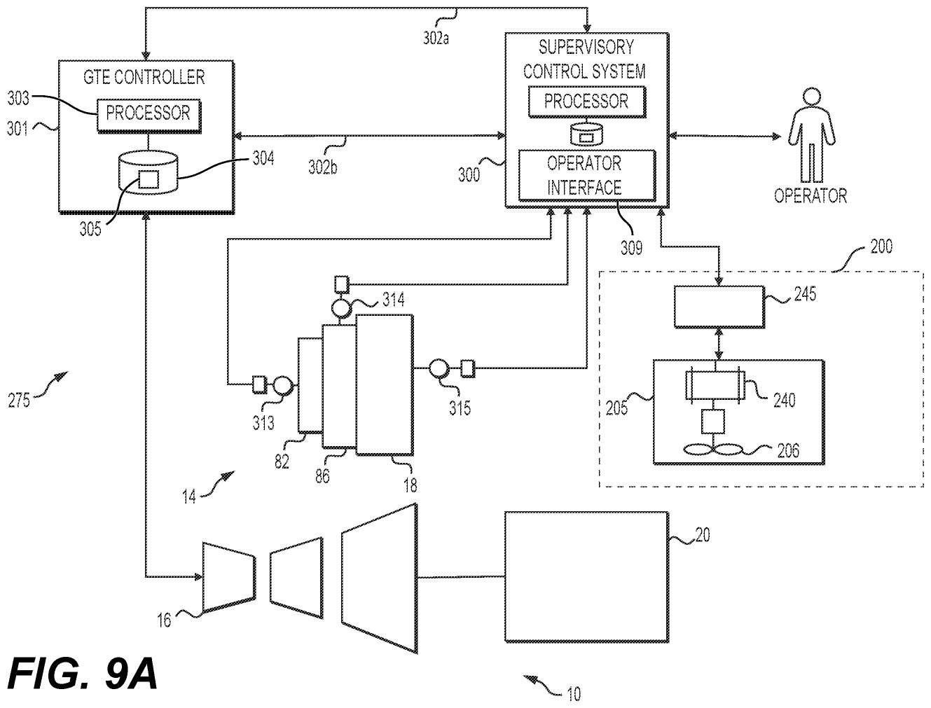

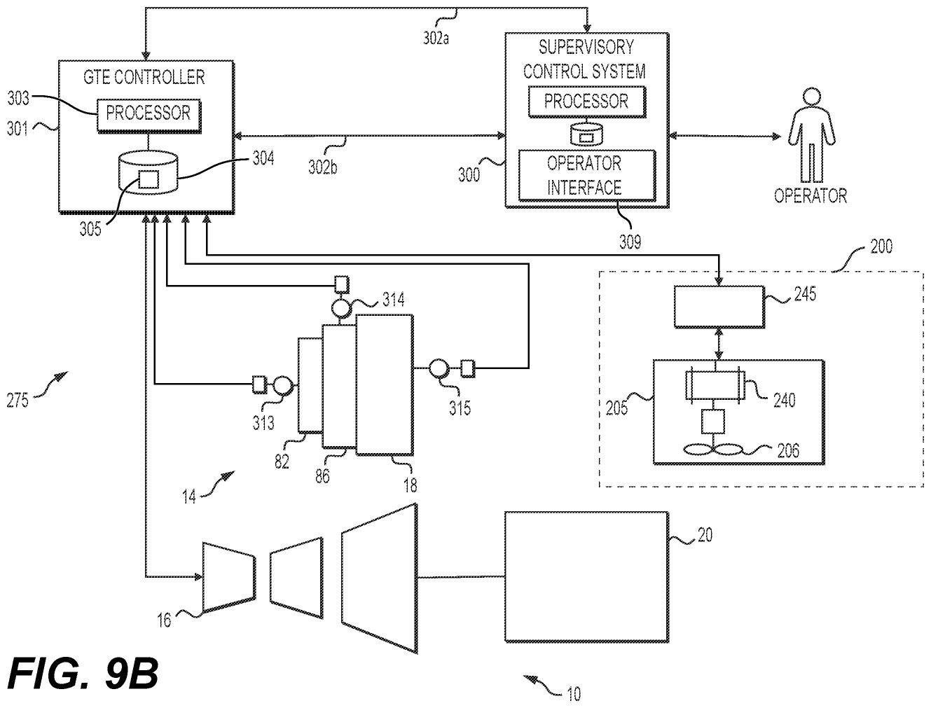

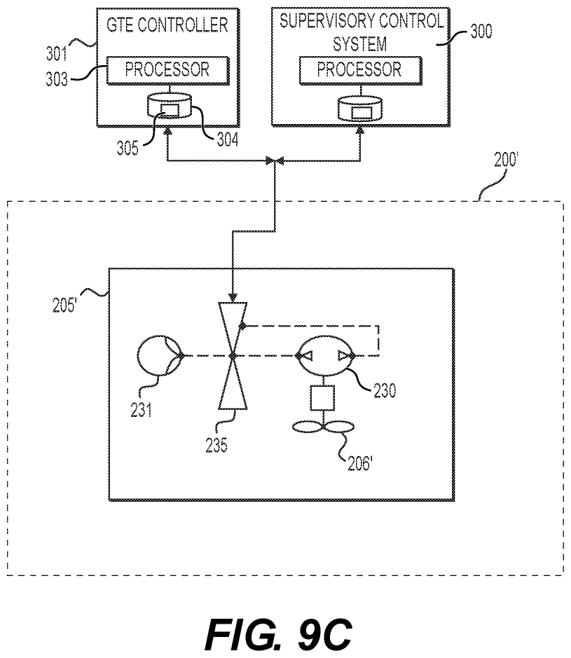

In other embodiments, the controller 245 may be linked to an overall or supervisory control system 300 of the hydraulic fracturing system 10, as indicated in FIGS. 9A-9B. The controller 245 may receive instructions from and may provide feedback to the supervisory control system 300 and in response, may control the operation of the electric motor 240 to vary the speed of the fan(s) 206 of the bleed airflow generators 205 to maintain the bleed airflow 201 generated thereby at a consistent level.

FIG. 8B illustrates a further embodiment of a bleed airflow generator 205, which includes an electric motor 240 coupled to a fan 206, and to at least one power source 241 such as a battery 242. In the embodiment illustrated in FIG. 8B, multiple power sources 241 may be used, including one or more batteries 242, and/or an alternate or auxiliary power unit 243 (or simply “auxiliary power unit 243”). Where multiple alternative power sources are provided, each of the power sources 241 may be linked to an isolator 244 that may enable switching between each of the connected power sources (e.g., the one or more batteries 242 and/or the auxiliary power unit 243) as needed. In some embodiments, the auxiliary power unit 243 may include an alternator or generator 248 that may be coupled to an engine 249, such as a diesel engine, or to another power source of the hydraulic fracturing system 10, configured to convert direct current (or “DC”) to alternating current (“AC”) power upstream of the isolator 244.

In addition, a switch or circuit control 251 (or simply “circuit switch 251”) may be provided between the electric motor 240 and the isolator 244. In operation of the bleed airflow generator 205 as illustrated in FIG. 8B, the electric motor 240 may be activated/turned on and controlled by a command from the supervisory control system 300, for example, upon the circuit switch 251 being opened and/or closed to disconnect or connect, respectively, the electric motor 240 from the power source 241. In addition, in other embodiments, a controller, such as a variable speed controller as illustrated in FIG. 8A, also may be used to regulate or control the operation of the electric motor 240, and thus control the bleed airflow 201 generated by the fan 206 connected thereto.

FIGS. 9A-11 illustrate example embodiments of a control system 275 of the hydraulic fracturing system 10 illustrating the interface of operation of the GTE 16 with a supervisory control system 300 for the hydraulic fracturing system 10 and with an operator, and with bleed air system 200. The embodiments of control system 275 shown in FIGS. 9A-11 may be representative of one or more control systems 275 of hydraulic fracturing system 10. In addition, to facilitate the description of the embodiments of control system 275 shown in FIGS. 9A-11, some of the features of filtration assembly 14 (e.g., one or more inertial separators 82, additional filters 86, etc.) and bleed air system 200 (e.g., bleed airflow generators 205, one or more fans 206, etc.) are depicted in FIGS. 9A-11, and reference may be made to other features and components of filtration assembly 14 and/or bleed air system 200 shown in FIGS. 3A-8B. As such, in the following description, like reference numerals are used herein to identify features of filtration assembly 14 and/or bleed air system 200 that were previously described above and depicted in FIGS. 3A-8B.

As shown in FIGS. 9A and 9B, the control system 275 of the hydraulic fracturing system 10 may include a supervisory control system 300. The supervisory control system 300 may include a computer or computing device such as a desktop computer, laptop computer, smartphone, tablet computer, server, or some combination thereof, including a plurality of such computing devices. In some embodiments, the supervisory control system 300 may include a processor and a memory (or a plurality of processors and/or memories). The processor(s) may execute machine-readable instructions that are stored on the memory(ies) to provide the supervisory control system 300 with all the functionality described herein. In some embodiments, the supervisory control system 300 may be configured to receive signals from associated components of the hydraulic fracturing system 10 and/or communicate control signals to the associated components of the hydraulic fracturing 10 (for example, such as the GTE 16). In the embodiment shown in FIG. 9A, the supervisory control system 300 is configured to control one or more operational aspects or parameters of the filtration assembly 14 and the bleed air system 200. Thus, in some embodiments, as shown in FIG. 9A, the supervisory control system 300 may be communicatively connected to various components of the filtration assembly 14 and bleed air system 200 (e.g., sensors 313, 314, 315, and electric motor 240 shown in FIG. 9A). Moreover, the supervisory control system 300 may also be connected to additional equipment and devices shown in FIG. 9C (e.g., hydraulic motor 230) and/or other equipment and devices not shown.

The control system 275 may further include a gas turbine engine controller 301 (or more simply “GTE controller 301”) configured to control one or more operational aspects or parameters of the GTE 16 (as shown in FIG. 9A). In some embodiments, the GTE controller 301 may be configured to control operations of the GTE 16 and/or to control other equipment or devices, for example, such as the controller 245 of the bleed air system 200 (as shown in FIG. 9B). In the embodiment shown in FIG. 9B, the GTE controller 301 is configured to control one or more operational aspects or parameters of the GTE 16, the filtration assembly 14, and the bleed air system 200. Thus, in some embodiments, for example as shown in FIG. 9B, the GTE controller 301 may be communicatively connected to various components of the filtration assembly 14, the bleed air system 200, and the GTE 16. In some embodiments, the GTE controller 301 may comprise a single controller or a plurality of controllers (or components thereof) that are communicatively connected to one another.

In some embodiments, the GTE controller 301 may include a processor 303 and memory 304. The memory 304 may include machine-readable instructions 305 that are executable by the processor 303 to provide the processor 303 (and the GTE controller 301 more broadly) with the functionality described herein.

The processor 303 may include, for example, one processor or multiple processors included in a single device or distributed across multiple devices. In general, processor 303 fetches, decodes, and executes instructions (e.g., instructions 305). In addition, processor 303 may also perform other actions, such as, making determinations, detecting conditions or values, etc., and communicating signals. If processor 303 assists another component in performing a function, then processor 303 may be said to cause the component to perform the function.

The processor 303 may be at least one of a central processing unit (CPU), a semiconductor-based microprocessor, a graphics processing unit (GPU), a field-programmable gate array (FPGA) to retrieve and execute instructions (e.g., instructions 305), a real time processor (RTP), other electronic circuitry suitable for the retrieval and execution of instructions (e.g., instructions 305) stored on a machine-readable storage medium (e.g., memory 304), or a combination thereof.

In some embodiments, the memory 304 may be a non-transitory machine-readable storage medium. As used herein, a “non-transitory machine-readable storage medium” may be any electronic, magnetic, optical, or other physical storage apparatus to contain or store information such as executable instructions (e.g., instructions 305), data, and the like. The memory 304 may be any machine-readable storage medium including volatile memory (e.g., random access memory (RAM)), non-volatile memory (read-only memory (ROM), resilient distributed datasets (RDD) memory, flash memory, etc.), a storage device (e.g., hard drive), a solid-state drive, any type of storage disc, and the like, or a combination thereof.

In addition, in some embodiments, the supervisory control system 300 and the GTE controller 301 may be communicatively connected to each other via a communications link 302a and a control bus 302b. The control bus 302b may communicate any control signals between the supervisory control system 300 and the GTE controller 301, for example, to control operation of the GTE 16. The communications link 302a may enable the GTE controller 301 and the supervisory control system 300 to communicate and/or share live data regarding the operation status and/or output data of the systems and assemblies shown in FIGS. 9A-9C. Communications between the supervisory control system 300 and the GTE controller 301 are illustrated using lines terminating in arrows. For example, as shown in FIGS. 9A and 9B, the GTE controller 301 may receive command or control instructions from the supervisory control system 300 via the control bus 302b to begin operation of the GTE 16 and the GTE controller 301 may provide feedback regarding the operation status (e.g., current operating speed) of the GTE 16 to the supervisory control system 300 via the communications link 302a.

The supervisory control system 300 may include and/or be in communication with an operator interface 309 (e.g., a monitor, display, operator input device, computing device, or combination thereof) as shown in FIGS. 9A and 9B. The operator interface 309 may allow an operator to monitor the status, input thresholds (e.g., parameters), and/or operation instructions of one or more components of the hydraulic fracturing system 10, the filtration assembly 14, and/or the bleed air system 200. In some embodiments, the operator may initiate specific tasks or operations of the GTE 16 and/or other components of the hydraulic fracturing system 10 via the operator interface 309. For example, in some embodiments, as specific tasks and operations are initiated by the operator (e.g., via the operator interface 309), the supervisory control system 300 may communicate the instructions to the GTE controller 301 (via the control bus 302b) for controlling operation of the GTE 16 (such as the speed of the GTE 16). Further, the supervisory control system 300 may receive feedback of the current operation of the GTE 16 (e.g., speed or other operating parameters) and status of any specific tasks initiated by the operator (via the communications link 302a) from the GTE controller 301.

In some embodiments, the supervisory control system 300 may be configured to control one or more operational aspects or parameters of the filtration assembly 14 and/or the bleed air system 200. As shown in FIG. 9A, the supervisory control system 300 may be connected to various components of the filtration assembly 14 (such as sensors 313, 314, 315) and the bleed air system 200 (such as the controller 245 and/or the electric motor 230). As also shown in FIGS. 9A and 9B, various sensors, as will be understood by those skilled in the art, may be utilized to monitor one or more parameters (e.g., pressure, flow rate, etc.) or values indicative thereof for air flow pressure (e.g., ambient airflow 92, at least partially filtered air 94, filtered intake air 96, etc.) that flow through the filtration assembly 14 and into the air inlet assembly 18 of the GTE 16. The supervisory control system 300 (as shown in FIG. 9A) and/or the GTE controller 300 (as shown in FIG. 9B) may be configured to use one or more signals from one or more sensors, such as sensors 313, 314, 315 to facilitate monitoring of, for example, the air pressure flowing through the inertial separators 82, the filtration chamber 84 (shown in FIGS. 4B and 4C) and into the intake air assembly 18 of the GTE 16. It is contemplated that a pressure drop through the inertial separators 82 and/or the additional filters 86 may be monitored via the pressure sensors 313, 314, 315 which may be positioned, for example, at the intake of the inertial separators 82, the additional filters 86, and the intake air assembly 18 of the GTE 16, respectively. A pressure differential between the sensors 313, 314, 315 at the different locations may facilitate the supervisory control system 300 or the GTE controller 301 to control operation of the bleed air system 200 (e.g., the fans 206) so that the bleed air system 200 may provide a continuous static pressure or suction of bleed air flow 201 through the filtration assembly 14 to the intake air assembly 18. For instance, for the control system 275 shown in FIG. 9A, the supervisory control system 300 may receive one or more signals from the sensors 313, 314, 315 indicating a pressure differential between the sensors 313, 314 and the supervisory control system 300 may provide one or more control signals to one or more fans 206 of the bleed air system 200 (e.g., to operate at a desired speed) to reduce or overcome any pressure differential sensed in the air flow between the sensors 313, 314, 315.

In some embodiments, the GTE controller 301 may be configured to control operation of the GTE 16 and/or one or more components of the filtration assembly 14 and/or the bleed air system 200. For instance, for the control system 275 shown in FIG. 9B, the GTE controller 301 may be configured to control operation of the bleed air system 200 based on one or more parameters of the GTE 16 (e.g., speed of the GTE 16) and/or the bleed air system 200 (e.g. air flow capacity). Thus, as illustrated in FIG. 9B, the GTE controller 301 may be communicatively connected (e.g., via wired and/or wireless connection) to one or more sensors 313, 314, 315, to the proportional flow control valve 235 (as shown in FIGS. 7 and 9C and previously described above), and to one or more other controllers associated with other components of the filtration assembly 14 and/or the bleed air system 200 (such as controller 245 shown in FIGS. 8A and 8B).

As shown in FIG. 9C, in some embodiments, the control system 275 may include a bleed air system 200′ configured to operate on hydraulic power provided by hydraulic components (e.g., hydraulic motor 230) As illustrated in FIG. 7 and previously described above, the bleed air system 200′ may include a hydraulic motor 230 (e.g., if hydraulic fans are used) to power one or more fans 206′. In some embodiments, for example, as shown in FIG. 9C, the bleed air system 200′ may include the hydraulic motor 230 connected to the one or more fans 206′ and the proportional flow control valve 235 located along the conduit 232 between the hydraulic flow pressure source 231 and the hydraulic motor 230. The proportional flow control valve 235 may receive control signals from the supervisory control system 300 or instructions from the GTE controller 301 (as described in detail below) to regulate the pressure of the pressurized fluid media being supplied to the hydraulic motor 230 and thus, to control the volume and velocity of the bleed airflow 201 generated by the one or more fans 206′ (e.g., via controlling the speed of the one or more fans 206′).

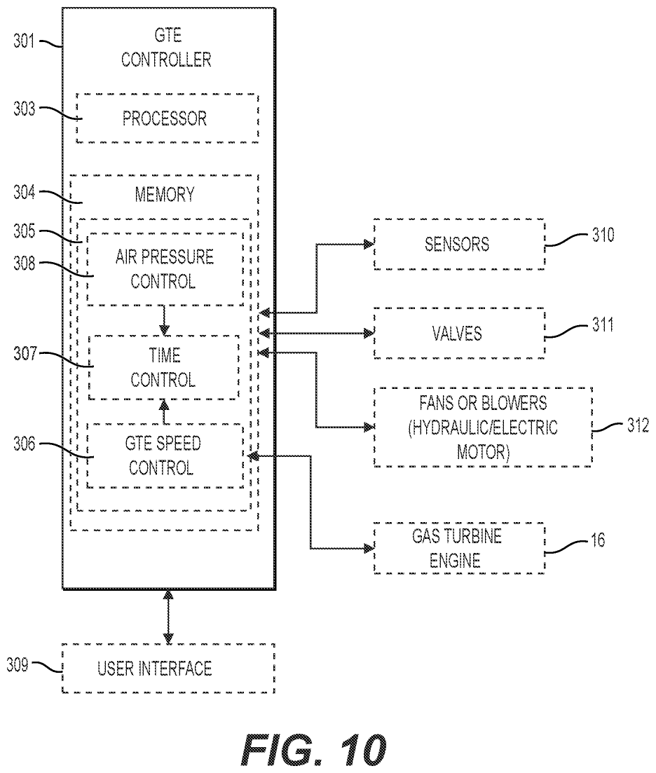

As described above, the supervisory control system 300 or the GTE controller 301 may be configured to control one or more operational aspects or parameters of the hydraulic fracturing system 10, the filtration assembly 14, and the bleed air system 200. Thus, in some embodiments, the supervisory control system 300, or in other embodiments, the GTE controller 301 may be communicatively connected (e.g., via wired and/or wireless connection) to one or more sensors 313, 314, 315, and to the proportional flow control valve 235. The proportional flow control valve 235 is schematically represented as “valves” 311 in FIG. 10, and the one or more sensors are schematically represented as “sensors” 310 in FIG. 10. Further, the supervisory control system 300 or the GTE controller 301 may also be communicatively connected (e.g., via wired and/or wireless connection) to one or more fans 206, 206′, or more particularly the hydraulic motors 230 of the one or more fans 206′ or the electric motors 240 of the one or more fans 206. The one or more fans 206, 206′ are schematically represented as “fans or blowers” 312 in FIG. 10.

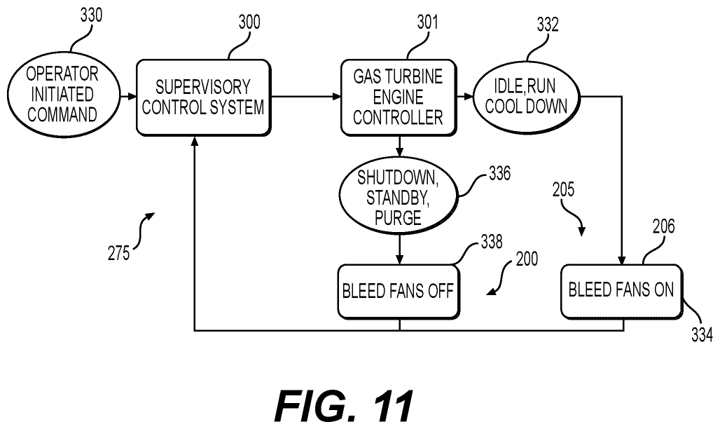

FIG. 10 is a schematic diagram of a GTE controller 301 for controlling one or more operational aspects or parameters of a gas turbine engine, a filtration assembly, and a bleed air system 200. In some embodiments, the GTE controller 301 as shown in FIG. 10, may represent a central controller or master controller of the supervisory control system 300. Thus, in some embodiments, the supervisory control system 300 may include similar components (such as processor 303, memory 304, instructions 305, etc.) to perform one or more features described below and shown in FIGS. 11-18.

In the embodiment shown in FIG. 10, for example, the machine-readable instructions 305 may include a plurality of separate instructions 306, 307, 308 for controlling one or more operational aspects or parameters of the hydraulic fracturing system 10, the filtration assembly 14 and the bleed air system 200 (as shown in FIG. 9A-9C). For instance, the machine-readable instructions 305, as will be understood by those skilled in the art, may include GTE speed control instructions 306, time control instructions 307, and air pressure control instructions 308. As will be described in more detail below, the GTE speed control instructions 306 may cause the processor 303 to control the operation of the bleed air system 200 based on one or more operating parameters of the GTE 16 (e.g., operational speed and/or output load of thereof). In addition, the time control instructions 307 may cause the processor 303 to control the operation of the bleed air system 200 based on an amount of time one or more fans 206 has been operating. Further, the air pressure control instructions 308 may cause the processor 303 to control the operation of bleed air system 200 based on an air flow pressure of the filtration assembly 14 (e.g., inertial separators 82) and the bleed air system 200.

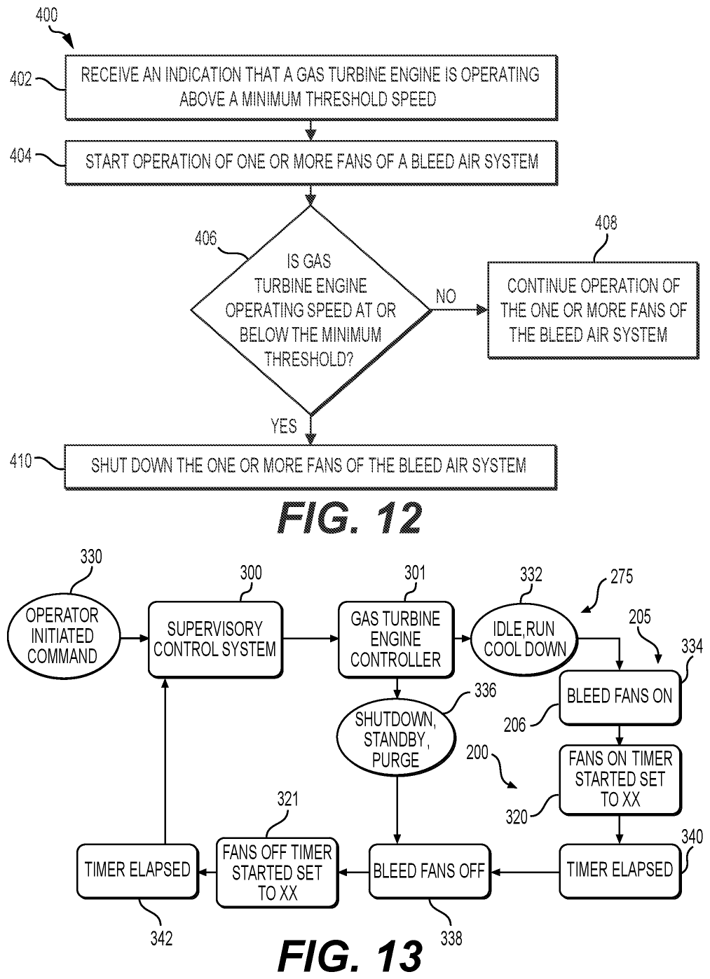

FIGS. 12, 16A-16B, and 18 illustrate embodiments of methods 400, 500, 600, of operating a bleed air system (e.g., bleed air system 200) that provides a bleed airflow (e.g., bleed airflow 201) of particles, liquids, and/or a combination thereof separated from ambient air flow through inertial separators 82. In some embodiments, methods 400, 500, 600 may be performed using the supervisory control system 300 as shown in FIG. 9A. In other embodiments, methods 400, 500, 600 may be performed using the GTE controller 301 as shown in FIG. 9B. As a result, methods 400, 500, 600 may be representative of some of the machine-readable instructions 305 stored on memory 304 (FIG. 10) in some embodiments. Specifically, the methods 400, 500, 600 may be representative of the instructions 306, 307, 308, respectively, shown in FIG. 10 according to some embodiments. In some embodiments, the supervisory control system 300 and the GTE controller 301 may be integrated into a single controller or control system for performing the functionality described herein. In some embodiments, tasks that are described herein as being performed by the supervisory control system 300 may be performed by the GTE controller 301 and vice versa.

To further clarify embodiments disclosed herein, flow diagrams in accordance with some embodiments are shown in FIGS. 11, 13-15, and 17. The flow diagrams may illustrate embodiments of controlling operation a bleed air system (e.g., bleed air system 200) that circulates bleed air (e.g., bleed airflow 201) through inertial separators (e.g., inertial separators 82) during operation of a hydraulic fracturing system. In particular, in some embodiments, one or more features described below and shown in FIGS. 11-18 may be performed using the control system 275 of FIG. 9A or the control system 275 of FIG. 9B.

Turning to FIG. 11, a flow diagram schematically illustrating an embodiment of a control system 275 for a bleed air system 200 is shown. The embodiment of the control system 275 shown in FIG. 11 may be representative of the control systems 275 shown in FIGS. 9A-9C. In addition, to facilitate the description of the embodiment of control system 275 shown in FIG. 11, some of the features of bleed air system 200 (e.g., bleed air generators 205, one or more fans 206, etc.) are referenced in FIG. 11 and reference may be made to other features and components of control system 275 shown in FIGS. 9A-9C. As such, in the following description, like reference numerals are used herein to identify features of control system 275 that were previously described above and depicted in FIGS. 9A-9C.

As discussed above, a bleed air system 200 may be operated so as to generate and maintain a substantially consistent static pressure or suction of bleed airflow 201 sufficient to draw out particles, liquids, and/or combinations thereof, separated from the ambient airflow 92 and entrained within the bleed airflow 201 drawn through each of the inertial separators. Operation of the bleed air system 200 may be controlled by the GTE controller 301 (as shown in FIG. 9B) or by the supervisory control system 300 (as shown in FIG. 9A) based on one or more parameters of the GTE 16, the filtration assembly 14, and/or the bleed air system.

As shown in FIG. 11, in some embodiments, operation of the bleed air system 200 may be based on an operating state of the GTE 16 (e.g., a current operational speed and/or output load thereof). In some embodiments, the one or more fans 206 of the bleed air system 200 may be maintained in a non-active or off state (e.g., not generating bleed airflow 201) when operation of the GTE 16 is below a minimal speed (e.g., below idle speeds). Once the speed of the GTE 16 reaches and/or exceeds the minimum threshold speed (e.g., idle speed), the GTE controller 301 may initiate operation of the bleed air system 200, e.g., it may start or activate the one or more fans 206 of the bleed air system 200 to generate the bleed airflow 201 through the inertial separators 82. In particular, in some embodiments, the GTE controller 301 may signal a bleed air generator 205 to supply power to one or more fans 206 to generate bleed airflow 201 to flow through the inertial separator 82 and out of the bleed air system 200. The inertial separators 82 may receive bleed airflow 201 from one or more fans 206 of the bleed air system 200 via conduit 120.

In an example embodiment, as illustrated in FIG. 11, the supervisory control system 300 may receive an operator initiated command 330 (via an operator interface 309) and communicate a signal (e.g., via the control bus 302b) to the GTE controller 301 to initiate operation of the GTE 16. The operator initiated command 330 may include any command or control instructions selected by an operator or user (e.g., via an operator interface 309 as described above and shown in FIGS. 9A and 9B) to control one or more of the features or components of the control system 275 (such as the GTE 16 and/or one or more fans 206 shown in FIGS. 9A and 9B). The GTE controller 301 may be configured to receive one or more signals (e.g., based on the operator initiated command 330) from the supervisory control system 300 to activate operation of the GTE 16, for example, by initiating a start-up sequence for the GTE 16. Further, the GTE controller 301 may continuously monitor the state (e.g., speed) of the GTE 16 and provide continuous feedback or live data (via the communications link 302a as shown in FIGS. 9A and 9B) regarding the operation status of the GTE 16 to the supervisory control system 300. For instance, while monitoring the operating state of the GTE 16, the GTE controller 301 may determine that the GTE 16 is operating at or above a minimum speed or an idle speed (e.g., idle, run, cool down 332) or, in other instances, the GTE controller 301 may determine that the GTE 16 is operating below the minimum speed or idle speed (e.g., shutdown, standby, purge 336). For example, the GTE controller 301 may make a determination that the speed of the GTE 16 is at and/or exceeds a selected minimum speed (e.g., idle, run, cool down 332), and the GTE controller 301 may activate one or more fans 206 of the bleed air system 200 to turn on (e.g., bleed fans on 334) and thereby generate a bleed airflow 201 through the inertial separators 82. In other embodiments, the supervisory control system 300 may receive an indication from the GTE controller 301 that the speed of the GTE 16 is at and/or exceeds the selected minimum speed (e.g., idle, run, cool down 332), and the supervisory control system 300 may initiate operation of one or more fans 206 of the bleed air system 200 to generate the bleed airflow 201.

Thereafter, if the speed of the GTE 16 drops back below the minimum speed (e.g., below idle speed) thereof, such as during a shut down phase (e.g., shutdown, standby, purge 336), one or more (or all) of the fans 206 of the bleed air system 200 may be deactivated or shut down (e.g., bleed fans off 338), and the GTE 16 may be shut down and the filtration assembly 14 purged as needed. For instance, the GTE controller 301 may make a determination that the speed of the GTE 16 is below the selected minimum speed (e.g., shutdown, standby, purge 336) and the GTE controller 301 may shut down one or more of the fans 206 (e.g., bleed fans off 338) of the bleed air system 200. While not explicitly shown in FIG. 11, in some embodiments, the supervisory control system 300 may receive an indication from the GTE controller 301 that the speed of the GTE 16 is operating below the selected minimum speed (e.g., shutdown, standby, purge 336), and the supervisory control system 300 may shut down or turn off one or more (or all) fans 206 of the bleed air system 200.

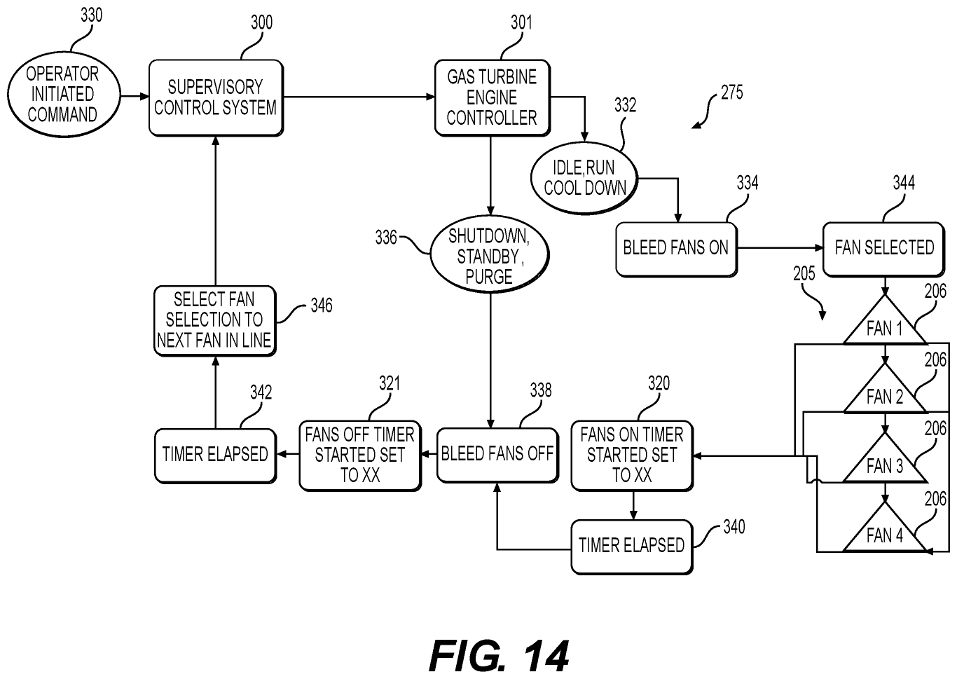

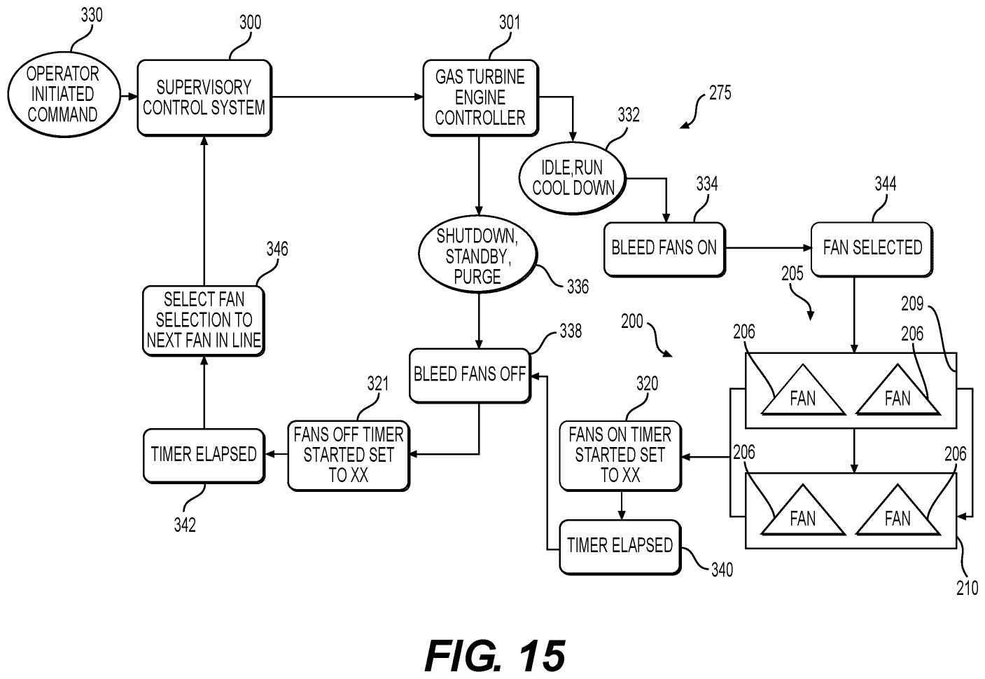

In some embodiments, for example as shown in FIGS. 14 and 15, operation of the one or more fans 206 of the bleed air system 200 may be based on the state of operation (e.g., operational speed) of the GTE 16 continuously monitored by the GTE controller 301. In some embodiments, in response to the monitored speed of the GTE 16 and changes thereof, the GTE controller 301 may determine whether to turn on and/or turn off at least one or more of the one or more fans 206 (for example, such as fans 1-4 shown in FIG. 14) or, in some instances, turn on and/or turn off all of the one or more fans 206 of the bleed air system 200. While not explicitly shown in FIG. 11, the supervisory control system 300 may turn on and/or turn off at least one or more of the one or more fans 206 based on outputs of the monitored speed of the GTE 16 from the GTE controller 301 (via the communications link 302a). Refer to FIGS. 14 and 15 for additional details regarding selecting operation of the one or more fans 206.

As shown in FIG. 12, an embodiment of method 400 is shown. Method 400 may be utilized to control the operation of a bleed air system (e.g., bleed air system 200) based on whether a gas turbine engine (e.g., GTE 16) is operating above a minimum threshold speed. In some embodiments, method 400 may be representative of an embodiment of the GTE speed control instructions 306 shown in FIG. 10. For instance, for the bleed air system 200 and the hydraulic fracturing system 10 shown in FIG. 9B, the GTE controller 301 may monitor the operational speed of the GTE 16 to determine whether to operate one or more fans 206 of the bleed air system 200. Without being limited to this or any other theory, if the GTE 16 is not operating at a minimum speed, an amount of intake air to the GTE 16 may be reduced and filtration of the intake air to the GTE 16 may be reduced similarly. For example, in some embodiments, the GTE controller 301 may receive one or more indications from the GTE 16 of the current operation speed of the GTE 16 (e.g., the rotational speed of the turbine engine shaft). In some circumstances, if the GTE 16 is not operating at a minimum threshold speed (e.g., an idle speed), the GTE controller 301 may reduce an amount of intake air ingested into the intake air assembly 18 of the GTE 16 and thus filtration of the intake air (e.g., ambient air 92) by the filtration assembly 14 may be reduced. In addition, the bleed airflow 201 passing through and out of the inertial separators 82 may be reduced as the amount of intake air to the GTE 16 is reduced. Conversely, if the GTE 16 is operating above the minimum threshold speed (e.g, idle speed), the GTE controller 301 may increase the amount of intake air ingested into the intake air assembly 18 of the GTE 16 and thus filtration of the intake air (e.g., ambient air 92) by the filtration assembly 14 may be increased. Similarly, the bleed airflow 201 passing through and out of the inertial separators 82 may be increased as the amount of intake air to the GTE 16 is increased, thereby expelling the particles, liquids, and/or combinations thereof, separated from the ambient air 92 out of the inertial separators 82.

The method 400, for example, includes receiving an indication that a gas turbine engine is operating above a minimum threshold speed at block 402. For instance, for the hydraulic fracturing system 10 and the bleed air system 200 shown in FIG. 9B, the GTE controller 301 may be connected to one or more components or sensors of the GTE 16 (e.g., flow sensors, temperature sensors, volt or current meters, etc.) and/or may be communicatively connected to another controller that is connected to one or more components or sensors of the GTE 16 such that during operations, the GTE controller 301 may determine that the GTE 16 is operating above a minimum threshold speed (e.g., an idle speed). In some embodiments, the GTE controller 301 may communicate the operating status of the GTE 16 (e.g., the current speed of the GTE 16) with the supervisory control system 300 (via the communication link 302 shown in FIGS. 9A and 9B).

The method 400 also includes starting operation of one or more fans of a bleed air system at block 404. For instance, for the control system 275 shown in FIG. 9B, the GTE controller 301 may be communicatively connected to one or more components of the bleed air system 200 (e.g., controller 245 or proportional flow control valve 235) such that the GTE controller 301 may generate one or more control signals to the one or more components of the bleed air system 200 to begin operation of the one or more fans 206. For instance, in some embodiments, the GTE controller 301 may send a signal to the controller 245 of the bleed air system 200 (as shown in FIG. 9B) to begin operation of the one or more fans 206 (via the electric motor 240). As previously described, the controller 245 may include a variable speed DC controller configured to adjust the speed of the one or more fans 206 based on the operation status of the GTE 16 and/or the limitations of the one or more fans 206 (e.g., maximum airflow output of one or more fans 206). As another example, in some embodiments, the GTE controller 301 may open the proportional flow control valve 235 to allow the hydraulic flow pressure source 231 to supply the pressurized fluid media to the hydraulic motor 230 (as shown in FIG. 9C) thus, controlling the speed of which the fan 206 is driven by the hydraulic motor 230.

The method 400 may include determining if the gas turbine engine operating speed is below the minimum threshold at block 406. The minimum threshold may be set based on a minimum operating speed of the GTE (e.g., an idle speed). For instance, for the control system 275 shown in FIG. 9B, the GTE controller 301 may monitor the operation status of the GTE 16 (e.g., the speed of the GTE 16) via one or more components or sensors of the GTE 16 (e.g., flow sensors, temperature sensors, volt or current meters, etc.).

As shown in FIG. 12, if it is determined that the GTE operating speed is not below the minimum threshold speed at block 406 (e.g., the determination at block 406 is “No”), method 400 may proceed to continue operation of the one or more fans of the bleed air system at block 408. Thus, block 408 may be performed in response to the determination that the GTE operating speed is at or above the threshold at block 406. If, on the other hand, it is determined that the GTE operating speed is below the minimum threshold speed at block 406 (e.g., the determination at block 406 is “Yes”), method 400 may proceed to shut down the one or more fans of the bleed air system at block 410.

In some embodiments, block 410 may include stopping or shutting down operation of the one or more fans of the bleed air system and/or some select components thereof. For instance, with respect to the control system 275 shown in FIG. 9B, if the GTE controller 301 detects that the speed of the GTE 16 is below the threshold (e.g., idle speed), then the GTE controller 301 may take action to prevent the continued production of bleed air flow 201 passing through the inertial separators 82 and exhausted out of the bleed air system 200. For instance, the GTE controller 301 may shut down the one or more fans 206 (or more particularly the electric motor 240) to prevent the flow of bleed air through the inertial separators 82.

FIGS. 13-15 illustrates additional embodiments of a control system 275 for control of the bleed air system 200. In some embodiments, operation of the bleed air system 200 may be controlled based on a time sequence that provides a substantially continuous bleed airflow passing through the inertial separators of the filtration assembly 14. For instance, in some embodiments, the bleed air system 200 may be controlled by one or more timers that may cycle the one or more fans 206 to turn on and turn off an intermittent fashion. In addition, in some embodiments, the operation of the bleed air system 200 may be controlled based on one or more limitations of the fan(s) 206 of the bleed air system 200, for example, such as the fan(s) output air flow capacity (e.g., cubic feet per minute), power consumption, etc.

As indicated in FIGS. 13-15, after an operator initiates the operation of the GTE 16 (e.g., operator initiated command 330), the supervisory control system 300 may signal the GTE controller 301 to start the operation of the GTE 16. The GTE controller 301 may determine that the GTE 16 is operating at or above a threshold or minimum speed (e.g., an idle speed) as previously described above in method 400 (FIG. 12). Upon detection that the speed of the GTE 16 has reached and/or exceeded the threshold or minimum speed (e.g., GTE 16 is idle, run, cool down 332), the GTE controller 301 (or another controller such as controller 245) may initiate operation of the one or more fans 206 of the bleed air system 200. While not explicitly shown in FIGS. 13-15, in some embodiments, the supervisory control system 300 may receive a signal from the GTE controller 301 indicating the speed of the GTE 16 has reached and/or exceeded the threshold or minimum speed (e.g., idle speed) and the supervisory control system 300 may initiate operation of the one or more fans 206 of the bleed air system 200. As also shown in FIGS. 13-15, once the bleed air system 200 is engaged/activated (e.g., one or more fans 206 are operating), a primary timer 320 may be started. Through the supervisory control system 300, the primary timer 320 may, for example, allow the bleed air system 200 to run for a selected or programmed time period, after which, upon expiration (e.g., timer elapsed 340) of the primary timer 320, the one or more fans 206 of the bleed air system 200 may be turned off (e.g., bleed fans off 338).

In some embodiments, an additional or secondary timer 321 may be activated once the one or more fans 206 are turned off during which time the one or more fans 206 may be maintained in an off or inactive condition (e.g., not generating bleed airflow 201). After the additional or secondary timer 321 expires (e.g., timer elapsed 342), the one or more fans 206 may be turned on or restarted (e.g., continue operation). In some embodiments, one or more of the fans 206 of the bleed air system may be operated based on operation of the primary and secondary timers 320,321. In certain embodiments, the primary or secondary timers 320,321 may be overridden by the supervisory control system 300 (or a separate bleed air system controller) and start or maintain the operation of the one or more fans 206 of the bleed air system based on the monitored operation of the GTE 16. For example, one or more of the fans 206 may be operated by the primary and secondary timers 320,321 and the GTE controller 301, unless otherwise instructed by the supervisory control system 300. In addition, when the speed of the GTE is detected as falling below the threshold or minimum speed (e.g., at idle speed or lower), the one or more of the fans 206 of the bleed air system 200 may be selectively shut down by the GTE controller 301 or the supervisory control system 300 (as described above) in advance of the elapsing of the respective timer (e.g., primary or secondary timer).

FIG. 14 illustrates an alternative embodiment of the control system 275 of FIG. 13 wherein the bleed air generators 205 of the bleed air system 200 may include multiple fans which, in some embodiments, may be arranged in separately controllable sets or groups, as show in FIG. 15. As indicated in FIG. 14, once an operator initiated command 330 to start operation of the GTE 16 of the hydraulic fracturing system 10 is received at the supervisory control system 300, the GTE controller 301 may receive a signal to start operation of the GTE 16. As the GTE controller 301 detects the speed of the GTE is at or exceeding a minimum or threshold speed (e.g., an idle speed), the GTE controller 301 may signal the one or more fans 206 to turn on (e.g., bleed fans on 334) and selectively initiate operation (e.g., fan selection 344) of one or more fans 206 of the bleed air system 200. As indicated in FIG. 14, fan selection 344 may include selectively operating one or more of the fans 206 (e.g., fans 1-4), for example, based on the operational state (e.g., speed) of the GTE 16 so as to generate the bleed airflow 201 passing through and out of inertial separators 82. For instance, the GTE controller 301 may determine that the GTE 16 is operating at a high operational state (e.g., high speed) and may individually select to operate fan 1 and fan 3 so as to generate an amount of bleed airflow 201 necessary to provide a continuous static pressure or vacuum through the inertial separators 82 of the filtration assembly 14 (as previously described above). In another example, the GTE controller may determine that the GTE 16 is operating at an idle speed (e.g., the minimum speed to activate the bleed air system 200) and may select to turn on fan 1 (as shown in FIG. 14) of the bleed air system 200 to generate the necessary amount of bleed airflow 201 to provide a continuous static pressure through the inertial separators 82 to remove the separated particles, liquids, and/or combinations thereof, from the ambient air 92 (as previously described above and shown in FIGS. 5A-5F).

In some embodiments, as indicated in FIG. 15, the bleed air generators 205 of the bleed air system 200 may include multiple fans arranged in one or more sets or groups of fans 206 including a first set of fans 209 and a second set of fans 210. In some embodiments, as shown in FIG. 15, the first set of fans 209 may include fan 1 and fan 3 and the second set of fans 210 may include fan 2 and fan 4 of the bleed air system 200. The first set of fans 209 and the second set of fans 210 may be individually selected to begin operation (via supplying power to the bleed airflow generators 205 of the first set of fans 209 and the second set of fans 210), so as to generate the bleed airflow 201 being exhausted from the inertial separators 82. For example, the GTE controller 301 may start operation of the first set of fans 209 when the GTE controller 301 determines the speed of the GTE 16 is at or above the minimum or threshold speed (e.g., idle, run, cool down 332).

The one or more fans 206, as indicated in FIG. 14, or sets of fans 209, 210, as indicated in FIG. 15, further may be connected to separate primary and secondary timers 320, 321 that may be configured to shut down operation of the one or more fans 206 or sets of fans 209, 210 connected thereto upon expiration of a preset time. In some embodiments, the primary and secondary timers 320, 321 may be set to start and expire at different times, as opposed to each timer starting and expiring at substantially the same time and shutting down all of the fans or sets of fans connected thereto. As a result, the primary and secondary timers 320, 321 may synchronize the bleed air system 200 so that a substantially continuous bleed airflow 201 may be drawn through the inertial separators 82, without having to operate all of the fans 206 at the same time (e.g., a staggered operation for bleed air system 200). This staggered operation may further help limit power consumption while still providing the desired bleed airflow 201. For example, the primary timer 320 may begin at the time the first set of fans 209 begin operation, as shown in FIG. 15, and once the time of the primary timer has expired (e.g., time elapsed 340), the first set of fans 209 may be shut down or turned off (e.g., bleed fans off 338). In addition, at the time the first set of fans 209 are shut down, the secondary timer 321 may start and at the expiration of the time for the secondary timer 321 (e.g., timer elapsed 342), one or more fans 206 may be selected as the next fan in line to begin operation (e.g., select fan selection to next fan in line 346).

In some embodiments, the one or more fans 206 may be controlled by the primary timer 320 and/or the secondary timer 321. However, it is contemplated that the one or more fans 206 may be controlled by the supervisory control system 300 or the GTE controller 301 before time has elapsed on at least one of the primary timer 320 and/or the secondary timer 321. In these circumstances, the supervisory control system 300 and/or the GTE controller 301 may immediately shut down one or more fans 206 that are operating at the time an indication is made that the operating state of the GTE 16 is in shut down, standby, purge 336 phase (e.g., the speed of the GTE 16 is below the minimum speed). For example, one or more fans 206 may be turned on (e.g., bleed fans on 334) and the primary timer 320 may begin (e.g., fans on, timer started, set to XX) during which time the GTE controller 301 may determine the GTE is operating below the minimum threshold (e.g., the GTE 16 is in shut down, standby, purge 336 phase). In this example, the GTE controller 301 or the supervisory control system 300 may signal the one or more fans 206 to turn off or shut down prior to the primary timer 320 reaching the predetermined threshold of time.

In addition, in some embodiments, only selected fans 206 or sets of fans 209, 210 of the bleed air system 200 may be connected to a timer, with other ones of the fans 206 or sets of fans 209, 210 being operated substantially continuously (or through the controller) to provide and maintain a substantially continuous bleed airflow 201 through the inertial separators 82. As further shown in FIG. 15, once the primary timer 320 for the selected fan(s) 206 or sets of fans 209, 210 have elapsed (e.g., timer elapsed 340), the selected fan(s) 206 or sets of fans 209, 210 may be turned off (e.g., bleed fans off 338), and the secondary timer 321 may be started and operated for a predetermined or selected time period during which the selected fan(s) 206 or sets of fans 209, 210 may be maintained in an off or shut down condition. In some embodiments, the sets of fans 209, 210 may remain turned off (e.g., not producing bleed airflow 201) for a predetermined or selected period of time based on one or more limitations of the fan(s) and/or operating parameters of the GTE 16.

In some embodiments, one or more of the fans 206, or sets of fans 209, 210, of the bleed air system 200 each may be linked to and controlled by the primary timer 320 and the secondary timer 321, of which may be started at staggered intervals or times. For example, as shown in FIG. 14, a primary timer for fans 1 and 3 may be started upon which fans 1 and 3 (or sets of fans 209 shown in FIG. 15) being turned on, while a primary timer for fans 2 and 4 (or sets of fans 210 shown in FIG. 15) may be activated at later times. In some embodiments, the starting or turning on of the additional fans 2 and 4 (or sets of fans 210) may be delayed, with the activation of the associated primary and secondary timers therefor also being delayed until the fans 2 and 4 (or sets of fans 210) are started. While in other embodiments, all of the fans 1-4 (FIG. 14), or sets of fans 209, 210 (FIG. 15) may be turned on and the timers associated therewith started and stopped at different times. Thus, each of the fans 206, or sets of fans 209, 210, of the bleed air system 200 may be turned on and off independently or at staggered time intervals to maintain a substantially continuous bleed airflow 201 through the inertial separators 82. In addition, in some embodiments, as the GTE controller 301 detects a slowdown of the operational speed of the GTE (e.g., the speed of the GTE falls below the selected minimum or threshold speed) the fans 206 (or sets of fans 209, 210) of the bleed air system may be automatically shut down by the GTE controller 301.

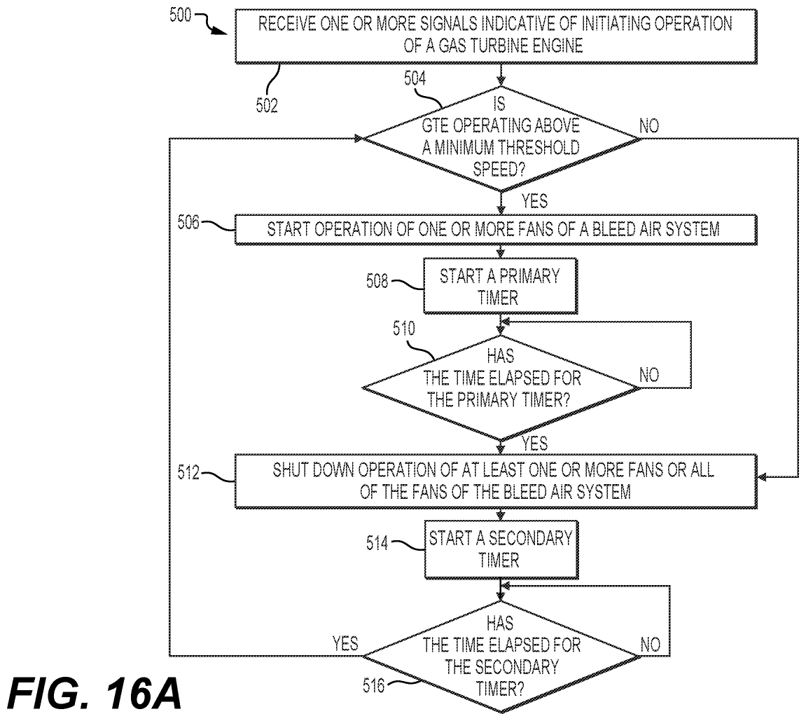

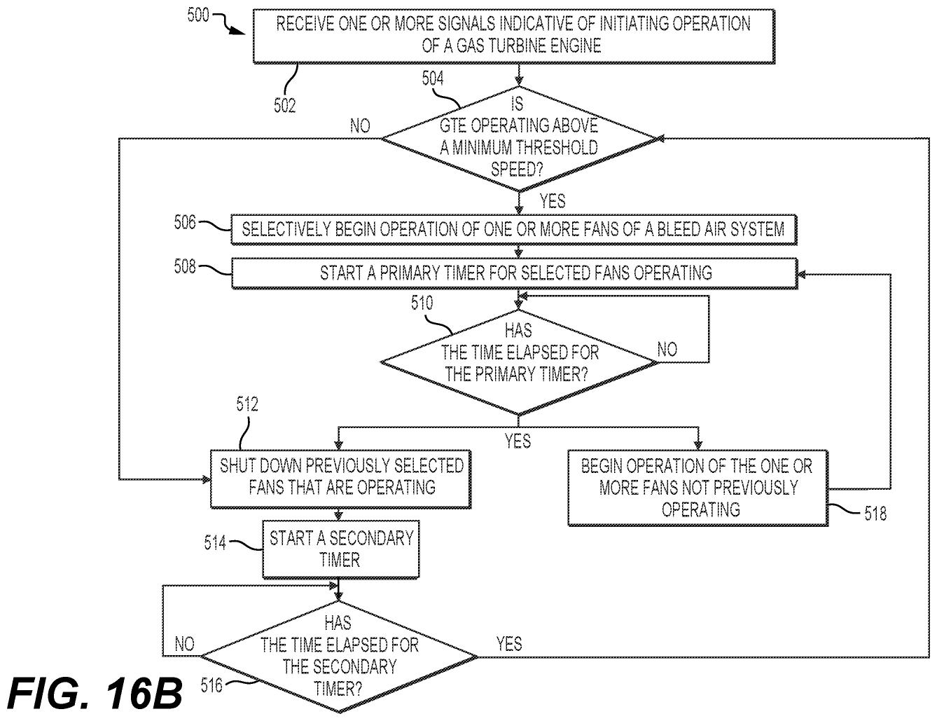

As shown in FIGS. 16A and 16B, various example embodiments of method 500 is shown. Method 500 may be utilized to control the operation of a bleed air system based on a flow rate of bleed air generated by one or more fans of the bleed air system that is circulated through inertial separators of a filtration assembly. In some embodiments, method 500 may be representative of an embodiment of the time control instructions 307 shown in FIG. 10. For instance, for the control system 275 shown in FIG. 9B, the GTE controller 301 may monitor the operation status of the GTE 16 and if the GTE 16 is operating above an idle speed, the GTE controller 301 may initiate one or more fans 206 of bleed air system 200 to begin operation (e.g., to start generating bleed airflow 201 through the inertial separators 82). In these circumstances, the one or more fans 206 may operate for a selected or programmed period of time, after which, the one or more fans 206 may shut down for a selected or programmed period of time. As a result, a time sequencing of the bleed air system 200 may be implemented so as to generate a continuous bleed airflow 201 drawn through the inertial separator 82, without having to operate all of the one or more fans 206 at the same time. The time sequencing may be described as a staggered operation where the fan(s) are operating at staggered (or different) time intervals. The staggered operation of the one or more fans 206 of the bleed air system 200 may further help limit power consumption (e.g., power utilized by the bleed air system 200) while providing the necessary bleed airflow 201 (e.g., volume and/or velocity of bleed air) to remove the separated particles, liquids, and/or combinations thereof, out of the inertial separators 82. In some embodiments, the supervisory control system 300 may shut down, prior to the end of the time sequence, the one or more fans 206 operating at the time the supervisory control system 300 receives an indication from the GTE controller 301 that the GTE 16 is operating at or below the minimum threshold speed (e.g., below idle speed).

The method 500 may include receiving one or more signals indicative of initiating operation of a gas turbine engine at block 502. For instance, for the control system 275 shown in FIGS. 9A and 9B, one or more signals indicative of an operator's desire to start operation of the GTE 16 may be communicated to the supervisory control system 300 and/or the GTE controller 301, for example, via an operator using the operator interface 309 and the GTE controller 301 may activate operation of the GTE 16.

The method 500 also includes determining whether the gas turbine engine is operating above a minimum threshold speed at block 504. In some embodiments, block 504 may include any one or more of the actions described above for block 406 of method 400 (FIG. 12), including monitoring the operation status of the GTE 16 (e.g., the speed of the GTE 16) via one or more components or sensors of the GTE 16 (e.g., flow sensors, temperature sensors, volt or current meters, etc.).

As shown in FIG. 16A, if it is determined that gas turbine engine is not operating above the minimum threshold speed at block 504 (e.g., the determination at block 504 is “No”) method 500 may proceed to shut down operation of at least one or more fans or all of the fans of the bleed air system at block 512. If, on the other hand, it is determined that the gas turbine engine is operating above the minimum threshold speed at block 504 (e.g., the determination at block 504 is “Yes”) method 500 may proceed to start operation of one or more fans of a bleed air system at block 506. In some embodiments, block 506 may include any one or more of the actions described above for block 404 of method 400 (FIG. 12).

As shown in FIG. 16B, method 500 may include selectively beginning operation of one or more fans of a bleed air system at block 506. For instance, for the control system 275 shown in FIG. 9B, once the GTE controller 301 determines the GTE 16 is operating above a minimum threshold speed (e.g., an idle speed), the GTE controller 301 may selectively initiate operation of one or more fans 206 of the bleed air system 200 based on the operating status of the GTE 16 (e.g., current operating speed or output) and one or more limitations of the fan(s) (e.g., airflow capacity of the fan(s)) so as to generate a substantially consistent static pressure or suction of bleed airflow 201 sufficient to draw out the separated particles, liquids, and/or combinations thereof, through the inertial separators 82. In these circumstances, the GTE controller 301 may send a control signal to a bleed air generator 205 of the bleed air system 200 to supply power to one or more fans 206, via one or more power sources 241. For instance, the GTE controller 301 may include communicating with the controller 245, for example as shown in FIG. 9B, to supply electrical power to the one or more fans 206. In some embodiments, the one or more fans 206 may be controlled by the supervisory control system 300, for example, as shown in FIG. 9A. In these circumstances, the supervisory control system 300 may receive an indication, via the GTE controller 301, that the GTE 16 is operating above the minimum threshold speed and the supervisory control system 300 may selectively begin operation of the one or more fans 206 of the bleed air system 200. For example, the supervisory control system 300 may communicate with the bleed airflow generator 205 (as shown in FIG. 9A) to supply electrical power to the one or more fans 206, via one or more power sources 241.

The method 500 also includes starting a primary timer at block 508, and then determining whether the primary timer has reached a threshold at block 510. The threshold at block 510 may be set based on an amount of time the bleed air system may operate one or more fans to generate a bleed airflow through a filtration assembly while the gas turbine engine is above the minimum operating speed. For instance, for the control system 275 shown in FIG. 9B, once the GTE controller 301 determines that the GTE is operating above a minimum threshold speed (e.g., an idle speed), the GTE controller 301 may initiate a primary timer or other suitable timing sequence (e.g., block 508) to limit the amount of time that one or more fans 206 may be operating (e.g., turned on and generating bleed airflow 201). The maximum time (e.g., the threshold in block 510) may be a selected or programmed time period for the one or more fans 206 selected to operate at block 506 based on operating parameters of the GTE 16 and/or manufacture guidelines of the one or more fans 206.

As shown in FIGS. 16A and 16B, if it is determined that the primary timer has not yet reached the threshold at block 510 (e.g., the determination at block 510 is “No”), method 500 may repeat block 510. If, on the other hand, it is determined that the primary timer has reached the threshold at block 510 (e.g., the determination at block 510 is “Yes”), method 500 may proceed to shut down operation of at least one or more fans or all of the fans of the bleed air system at block 512.

The method also includes starting a secondary timer at block 514 and then determining whether the secondary timer has reached a threshold at block 516. The threshold at block 516 may be set based on an amount of time the bleed air system 200 may turn off one or more fans 206. For instance, for the control system 275 shown in FIG. 9B, once the one or more fans cease operation (e.g., shut down) at block 510, the GTE controller 301 may initiate a secondary timer or other suitable timing sequence (e.g., block 514) to limit the amount of time that the one or more fans 206 selected at block 506 may be turned off or shut down (e.g., not generating bleed airflow). The maximum time (e.g., the threshold in block 516) may be a selected or programmed time period for the one or more fans 206 selected to operate at block 506 based on operating parameters of the GTE 16 and/or manufacture guidelines of the one or more fans 206.

As shown in FIGS. 16A and 16B, if it is determined that the secondary timer has not yet reached the threshold at block 516 (e.g., the determination at block 516 is “No”), method 500 may repeat block 516. If, on the other hand, it is determined that the secondary timer has reached the threshold at block 516 (e.g., the determination at block 516 is “Yes”), method 500 may return to block 504 to once again determine the operation speed of the gas turbine engine and proceed to shut down operating fans at block 512 if it is determined that the operation speed of the gas turbine engine is below the minimum threshold speed at block 504 (e.g., the determination at block 504 is “No”).

As shown in FIG. 16B, in some instances, if it is determined that the primary timer has reached the threshold at block 510 (e.g., the determination at block 510 is “Yes”), method 500 may include beginning operation of the one or more fans not previously operating (e.g., inactive or turned off) at block 518. For instance, for the control system 275 shown in FIG. 9B, once the GTE controller 301 determines the primary timer has reached the threshold at block 510, the GTE controller 301 may start operation of the one or more fans that were not selected at block 506 and continued to operate until the time elapsed for the primary timer at block 510 (e.g., the determination at block 510 is “Yes”). In some embodiments, block 518 may include any one or more of the actions described above for block 506 of method 500. Thus, block 518 may be performed in response to the determination that the GTE is operating above a minimum threshold speed at block 504 and the primary timer has reached the threshold at block 510.

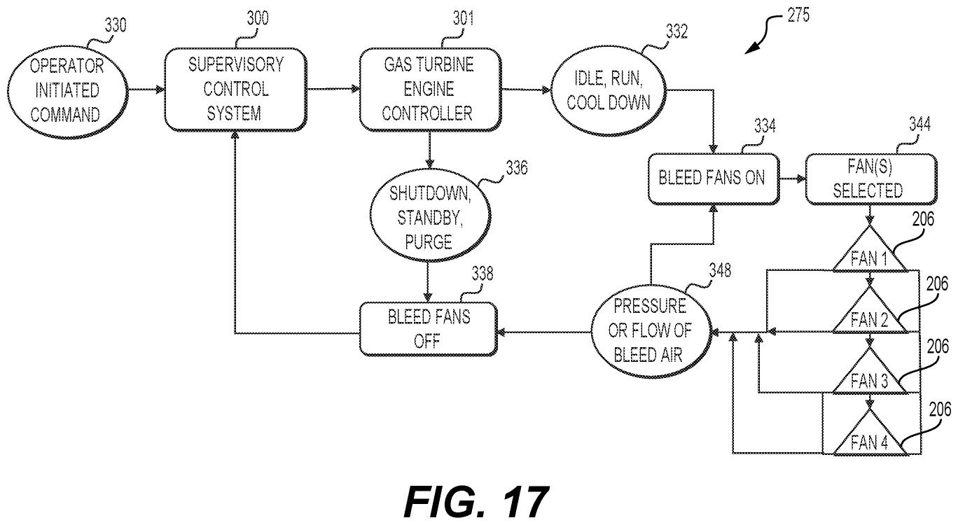

As shown in FIG. 17, a flow diagram illustrating another example process for control of a bleed air system based on a pressure or flow of bleed air that passes through inertial separators of a filtration assembly to exhaust separated particles, liquids, and/or combination thereof, from ambient air supplied to an air inlet assembly of a gas turbine engine.

In some embodiments, when an operator initiated command 330 is received by the supervisory control system 300, the supervisory control system 300 may signal the GTE controller 301 to begin operation of the GTE 16 and once the GTE controller 301 determines the operating state of the GTE 16 is idle, run, cool down 332, the bleed air system 200 may be activated (e.g., bleed fans on 334). In some embodiments, the bleed air system 200 may be controlled in relation to the pressure or flow of bleed air that passes through inertial separators of a filtration assembly 14. For instance, once the GTE controller 301 determines the operating state of the GTE 16 is at or above a selected minimum speed (e.g., idle, run, cool down 332), the bleed air system 200 may be activated (e.g., bleed fans on 334). Activating the bleed air system 200 may include individually selecting (e.g., fan selected 344) one or more fans 206 (e.g., fans 1-4 as shown in FIG. 17) to turn on and begin generating bleed airflow 201.

As indicated in FIG. 17, once one or more fans 206 are activated/turned on, an amount of pressure or flow of bleed air 348 passing through the inertial separators may be monitored and controlled so as to provide a substantially continuous bleed airflow 201 based on one or more parameters of the GTE 16, for example. For example, in some embodiments, the amount of pressure or flow of bleed airflow 201 passing through the inertial separator 82 may adjusted as the operational state of the GTE 16 (e.g., operating speed) changes. For instance, during operation of control system 275 shown in FIG. 9B, one or more sensors 313, 314, 315 may output a value of the pressure or flow rate of bleed airflow 201 passing through the inertial separator 82, generated by one or more fans 206, to the GTE controller 301. The GTE controller 301 may determine the pressure or flow of bleed air 348 is below an operating threshold such that the pressure or flow of bleed air may no longer effectively remove the particles, liquids, and/or combination thereof, separated from the ambient air 92, out of the inertial separators 82. Thus, in some embodiments, the GTE controller 301 may facilitate operation of one or more fans 206 so as to increase the amount of bleed airflow 201 generated by one or more fans 206, for example, by increasing speed of one or more fans 206 via signal to controller 245 (shown in FIG. 9B). In some embodiments, the GTE controller 301 may increase the amount of bleed airflow 201 generated by one or more fans 206 by initiating operation of an additional one or more fans 206 not previously operating.

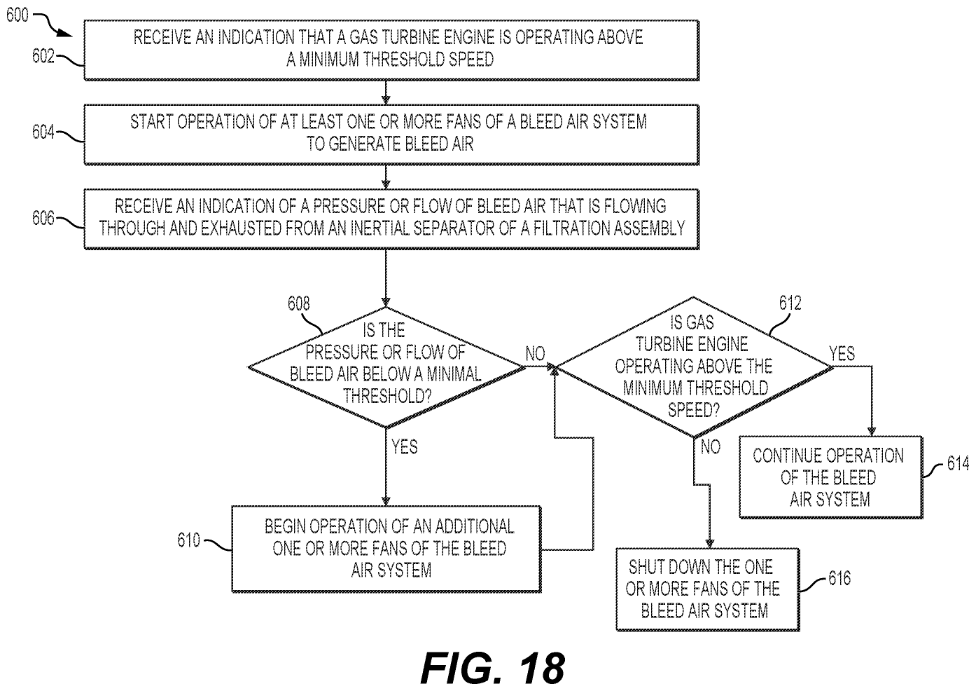

As shown in FIG. 18, an embodiment of method 600 may be utilized to control the operation of a bleed air system based on a pressure of air passing through inertial separators of a filtration assembly. In some embodiments, method 600 may be representative of an embodiment of the air pressure control instructions 308 shown in FIG. 10. For instance, for the hydraulic fracturing assembly 10, bleed air system 200, and the filtration assembly 14 shown in FIG. 9B, in some embodiments the GTE controller 301 may monitor one or more parameters of the filtration assembly 14 and the bleed air system 200 to determine if one or more fans 206 of the bleed air system 200 is providing a suitable amount of static pressure of bleed air flow through the inertial separators while a gas turbine engine is operating above a minimum threshold speed.

Additionally, in some embodiments, the one or more fans 206 of the bleed air system 200 may be selectively engaged to ensure that any pressure drop across the inertial separators 82 and/or the additional filters 86 is within the GTE manufacturer's guidelines. For instance, in some embodiments, the GTE controller 301 and/or the controller 245 (e.g., variable speed controller) for the motors (e.g., the hydraulic motor 230 or electric motor 240) driving the fans 206 of the bleed air system 200 may be configured to use one or more signals from one or more sensors (e.g., sensors 313, 314, 315) for monitoring, for example, air flow and/or pressure drop within the inertial separator 82. For example, in some embodiments, the pressure drop through the inertial separator 82 and/or the one or more additional filters 86 may be monitored via a plurality of pressure sensors, which may be positioned, for example, at the intake of the inertial separators 82 and/or the additional filters 86, and at the air inlet assembly 18 of the GTE 16. A pressure differential between the pressure sensors (e.g., sensors 313, 314, 315) of the different locations may facilitate control operation of the one or more fans 206, for example, so that they operate at a desired speed to reduce, mitigate, or overcome any sensed pressure drop between the sensor locations.

Method 600 may include receiving an indication that a gas turbine engine is operating above a minimum threshold speed at block 602. For instance, with respect to the control system 275 shown in FIG. 9B, the GTE controller 301 may monitor the operating speed of the GTE 16. In some embodiments, block 602 may include any one or more of the actions described above for block 402 of method 400 (FIG. 12).

The method 600 includes starting an operation of at least one or more fans of a bleed air system to generate bleed air at block 604. For instance, during operation of the GTE 16 shown in FIG. 9B, the GTE controller 301 may communicate with controller 245 to start operation of the one or more fans 206 (or more particularly the electric motor 240 of the fan 206) based on the operation status of the GTE 16 (e.g., the speed of the GTE). Further, in some embodiments, as shown in FIG. 9A, the supervisory control system 300 may communicate with the controller 245 to start operation of the one or more fans 206 (or more particularly the electric motor 240). In addition, in some embodiments, the supervisory control system 300 or the GTE controller 301 may open the proportional flow control valve 235 (shown in FIG. 9C) to supply power to the one or more fans 206 (e.g., allow the flow of hydraulic fluid therethrough to the hydraulic motor 230).

The method 600 also includes receiving an indication of a pressure or a flow rate of bleed air flow 201 flowing through and exhausted from an inertial separator of a filtration assembly at block 606, and then determining if the pressure or flow of the bleed air is below a minimal threshold at block 608. The threshold at block 608 may be set based on a minimum air flow capacity of an inertial separator 82 of the filtration assembly required to provide a static pressure (or vacuum) of bleed airflow 201 passing through and out of the inertial separator 82. For instance, with respect to the control system 275 shown in FIG. 9A, the supervisory control system 300 may monitor the pressure or flow rate of the bleed airflow 201 via one or more of the pressure sensors 313, 314, 315. As previously described, the sensors 313, 314, 315 may output a value of the pressure or flow rate (e.g., cubic feet per minute), or some value that is indicative thereof, to the supervisory control system 300.

As shown in FIG. 18, if it is determined that the pressure or flow of bleed air is not below the minimal threshold at block 608 (e.g., the determination at block 608 is “No”) method 600 may proceed to block 612 to determine if the gas turbine engine operating speed is at or below the minimum threshold. If, on the other hand, it is determined that the pressure or flow of bleed air is below the minimal threshold at block 608 (e.g., the determination at block 608 is “Yes”) method 600 may proceed to begin operation of an additional one or more fans of the bleed air system at block 610. For instance, for filtration assembly 14 and the bleed air system 200 shown in FIG. 9B, upon determining that the pressure or flow of bleed air is below a minimal threshold, the GTE controller 301 may selectively turn on one or more of the one or more fans 206 not operating at the time the pressure or flow of bleed air is determined to be below the minimal threshold (e.g., the threshold at block 608), thereby increasing an amount of bleed air flow 201 passing through the inertial separators 82. For instance, the GTE controller 301 may signal to the controller 245 to start the electric motor 240 to supply power to the one or more fans 206.

Further, if it is determined that the gas turbine engine is still operating above a minimum threshold speed at block 612 (e.g., the determination at block 612 is “Yes”), then method 600 may proceed to continue operation of the bleed air system at block 614. Thus, block 614 may be performed in response to the determinations that the pressure or flow of bleed air is above the threshold at block 608 and the gas turbine engine is operating above the minimum threshold speed at block 612. If, on the other hand, it is determined that the gas turbine engine is not operating above the minimum threshold speed at block 612 (e.g., the determination at block 612 is “No”), the method 600 may proceed to shut down at least one or more fans of the bleed air system at block 616.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations may depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This application is related to U.S. Provisional Application No. 63/476,452, filed on Dec. 21, 2022, titled “SYSTEMS, ASSEMBLIES, AND METHODS FOR TREATMENT/FILTRATION OF INTAKE AIR FLOWS TO A GAS TURBINE ENGINE OF A HYDRAULIC FRACTURING UNIT,” which is a continuation-in-part of U.S. Non-Provisional application Ser. No. 17/989,601, filed Nov. 17, 2022, titled “SYSTEMS, ASSEMBLIES, AND METHODS TO ENHANCE INTAKE AIR FLOW TO A GAS TURBINE ENGINE OF A HYDRAULIC FRACTURING UNIT,” which is a continuation-in-part of U.S. Non-Provisional application Ser. No. 17/954,118, filed Sep. 27, 2022, titled “MOBILE GAS TURBINE INLET AIR CONDITIONING SYSTEM AND ASSOCIATED METHODS,” which is a continuation of U.S. Non-Provisional application Ser. No. 17/403,373, filed Aug. 16, 2021, titled “MOBILE GAS TURBINE INLET AIR CONDITIONING SYSTEM AND ASSOCIATED METHODS,” which is a continuation of U.S. Non-Provisional application Ser. No. 17/326,711, filed May 21, 2021, titled “MOBILE GAS TURBINE INLET AIR CONDITIONING SYSTEM AND ASSOCIATED METHODS,” now U.S. Pat. No. 11,156,159, issued Oct. 26, 2021, which is a continuation U.S. Non-Provisional application Ser. No. 17/213,802, filed Mar. 26, 2021, titled “MOBILE GAS TURBINE INLET AIR CONDITIONING SYSTEM AND ASSOCIATED METHODS,” now U.S. Pat. No. 11,060,455, issued Jul. 13, 2021, which is a continuation of U.S. Non-Provisional application Ser. No. 16/948,289, filed Sep. 11, 2020, titled “MOBILE GAS TURBINE INLET AIR CONDITIONING SYSTEM AND ASSOCIATED METHODS,” now U.S. Pat. No. 11,002,189, issued May 11, 2021, which claims priority to and the benefit of U.S. Provisional Application No. 62/704,565, filed May 15, 2020, titled “MOBILE GAS TURBINE INLET AIR CONDITIONING SYSTEM AND ASSOCIATED METHODS,” and U.S. Provisional Application No. 62/900,291, filed Sep. 13, 2019, titled “MOBILE GAS TURBINE INLET AIR CONDITIONING SYSTEM,” the disclosures of which are incorporated herein by reference in their entireties.

The scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

What is claimed is:

1. An intake air treatment system for supplying filtered intake air to an air inlet assembly of a gas turbine engine, the intake air treatment system comprising:
an air intake housing configured to at least partially enclose the air inlet assembly of the gas turbine engine;
a filtration assembly at least partially received within the air intake housing and configured to substantially clean particles, liquids, and/or combinations thereof, from ambient air drawn into the filtration assembly by operation of the gas turbine engine, the filtration assembly comprising:
a filtration housing connected to the air inlet assembly of the gas turbine engine and having a filtration chamber defined therein;
at least one pre-cleaner positioned along the filtration housing upstream of the filtration chamber such that the ambient air passes therethrough, the at least one pre-cleaner comprising at least one inertial separator configured to separate a first portion of the particles, liquids, and/or combinations thereof, from the ambient air to provide a flow of at least partially filtered intake air; and
one or more additional filters positioned along the filtration chamber downstream of the at least one inertial separator, the one or more filters configured to receive the at least partially filtered intake air from the at least one inertial separator and separate a second portion of the particles, liquids, and/or combinations thereof, from the at least partially filtered intake air to provide the filtered intake air into the filtration chamber; and
a bleed air system in fluid communication with the at least one inertial separator and comprising:
a duct adapter coupled to the at least one inertial separator; and
at least one bleed airflow generator in fluid communication with the duct adapter, the at least one bleed airflow generator configured to draw a velocity of a bleed air flow through the at least one inertial separator and the duct adapter to sufficiently remove the first portion of the particles, liquids, and/or combinations thereof, separated from the ambient air from the at least one inertial separator.

2. The intake air treatment system of claim 1, wherein the at least one bleed airflow generator comprises one or more fans connected to the duct adapter and operable to draw the bleed air flow through and out of the at least one inertial separator so as to create a static pressure sufficient to draw the first portion of the particles, liquids, and/or combinations thereof, separated from the ambient air out of the at least one inertial separator and the duct adapter with the bleed air flow.

3. The air intake treatment system of claim 1, wherein the at least one bleed airflow generator further comprises at least one fan box having one or more fans housed therein, wherein the at least one fan box is located along the duct adapter coupled to the at least one inertial separator.

4. The intake air treatment system of claim 1, the bleed air system further comprises a conduit coupled to the at least one inertial separator, and wherein the at least one inertial separator comprises a plurality of inertial separators arranged along opposite sides of the filtration chamber; and wherein the at least one bleed airflow generator comprises a plurality of fans each in fluid communication with an associated one of the plurality of inertial separators, each one of the plurality of fans configured to draw the bleed air flow through and out of the associated one of the plurality of inertial separators so as to create a static pressure sufficient to draw the first portion of the particles, liquids, and/or combinations thereof, separated from the ambient air out of the associated one of the plurality of inertial separators and along the conduit with the bleed air flow.

5. The intake air treatment system of claim 1, wherein the at least one inertial separator comprises:
a body having an interior panel, an exterior panel, and a separation cavity defined between the interior panel and the exterior panel; and
a plurality of separator tubes, each one of the plurality of separator tubes comprising:
an air flow inlet tube having a proximal end connected to the exterior panel, extending toward the interior panel, and terminating at a distal end, the air flow inlet tube defining an interior cross-sectional area;
a diverter arranged along the air flow inlet tube and configured to cause turbulence in the ambient air entering the air flow inlet tube as the ambient air flows from the proximal end of the air flow inlet tube toward the distal end of the air flow inlet tube; and
an air outlet tube connected to the interior panel and extending into the distal end of the air flow inlet tube, the air outlet tube having an exterior cross-sectional area smaller than an interior cross-sectional area of the air flow inlet tube.

6. The intake air treatment system of claim 5, wherein the air outlet tube comprises an interior passage defining: a first separator flow path along which the at least partially filtered intake air is directed to exit the air outlet tube; and wherein a second separator flow path is defined between an exterior surface of the air outlet tube and the interior surface of the air flow inlet tube to enable the first portion of the particles, liquids, and/or combinations thereof, separated from the ambient air to be discharged from the separator tube.

7. The intake air treatment system of claim 5, wherein the diverter comprises one or more stator blades having one or more curved surfaces configured to cause the ambient air entering the air flow inlet tube to swirl as the ambient air passes the one or more stator blades.

8. The intake air treatment system of claim 5, wherein the interior panel of the at least one inertial separator comprises a plurality of interior holes, and wherein each of the air outlet tubes is connected to the interior panel such that an interior passage of the air outlet tube provides a first separator flow path for the at least partially filtered intake air to exit through the interior passage of the air outlet tube and through the interior hole of the interior panel; and wherein:
each air flow inlet tube is connected to an exterior surface of a corresponding air outlet tube and at least partially defines a second separator flow path for the first portion of the particles, liquids, and/or combinations thereof to be separated from the ambient air and directed into the separation cavity.

9. The intake air treatment system of claim 8, wherein one or more of (1) an interior passage of the air flow inlet tube, (2) an interior passage of the air outlet tube, or (3) an exterior passage defined between the air flow inlet tube and the air outlet tube has a substantially circular cross-sectional shape.

10. The intake air treatment system of claim 1, wherein the at least one inertial separator comprises a plurality of inertial separators mounted along one or both sides of the filtration housing; wherein each one of the plurality of inertial separators comprises at least one pre-cleaner bypass positioned along a lower portion of the inertial separator and configured to receive and divert the first portion of the particles, liquids, or combination thereof, separated from the ambient air into the duct adapter.

11. The intake air treatment system of claim 1, wherein the one or more additional filters comprise one or more of a pre-filter or a final filter.

12. The intake air treatment system of claim 1, wherein the at least one bleed airflow generator comprises at least one fan located along the conduit coupled to the at least one inertial separator; wherein the at least one fan is located at a position along the conduit selected to substantially minimize a pressure drop of the bleed air flow after exiting the at least one inertial separator.

13. The intake air treatment system of claim 12, wherein the at least one fan or blower comprises an axial fan, centrifugal fan, axial blade fan, or a squirrel cage fan.

14. The intake air treatment system of claim 12, wherein the at least one bleed airflow generator further comprises at least one hydraulically, pneumatically or electrically powered motor coupled to the at least one fan.

15. The intake air treatment system of claim 1, wherein the bleed air system further comprises at least one timer linked to the at least one bleed airflow generator; wherein the timer is activated as the at least one bleed airflow generator is actuated to generate the bleed air flow, and, upon expiration of the timer, the at least one bleed airflow generator is deactivated.

16. The intake air treatment system of claim 1, further comprising one or more sound attenuation baffles positioned within the filtration chamber and configured to attenuate sound generated during operation of the gas turbine engine.

17. A hydraulic fracturing unit comprising:
a chassis;
a gas turbine engine supported by the chassis;
an air inlet assembly connected to the gas turbine engine and adapted to supply intake air to the gas turbine engine;
a hydraulic fracturing pump positioned along the chassis and connected to the gas turbine engine; and
an intake air treatment system comprising:
an air intake housing at least partially enclosing the air inlet assembly of the gas turbine engine;
a filtration assembly located at least partially within the turbine housing and positioned to receive ambient air via operation of the gas turbine engine, the filtration assembly configured to substantially clean particles, liquids, and/or combinations thereof, from the ambient air and provide a flow path to supply filtered intake air to the air inlet assembly of the gas turbine engine, the filtration assembly comprising:
a pre-cleaner configured to separate a first portion of the particles, liquids, and/or combinations thereof, from the ambient air drawn into the filtration assembly thereby to supply at least partially filtered intake air; and
one or more additional filters positioned along the flow path downstream of the pre-cleaner, the one or more additional filters configured to receive at least partially filtered ambient air from the pre-cleaner and separate a second portion of the particles, liquids, and/or combinations thereof, from the at least partially filtered ambient air, to provide filtered intake air to the air inlet assembly of the gas turbine engine; and
a bleed air system in fluid communication with a pre-cleaner, the bleed air system configured to generate a substantially continuous bleed air flow through the pre-cleaner to create a static pressure or suction sufficient to substantially draw the first portion of the particles, liquids, and/or combinations thereof, separated from the ambient air, out of the pre-cleaner with the bleed air flow.

18. The hydraulic fracturing unit of claim 17, wherein the bleed air system comprises at least one bleed airflow generator comprises a plurality of fans located along a conduit coupled to the pre-cleaner operable to generate and draw the bleed air flow through and out of the pre-cleaner.

19. The hydraulic fracturing unit of claim 18, wherein the at least one bleed airflow generator further comprises a motor coupled to each one of the plurality fans, wherein when the bleed air system is operating, the motors are configured to drive the fans to generate the substantially continuous bleed air flow.

20. The hydraulic fracturing unit of claim 19, further comprising a variable speed controller configured to control a speed of the motors.

21. The hydraulic fracturing unit of claim 17, wherein the pre-cleaner comprises a plurality of inertial separators; and wherein the bleed air system comprises at least one bleed airflow generator, the at least one bleed airflow generator comprises at least one fan box having a plurality of fans mounted therein, wherein the fan box is located along a conduit coupled to one or more of the plurality of inertial separators.

22. The hydraulic fracturing unit of claim 17, wherein the pre-cleaner comprises a plurality of inertial separators arranged along opposite sides of the filtration assembly, upstream from the one or more additional filters; and wherein the bleed air system comprises a plurality of fans, each one of the plurality of fans in fluid communication with an associated one of the plurality of inertial separators and operable draw the bleed air flow through and out its associated one of the plurality of inertial separators.

23. The hydraulic fracturing unit of claim 17, wherein the pre-cleaner comprises at least one inertial separator including:
a body having an interior panel, an exterior panel, and a separation cavity defined between the interior panel and the exterior panel; and
a plurality of separator tubes, each one of the plurality of separator tubes comprising:
an air flow inlet tube having a proximal end connected to the exterior panel, extending toward the interior panel, and terminating at a distal end, the air flow inlet tube defining an interior cross-sectional area;
a diverter arranged along the air flow inlet tube and configured to cause turbulence in the ambient air entering the air flow inlet tube as the ambient air flows from the proximal end of the air flow inlet tube toward the distal end of the air flow inlet tube; and
an air outlet tube connected to the interior panel and extending into the distal end of the air flow inlet tube, the air outlet tube having an exterior cross-sectional area smaller than the interior cross-sectional area of the air flow inlet tube.

24. The hydraulic fracturing unit of claim 23, wherein the air outlet tube comprises an interior passage defining: a first separator flow path along which the at least partially filtered intake air is directed to exit the air outlet tube; and wherein a second separator flow path is defined between an exterior surface of the air outlet tube and an interior surface of the air flow inlet tube to enable the first portion of the particles, liquids, and/or combinations thereof, separated from the ambient air to be discharged from the separator tube into the separation cavity.

25. The hydraulic fracturing unit of claim 17, wherein the pre-cleaner comprises a plurality of inertial separators mounted along one or both sides of the filtration housing; and further comprising at least one pre-cleaner bypass configured to receive and divert the first portion of the particles, liquids, or combination thereof separated from the ambient air to a conduit or hose along which the bleed air flow is drawn out of each inertial separator.

26. The hydraulic fracturing unit of claim 17, wherein the one or more additional filters comprise one or more of a pre-filter or a final filter.

27. The hydraulic fracturing unit of claim 17, wherein the bleed air system comprises at least one fan in fluid communication with the pre-cleaner, and configured to generate the bleed air flow through the pre-cleaner.

28. The hydraulic fracturing unit of claim 27, wherein the at least one fan comprises an axial fan, centrifugal fan, axial blade fan, or a squirrel cage fan.

29. The hydraulic fracturing unit of claim 27, further comprising a gas turbine engine controller configured to monitor and control a speed of the gas turbine engine, and to turn on the at least one fan when the speed of the gas turbine engine is at or above a selected minimum speed, and turn off the at least one fan when the speed of the gas turbine engine is below the selected minimum speed.

30. The hydraulic fracturing unit of claim 17, wherein the bleed air system comprises at least one bleed airflow generator, the at least one bleed airflow generator comprising at least one fan, and at least one hydraulically, pneumatically or electrically powered motor coupled to the at least one fan.

31. The hydraulic fracturing unit of claim 17, wherein the bleed air system further comprises at least one timer linked to at least one bleed airflow generator; wherein as the at least one bleed airflow generator is actuated to generate the bleed air flow, the timer is activated and, upon expiration of a selected time, the at least one bleed airflow generator is deactivated to stop generation of the bleed air flow.

32. The hydraulic fracturing unit of claim 17, wherein the filtration assembly further comprises a filtration housing having a filtration chamber defined therein, with the air inlet assembly of the gas turbine engine in communication therewith; and one or more sound attenuation baffles positioned within the filtration chamber and configured to attenuate sound generated during operation of the gas turbine engine.

33. A method comprising:
operating a gas turbine engine;
drawing ambient air into and through a filtration assembly in communication with an air inlet assembly connected to the gas turbine engine;
passing the ambient air through one or more inertial separators of the filtration assembly to separate a first portion of one or more of particles, liquids, and/or combinations thereof, from the ambient air, and provide a flow of at least partially filtered intake air;
passing the flow of at least partially filtered intake air through one or more additional filters to separate a second portion of the one or more of particles, liquids, and/or combinations thereof, from the at least partially filtered intake air, thereby to provide further filtered intake air;
supplying the further filtered intake air to the air inlet assembly; and
as the gas turbine engine is operating to draw the ambient air into and through the filtration assembly, drawing a bleed air flow out of the one or more inertial separators to obtain a static pressure or suction sufficient to remove the first portion of the one or more of particles, liquids, and/or combination thereof, from the one or more inertial separators with the bleed air flow.

34. The method of claim 33, wherein passing the ambient air through one or more inertial separators comprises:
passing the ambient air through an air flow inlet tube and a diverter connected to the air flow inlet tube and positioned to cause the ambient air entering the air flow inlet tube to swirl as the ambient air flows from a proximal end of the air flow inlet tube to a distal end of the air flow inlet tube to thereby generate swirling ambient air; and
separating the first portion of the one or more of particles, liquids, and/or combinations thereof from the swirling ambient air via the separator tube.

35. The method of claim 33, wherein drawing the bleed air flow out of the one or more inertial separators comprises turning on one or more fans when a speed of the gas turbine engine reaches or exceeds a selected minimum speed.

36. The method of claim 35, further comprising turning off the one or more fans when the speed of the gas turbine engine falls below the selected minimum speed.

37. The method of claim 35, further comprising initiating a primary timer after the one or more fans are turned on, and turning off the one or more fans after the primary timer expires.

38. The method of claim 37, further comprising initiating a secondary timer when the one or more fans are turned off, and, after the secondary timer has expired, turning on the one or more fans.

39. The method of claim 33, further comprising passing the further filtered intake air through one or more sound attenuation baffles to attenuate sound generated during operation of the gas turbine engine.

40. The method of claim 33, wherein drawing the bleed air flow out of the one or more inertial separators comprises turning on a plurality of fans in fluid communication with the one or more inertial separators.

41. The method of claim 40, further comprising monitoring a speed of the gas turbine engine and turning selected ones of the plurality of fans on and off based on the speed of the gas turbine engine.
